(19) United States
(12) Patent Application Publication
(10) Pub. No.: US 2009/0036608 A1
(43) Pub. Date: Feb. 5, 2009

(54) CHLOROPRENE-BASED BLOCK COPOLYMER, SOAPLESS POLYCHLOROPRENE-BASED LATEX, AND PROCESSES FOR PRODUCING THE SAME

(75) Inventor: Shinji Ozoe, Yamaguchi (JP)

Correspondence Address: SUGHRUE-265550, 2100 PENNSYLVANIA AVE. NW, WASHINGTON, DC, 20037-3213, US

(73) Assignee: TOSOH CORPORATION, Shunan-shi (JP)

(21) Appl. No.: 11/994,156

(22) PCT Filed: Jul. 7, 2006
(86) PCT No.: PCT/JP2006/313598

§ 371 Date: Dec. 28, 2007

(30) Foreign Application Priority Data
Jul. 8, 2005 (JP) 2005-200304
Apr. 28, 2006 (JP) 2006-126067
May 18, 2006 (JP) 2006-139463

(51) Int. Cl. C08L 11/02; C08L 11/00

(52) U.S. Cl. 525/212; 525/215

(57) ABSTRACT

An object of the present invention is to provide a novel polychloroprene-based copolymer, a soapless polychloroprene-based latex, and a process for producing the same in a simple and convenient manner, which are intended to be used for the improvement in adhesiveness and water resistance of a conventional polychloroprene adhesive or the improvement in oil resistance and adhesiveness of a styrene-butadiene block copolymer.

The invention relates to a chloroprene-based block copolymer comprising a polymer (A) having a composition represented by the following formula (1) and a chloroprene-based polymer (B), the polymer (A) being linked to one terminal or both terminals of the chloroprene-based polymer (B), and the total amount of the 1,2-bond and the isomerized 1,2-bond in the chloroprene-based polymer (B) as determined by carbon-13 nuclear magnetic resonance spectrometry being 2.0 mol % or less; a soapless polychloroprene-based latex comprising an amphipathic chloroprene copolymer having a hydrophobic chloroprene-based polymer and a hydrophilic oligomer or polymer having an acidic functional group linked to the hydrophobic chloroprene-based polymer and 2 wt % or less of an emulsifying agent; and a process for producing the same:

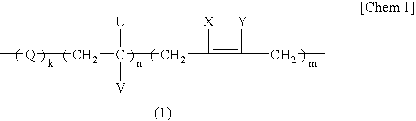

wherein U represents hydrogen, a methyl group, a cyano group, or a substituted alkyl group; V represents a phenyl group, a substituted phenyl group, a carboxyl group, an alkoxycarbonyl group, a substituted alkoxycarbonyl group, an allyloxycarbonyl group, a substituted allyloxycarbonyl group, an acyloxy group, a substituted acyloxy group, an amido group, or a substituted amido group; X represents hydrogen, a methyl group, chlorine, or a cyano group; Y represents hydrogen, chlorine, or a methyl group; Q represents a polymerization residue of maleic anhydride, citraconic acid, maleic acid, fumalic acid, a maleate ester, or a fumalate ester; and k, n, and m each represents an integer of 0 or more.

### TECHNICAL FIELD

The present invention relates to an unprecedented chloroprene-based block copolymer wherein a polymer heterogeneous to a chloroprene-based polymer is linked to one terminal or both terminals of a chloroprene-based polymer and a soapless polychloroprene-based latex containing a reduced amount of emulsifier in the latex and having a remarkably improved adhesiveness and water resistance, which is obtained utilizing the block copolymer, as well as processes for producing the same.

### BACKGROUND ART

Adhesives and primers based on chloroprene rubber (also called polychloroprene and hereinafter sometimes abbreviated as CR) are applications where characteristics of CR, such as polarity, cohesive force, and flexibility, are utilized to the fullest extent and are used as a mainstream of rubber-based adhesives in a wide variety of fields such as building materials, furniture, shoe making, and vehicle production.

However, the conventional CR adhesives have mainly two problems. First, adhesiveness toward extremely high-polarity materials such as vinyl chloride-based resins, urethane resins, and Nylon resins or contrarily toward extremely low-polarity materials such as natural rubber, ethylene-propylene-based rubbers, and polyolefin resins are not always sufficient and hence improvement has been desired. Second, the mainstream of the conventional CR adhesives is a type where CR, a tackifying resin, zinc oxide, an antioxidant, and the like are dissolved in an organic solvent such as toluene, hexane, ethyl acetate, or cyclohexane but they contain a large amount of VOC (volatile organic compound) and thus use of lesser solvent (reduction of VOC or use of no solvent) has been desired as concern about environmental problems grows.

As a method for improving the above first problem, i.e., adhesiveness toward a variety of materials, there is considered modification of CR by random copolymerization, graft copolymerization, or block copolymerization of chloroprene with a heterogeneous monomer. However, since chloroprene has an extremely high radical reactivity, there is a strict limitation in modification of CR by random copolymerization with a heterogeneous monomer. Moreover, with regard to monomers such as styrene and butadiene, a block copolymer (styrene block copolymer, so-called SBC) wherein polybutadiene is linked to terminal(s) of polystyrene or polystyrene is linked to both terminals of butadiene and molecular weight distribution is highly controlled can be obtained by applying a living anion polymerization process. In the case of chloroprene, however, owing to problems such as poisoning of metal catalysts by the chlorine atom in chloroprene, it is difficult to apply the living anion polymerization process. Accordingly, a radical polymerization process which is a polymerization process using no metal catalyst is a common process in the production of CR.

As a measure against the above second problem, i.e., for enabling use of lesser solvent in the conventional solvent-based CR adhesives, CR latexes have been attracted attention but the conventional CR latexes are insufficient in adhesiveness and water resistance and thus have not yet displaced the solvent-based CR adhesives. The conventional CR latexes are produced by a method wherein a chloroprene monomer is emulsified in water with an emulsifier such as potassium rhodinate, a sodium alkyl sulfate, a higher alcohol sulfate ester sodium, a polyoxyethylene alkyl ether, an alkylamine salt, a quaternary ammonium salt, or polyvinyl alcohol, then the chloroprene was polymerized by adding a radical initiator such as potassium persulfate, and subsequently unreacted monomer is removed by a method of steam stripping or the like. The above latex contains the above emulsifier in an amount of about 1 to 6 wt % relative to CR and this fact is considered to be a main cause of inhibiting exhibition of adhesiveness and water resistance of the conventional CR latex adhesives. Namely, in the process of applying an adhesive based on the conventional CR latex to an article to be adhered and of drying the same, it is considered that the emulsifier desorbed from the surface of CR latex particles and the emulsifier dissolved in water are segregated on the surface of the adhesive film or at the interface of the article to be adhered, thereby the adhesiveness intrinsic to CR being inhibited. Thus, an attempt has been made to produce an emulsifier-free, so-called soapless CR latex. For example, there have been disclosed a process for obtaining a soapless CR latex wherein styrene and acrylic acid are subjected to radical copolymerization, then neutralization is conducted with ammonia, and subsequently chloroprene is added and subjected to emulsion polymerization (Patent Document 1) and a process for obtaining a soapless CR latex by radical copolymerization of chloroprene and an active chlorine-containing monomer in water in the presence of an amine (Patent Document 2).

However, any hydrophilic group-containing copolymers for use in emulsification of chloroprene are random copolymers and have a bad balance between hydrophilicity and hydrophobicity and thus adsorbability to the surface of CR latex particles is not sufficient, so that it is difficult to sufficiently maintain stability of the latex.

On the other hand, There is disclosed a process for obtaining a soapless latex wherein a radically polymerizable monomer such as an acrylate ester is emulsified in water using a salt of an amphipathic acrylate ester-based copolymer consisting of a hydrophobic acrylate ester polymer block and a hydrophilic acrylic acid oligomer or polymer block and is polymerized but there is no description of chloroprene (Patent Documents 3 and 4).

In addition, as a means capable of responding needs for use of lesser solvent in solvent-based adhesives including those other than CR-based ones, hot-melt adhesives are known and SBC is utilized as a base polymer for rubber-based hot-melt adhesives. However, since SBC does not contain any polar group, it is poor in adhesiveness and has not yet displaced the solvent-based CR adhesives. Moreover, SBC is also utilized as a thermoplastic elastomer but has a limitation in adhesiveness and oil resistance since it does not contain any polar group, so that improvement has been desired.

As mentioned above, in the conventional radical polymerization, it is difficult to precisely control the primary structure of a polymer to improve polymer properties to a large extent. However, as a radical polymerization process capable of controlling the primary structure of a polymer, recently, a living radical polymerization process has been attracted attention. Examples of applying the process to chloroprene have been reported. For example, Patent Documents 5 and 6 disclose an ABA-type triblock copolymer having polychloroprene as an intermediate block (B) and a styrene-based or (meth)acrylate ester-based polymer as a (A) block and a process for producing the same utilizing a photo-iniferter polymerization process but the molecular weight distribution exceeds 2.1, which is almost as broad as that in the case of a usual radical polymerization. Moreover, there is no description of modification of a hard segment by an N-substituted maleimide, a vinylnirile, maleic anhydride, or the like and improvement of molecular weight control by using a disulfide or no description of the use of a CR block copolymer as an emulsifier.

Patent Document 7 discloses a process for producing a diblock copolymer having polystyrene and polychloroprene linked to each other utilizing a stable nitroxyl radical but the molecular weight distribution exceeds 3.0. Moreover, since temperature for fragmentation of the stable nitroxyl is high, the process requires a polymerization temperature of 80° C. or higher which is far higher than the boiling point of chloroprene, so that there are a defect of easy occurrence of deterioration and coloring of polychloroprene and the like defects. In the conventional radical polymerization of chloroprene, it is well known in RUBBER CHEMISTRY AND TECHNOLOGY vol. 50, page 49 (1977) and vol. 51, page 668 (1978) (Coleman et al.) that the ratio of the 1,2- and isomerized 1,2-bonds in the chloroprene polymer chain increases as the polymerization temperature is elevated. Since the increase in bonding modes other than the 1,4-trans bond, such as the 1,2- and isomerized 1,2-bonds, inhibits crystallization of polychloroprene, adhesion strength as an adhesive and an exhibiting rate thereof are decreased and also the unstable allyl chlorine contained in these bonds is known to be an initiation point of polymer deterioration (Encyclopedia of Polymer Science and Engineering (2nd Edition) vol. 3, page 441 (1985)).

Patent Document 8 discloses living radical polymerization of chloroprene using a dithiocarbamte ester but there is no description of a chloroprene block copolymer. Patent Documents 9 and 10 describes that production of various block copolymers are possible by a reversible addition-fragmentation chain transfer (RAFT) polymerization process using a dithiocarboxylate ester but there is no description of polymerization of chloroprene and synthesis of a polychloroprene block copolymer as well as a block-formation ratio and physical properties of the block copolymers.

### Patent Document 1: JP-A-58-89602

### Patent Document 2: JP-B-52-32987

### Patent Document 3: JP-T-2004-530751

### Patent Document 4: JP-A-2005-513252

### Patent Document 5: JP-A-2-300217

### Patent Document 6: JP-A-3-212414

### Patent Document 7: JP-A-2002-348340

### Patent Document 8: JP-A-2004-115517

### Patent Document 9: WO98/01478

### Patent Document 10: JP-A-2003-155463

### DISCLOSURE OF THE INVENTION

### Problems that the Invention is to Solve

As above, there have been strongly desired a novel chloroprene-based block copolymer and a CR-based latex, as well as convenient processes for producing the same for the purpose of improving adhesiveness of conventional chloroprene adhesives, adhesiveness and water resistance of CR latex adhesives, or oil resistance and adhesiveness of SBC.

### Means for Solving the Problems

As a result of extensive studies for solving the above problems, the present inventors have found that the conventional problems can be solved by the following findings: when chloroprene or the like is radically polymerized in the presence of a polymer (A) obtained by radical polymerization of a radically polymerizable monomer in the presence of a specific compound or a specific radically polymerizable monomer is radically polymerized in the presence of a chloroprene-based polymer (B) obtained by radical polymerization of chloroprene or the like in the presence of a specific compound, a chloroprene-based block copolymer wherein the polymer (A) is linked to one terminal or both terminals of a chloroprene-based polymer is obtained including a chloroprene-based block copolymer wherein the chloroprene-based polymer (B) is linked to the terminal(s) of the polymer (A); and further a stable soapless CR latex is obtained by emulsion polymerization of chloroprene or chloroprene and a monomer polymerizable with chloroprene using an amphipathic CR-based copolymer (hereinafter sometimes refers to as amphipathic CR) wherein a hydrophilic oligomer or polymer is linked to a CR polymer. Thus, they have accomplished the invention.

Namely, the invention lies in a chloroprene-based block copolymer comprising a polymer (A) having a composition represented by the following formula (1) and a chloroprene-based polymer (B), the polymer (A) being linked to one terminal or both terminals of the chloroprene-based polymer (B), and the total amount of the 1,2-bond and the isomerized 1,2-bond in the chloroprene-based polymer (B) as determined by carbon-13 nuclear magnetic resonance spectrometry being 2.0 mol % or less; a soapless polychloroprene-based latex comprising an amphipathic chloroprene copolymer having a hydrophobic chloroprene-based polymer and a hydrophilic oligomer or polymer having an acidic functional group linked to the hydrophobic chloroprene-based polymer and 2 wt % or less of an emulsifying agent; and processes for producing the same:

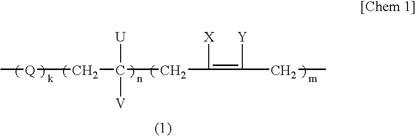

wherein U represents hydrogen, a methyl group, a cyano group, or a substituted alkyl group; V represents a phenyl group, a substituted phenyl group, a carboxyl group, an alkoxycarbonyl group, a substituted alkoxycarbonyl group, an allyloxycarbonyl group, a substituted allyloxycarbonyl group, an acyloxy group, a substituted acyloxy group, an amido group, or a substituted amido group; X represents hydrogen, a methyl group, chlorine, or a cyano group; Y represents hydrogen, chlorine, or a methyl group; Q represents a polymerization residue of maleic anhydride, citraconic acid, maleic acid, fumalic acid, a maleate ester, or a fumalate ester; and k, n, and m each represents an integer of 0 or more.

### ADVANTAGE OF THE INVENTION

Since the chloroprene-based block copolymer obtained according to the invention has improved adhesiveness as compared with conventional chloroprene-based adhesives, it can be utilized as an adhesive or a primer for a wide variety of materials. Furthermore, the block copolymer is also expected to utilize as a polymer modifier, a resin compatibilizer, a dispersant, an emulsifier, a hot-melt adhesive, and a thermoplastic elastomer. Moreover, the soapless CR latex obtained in the invention can remarkably reduce an amount of an emulsifier which is conventionally contained in a large amount, the latex enables production of a CR latex-based adhesive, a primer, a sealant, a binder for capacitor electrodes, which have remarkably improved adhesiveness and water resistance.

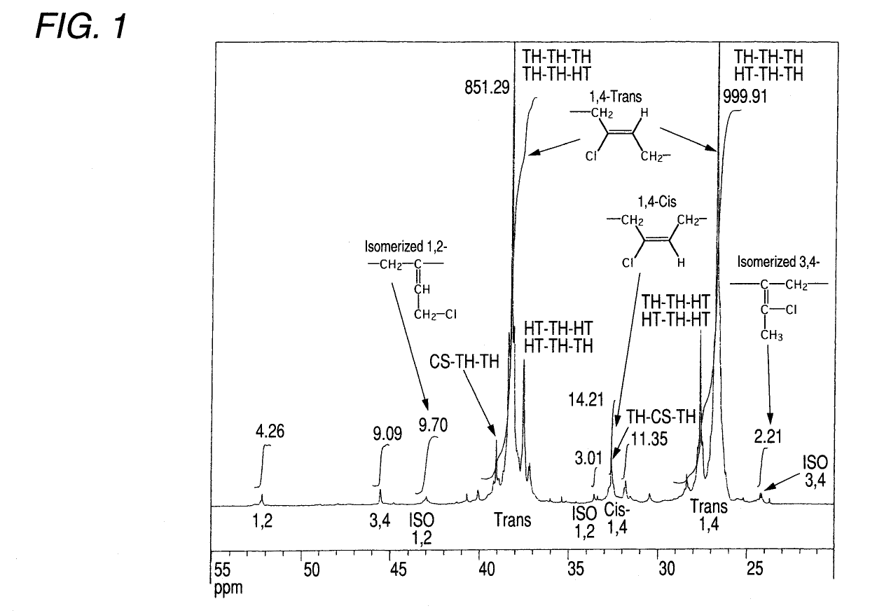

### BRIEF DESCRIPTION OF THE DRAWINGS

[FIG. 1]

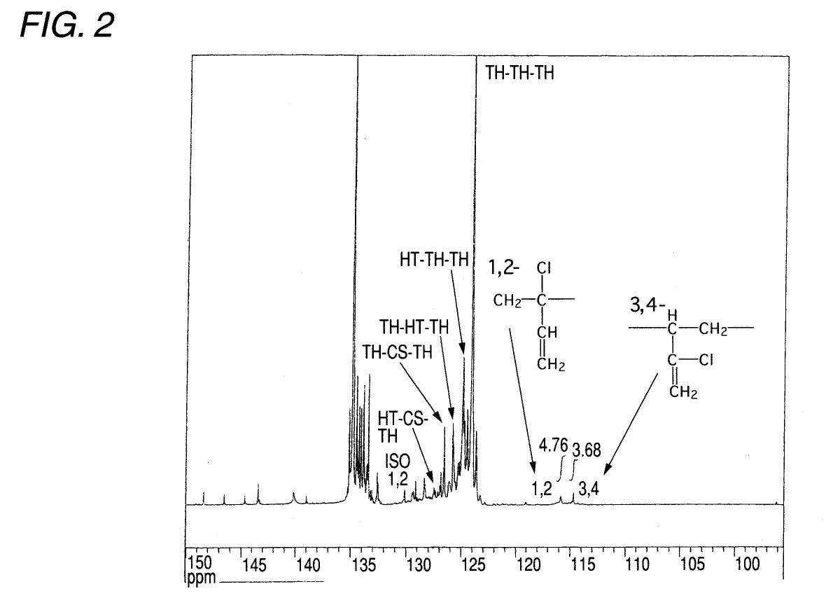

It shows a chemical shift range of 20 to 55 ppm of a figure showing carbon-13 nuclear magnetic resonance spectrum of polychloroprene obtained in Synthetic Example 8.

[FIG. 2]

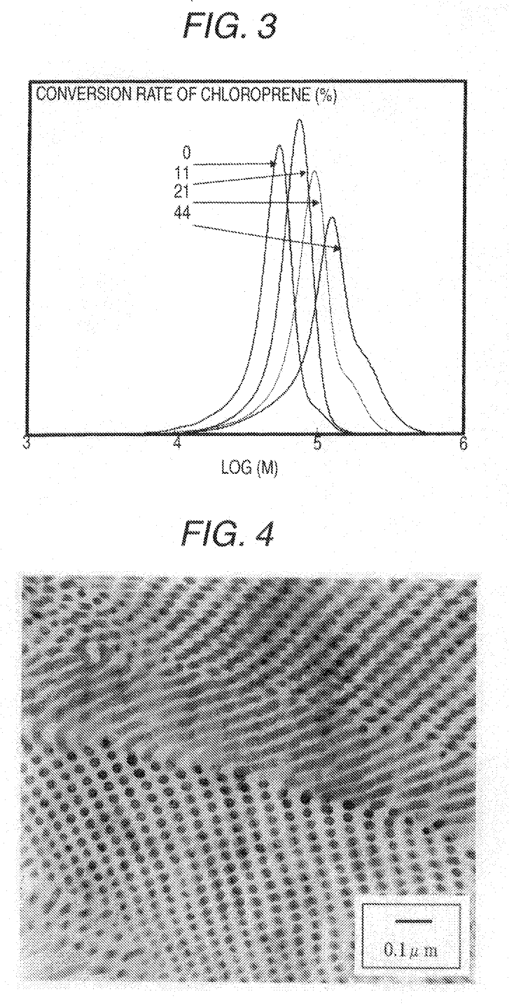

It shows a chemical shift range of 95 to 150 ppm of a figure showing carbon-13 nuclear magnetic resonance spectrum of polychloroprene obtained in Synthetic Example 8.

[FIG. 3]

It is a figure showing the relation between a conversion rate of polymerization of chloroprene and molecular weight distribution measured by GPC in Example 5.

[FIG. 4]

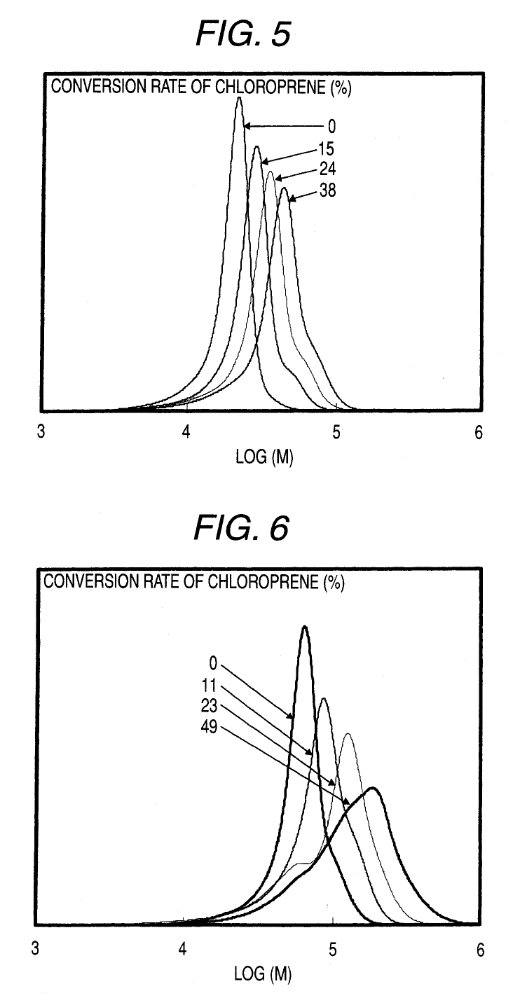

It is a figure showing a transmission electron microscopic photograph of the chloroprene-based block copolymer obtained in Example 5.

[FIG. 5]

It is a figure showing the relation between a conversion rate of polymerization of chloroprene and molecular weight distribution measured by GPC in Example 6.

[FIG. 6]

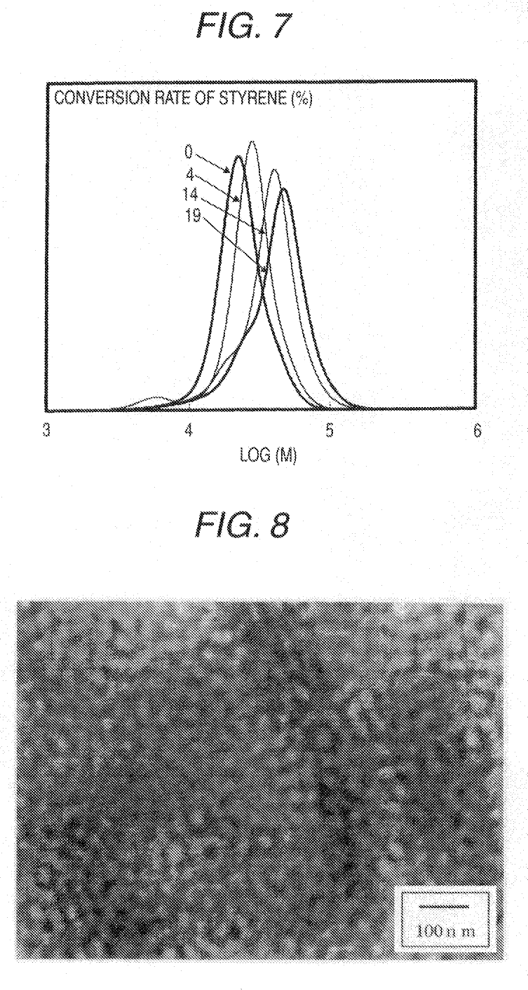

It is a figure showing the relation between a conversion rate of polymerization of chloroprene and molecular weight distribution measured by GPC in Example 7.

[FIG. 7]

It is a figure showing the relation between a conversion rate of polymerization of styrene and molecular weight distribution measured by GPC in Example 14.

[FIG. 8]

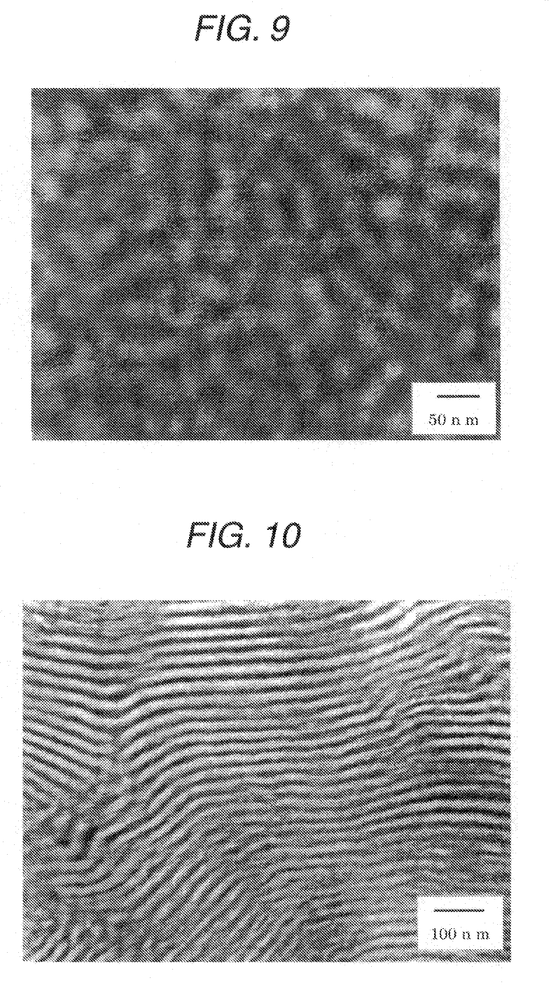

It is a figure showing a transmission electron microscopic photograph of the chloroprene-based block copolymer obtained in Example 16.

[FIG. 9]

It is a figure showing a transmission electron microscopic photograph of the chloroprene-based block copolymer obtained in Example 20.

[FIG. 10]

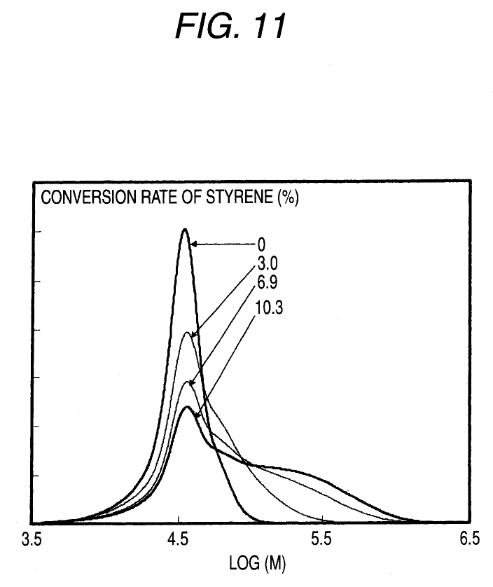

It is a figure showing a transmission electron microscopic photograph of the chloroprene-based block copolymer obtained in Example 21.

[FIG. 11]

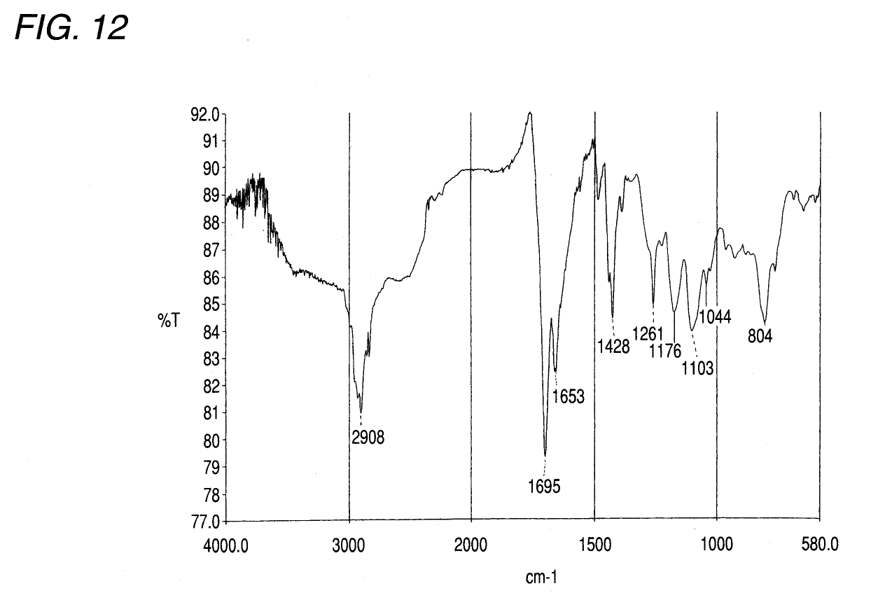

It is a figure showing the relation between a conversion rate of polymerization of styrene and molecular weight distribution measured by GPC in Comparative Example 2.

[FIG. 12]

It shows a figure showing an infrared absorption spectrum of the methacrylic acid-chloroprene-based block copolymer obtained in Synthetic Example 16.

### BEST MODE FOR CARRYING OUT THE INVENTION

The following will explain the present invention.

First, the chloroprene-based block copolymer will be explained in detail.

In the chloroprene-based block copolymer of the invention, a polymer (A) having the composition represented by the following formula (1) is linked to one terminal or both terminals of a chloroprene-based polymer (B):

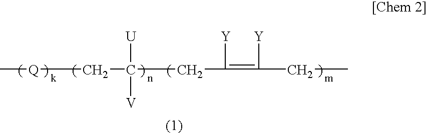

wherein U represents hydrogen, a methyl group, a cyano group, or a substituted alkyl group; V represents a phenyl group, a substituted phenyl group, a carboxyl group, an alkoxycarbonyl group, a substituted alkoxycarbonyl group, an allyloxycarbonyl group, a substituted allyloxycarbonyl group, an acyloxy group, a substituted acyloxy group, an amido group, or a substituted amido group; X represents hydrogen, a methyl group, chlorine, or a cyano group; Y represents hydrogen, chlorine, or a methyl group; Q represents a polymerization residue of maleic anhydride, citraconic acid, maleic acid, fumalic acid, a maleate ester, or a fumalate ester; and k, n, and m each represents an integer of 0 or more.

The polymer (A) is a necessary component for imparting properties such as polarity, hydrophilicity, adhesiveness, pressure-sensitive adhesiveness, thermal resistance, a high softening point, and water repellency to a chloroprene-based polymer, the properties being not possessed by the chloroprene-based polymer. The polymer (A) is a polymer block heterogeneous to a chloroprene-based polymer and includes a styrene-based polymer, an acrylate ester-based polymer, a methacrylate ester polymer, a 1,3-butadiene-based polymer, a vinyl ester-based polymer, and the like. The styrene-based polymer includes polystyrene, styrene/acrylonitrile copolymers, styrene/methacrylic acid/acrylonitrile copolymers, styrene/maleic anhydride copolymers, styrene/N-phenylmaleimide copolymers, styrene/fumalate ester copolymers, styrene/maleic acid copolymer, styrene/fumalic acid copolymers, and the like; the acrylate ester-based polymer includes polybutylacrylate, polyethyl acrylate, polymethyl acrylate, and the like; the methacrylate ester-based polymer includes polymethyl methacrylate, methyl methacrylate/glycidyl methacrylate copolymers, methyl methacrylate/methacrylic acid copolymers, and the like; the 1,3-butadiene-based polymer includes poly-2,3-dichloro-1,3-butadiene, 2,3-dichloro-1,3-butadiene/methacrylic acid/2-chloro-1,3-butadiene copolymers, and the like; and the vinyl ester-based polymer includes polyvinyl acetate, vinyl acetate/vinyl chloroacetate copolymers, and the like.

The chloroprene-based polymer (B) is not particularly limited so far as it falls within the range of chloroprene-based polymers not impairing the nature of chloroprene-based rubber and includes, for example, chloroprene polymers, chloroprene/2,3-dichloro-1,3-butadiene copolymers, chloroprene/styrene copolymers, chloroprene/methacrylate ester copolymers, chloroprene/maleic anhydride copolymers, chloroprene/fumalate ester copolymers, chloroprene/sulfur copolymers, and the like. Of these, the chloroprene polymers include polychloroprene, chloroprene/methacrylic acid copolymers, and the like; the chloroprene/2,3-dichloro-1,3-butadiene copolymers include chloroprene/2,3-dichloro-1,3-butadiene copolymers, chloroprene/2,3-dichloro-1,3-butadiene/methacrylic acid copolymers, and the like; the chloroprene/methacrylate ester copolymers include chloroprene/methyl methacrylate copolymers, chloroprene/methyl methacrylate/methacrylic acid copolymers, and the like. They can be produced using chloroprene or chloroprene and a monomer copolymerizable therewith.

In the chloroprene-based block copolymer of the invention, the total amount of the 1,2-bond and the isomerized 1,2-bond in the chloroprene-based polymer (B) as determined by carbon-13 nuclear magnetic resonance spectrometry is 2.0% by mol or less. In the case where the total amount of the 1,2-bond and the isomerized 1,2-bond exceeds 2.0% by mol, there are merits that crystallization is inhibited and these active chlorines can be utilized as reaction sites in applications such as horses and belts where crystallinity of the chloroprene-based polymer is unnecessary but there arises a severe defect of extremely easy occurrence of deterioration such as color change and gelation.

The carbon-13 nuclear magnetic resonance spectrometry is one of the most common methods for organic compound identification and is essential for microstructure analysis of polymers. The microstructures (bonding modes) of a chloroprene polymer consist of a 1,4-trans bond, a 1,4-cis bond, a 1,2-bond, an isomerized 1,2-bond, a 3,4-bond, and an isomerized 3,4-bond and the molar ratio of each bonding mode corresponds to area of each peak. The molar ratio of the amount of the 1,2-bond and the isomerized 1,2-bond in the chloroprene-based polymer (B) is determined based on the peak area ratio derived from the 1,2-bond and the isomerized 1,2-bond to the total of the above peak areas.

The ratio of the contents of the polymer (A) component and the chloroprene-based polymer (B) component in the chloroprene-based block copolymer of the invention varies depending on intended uses and applications but, in order to sufficiently utilize the characteristics of the chloroprene-based polymer, the chloroprene-based polymer (B) in the chloroprene-based block copolymer is present preferably in an amount of 40 to 99.5% by weight and particularly, for intended uses as an adhesive, a thermoplastic elastomer, a rubber compatibilizer, and a resin modifier, it is present in an amount of 50 to 99.5% by weight.

In the chloroprene-based block copolymer of the invention, the molecular weight distribution (Mw/Mn) represented by the ratio of weight-average molecular weight (Mw) to number-average molecular weight (Mn) determined by gel permeation chromatography (GPC) is not particularly limited but, in order to sufficiently utilize the characteristics of the chloroprene-based polymer (B) without impairing the sufficient rubber elasticity of the chloroprene-based polymer (B) in applications such as a thermoplastic elastomer, the distribution is preferably 2.5 or less, further preferably 2.1 or less.

The process for producing the chloroprene-based block copolymer of the invention includes a process comprising steps of synthesizing the polymer (A) by radical polymerization of a radically polymerizable monomer in the presence of a dithiocarbamate ester compound, a dithiocarboxylate ester compound, a dithiocarbamate ester compound and a disulfide compound, or a dithiocarboxylate ester compound and a disulfide compound and radically polymerizing chloroprene or chloroprene and a monomer copolymerizable therewith in the presence of the resulting polymer (A).

The radically polymerizable monomer for use in the synthesis of the polymer (A) is not particularly limited so far as it is a monomer capable of radical polymerization. However, for radical polymerization at a relatively high rate under relatively mild conditions, the monomer is preferably an acrylate ester-based monomer, a methacrylate ester-based monomer, acrylic acid, methacrylic acid, a styrene-based monomer, acrylonitrile, methacrylonitrile, a vinyl ester-based monomer, an acrylamide-based monomer, a methacrylamide-based monomer, a 1,3-butadiene-based monomer, or a combination of maleic anhydride, maleic acid, a fumalate ester, or an N-substituted maleimide, which does not undergo homopolymerization, with an electron-donating monomer such as styrene or isobutylene. These radically polymerizable monomers can be selected depending on the purposes of the chloroprene-based block copolymer. For example, in the case where adhesiveness toward a highly polar material or the like is desirably imparted to the chloroprene-based polymer, it is suitable to synthesize the polymer (A) using a monomer selected from acrylate ester-based monomers such as methyl acrylate, glycidyl acrylate, 2-hydroxyethyl acrylate, 2-hydroxypropyl acrylate, 4-hydroxybutyl acrylate, 2-(dimethylamino)ethyl acrylate, 2-(diethylamino)ethyl acrylate, 3-(dimethylamino)propyl acrylate, 2-(isocyanato)ethyl acrylate, and 2,4,6-tribromophenyl acrylate; methacrylate ester-based monomers such as methyl methacrylate, glycidyl methacrylate, 2-hydroxyethyl methacrylate, 2-hydroxypropyl methacrylate, 4-hydroxybutyl methacrylate, 2-(dimethylamino)ethyl methacrylate, 2-(diethylamino)ethyl methacrylate, 3-(dimethylamino)propyl methacrylate, 2-(isocyanato)ethyl methacrylate, and 2,4,6-tribromophenyl methacrylate; vinyl ester-based monomers such as vinyl acetate and vinyl chloroacetate; acrylamide-based monomers such as acrylamide; methacrylamide-based monomers such as methacrylamide; acrylonitrile; methacrylonitrile; α-cyanoethyl acrylate; styrene-based monomers such as p-vinylbenzenesulfonic acid, p-vinylbenzenesulfonate salts, p-cyanostyrene, p-acetoxystyrene, p-styrenesulfonyl chloride, ethyl p-styrenesulfonyl, p-butoxystyrene, 4-vinylbenzoic acid, and α,α′-dimethylbenzylisocyanate; 1,3-butadiene-based monomers such as 2,3-dichloro-1,3-butadiene and 2-cyano-1,3-butadiene; maleic anhydride; an N-substituted maleimide; methacrylic acid; acrylic acid; maleic acid; fumalic acid; itaconic acid; and the like. In the case where adhesiveness toward a lowly polar rubber material is desirably imparted, it is suitable to synthesize the polymer (A) using a 1,3-butadiene-based monomer such as isoprene or butadiene. In the case where adhesiveness toward a lowly polar resin material is desirably imparted, it is suitable to synthesize the polymer (A) using a monomer selected from acrylate ester monomers such as ethyl acrylate, butyl acrylate, 2-ethylhexyl acrylate, 2-ethoxyethyl acrylate, 2-butoxyethyl acrylate, cyclohexyl acrylate, and 3-(trimetoxysilyl)propyl acrylate. In addition, in the case where water repellency and thermal resistance are desirably imparted to the chloroprene-based polymer, it is suitable to synthesize the polymer (A) using a monomer selected from acrylate ester monomers such as 2,2,3,3-tetrafluoropropyl acrylate, 2,2,2-trifluoroethyl acrylate, 2,2,3,3,3-pentafluoropropyl acrylate, and 2,2,3,4,4,4-hexafluorobutyl acrylate; and methacrylate ester monomers such as 2,2,3,3-tetrafluoropropyl methacrylate, 2,2,2-trifluoroethyl methacrylate, 2,2,3,3,3-pentafluoropropyl methacrylate, and 2,2,3,4,4,4-hexafluorobutyl methacrylate.

Then, by radical polymerization of chloroprene or chloroprene and a monomer copolymerizable therewith in the presence of the polymer (A) obtained by the synthesis, the chloroprene-based polymer (B) is linked to terminal(s) of the polymer (A), whereby the chloroprene-based block copolymer can be produced. The monomer copolymerizable with chloroprene includes, for example, 2,3-dichloro-1,3-butadiene, 2-cyano-1,3-butadiene, 1-chloro-1,3-butadiene, styrene, α-methylstyrene, (meth)acrylic acid, methyl (meth)acryalte, glycidyl (meth)acrylate, hydroxyethyl (meth)acrylate or hydroxypropyl (meth)acrylate, maleic anhydride, maleic acid, a fumalate ester, and the like. They are used in an amount of 30% by weight or less relative to 70% by weight or more of chloroprene but, in the case where rubber elasticity and tackiness of chloroprene are desirably retained, the amount is preferably 20% by weight or less relative to 80% by weight or more of chloroprene.

The dithiocarbamate ester compound for use in the production of the chloroprene-based block copolymer of the invention is a compound having a function of enabling photo-iniferter polymerization, namely a compound having all functions of a polymerization initiator, a chain transferring agent, and a terminator and is not particularly limited so far as it is a compound having an ability of reversibly terminating a propagation reaction of a polymer and there may be, for example, mentioned a compound represented by the following formula (2):

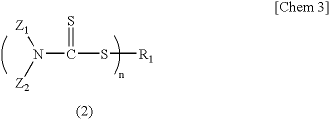

wherein R₁ represents an n-valent organic group having one or more carbon atoms, Z₁ and Z₂ each represents an alkyl group, a substituted alkyl group, an aryl group, or a substituted aryl group which each is an organic group having one or more carbon atoms, and n represents an integer of 1 or more.

Moreover, the dithiocarbamate ester compound for use in the production of the chloroprene-based block copolymer of the invention is not particularly limited so far as it is a compound having such a chain transferring reactivity that RAFT polymerization of the above monomer is enabled and is, for example, a compound represented by the following formula (3) or the following formula (4):

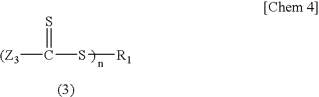

wherein R₁ represents an n-valent organic group having one or more carbon atoms, Z₃ represents an aryl group, a substituted aryl group, an allyl group, a substituted allyl group, an alkyl group substituted with an electron-withdrawing group, or an alkoxy group which each is a monovalent organic group having one or more carbon atoms;

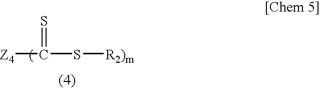

wherein R₂ represents an monovalent organic group having one or more carbon atoms, Z₄ represents an aryl group, a substituted aryl group, an allyl group, a substituted allyl group, an alkyl group substituted with an electron-withdrawing group, or an alkoxy group which each is an m-valent organic group having one or more carbon atoms.

Furthermore, the disulfide compound for use in the production of the chloroprene-based block copolymer of the invention is not particularly limited so far as it is a compound capable of a chain transferring reaction of a propagating radical and having a low polymerization initiating ability of a formed thiyl radical and is, for example, a compound represented by the following formula (5):

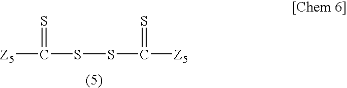

wherein Z₅ represents an aryl group, a substituted aryl group, an allyl group, a substituted allyl group, an alkyl group substituted with an electron-withdrawing group, an alkoxy group, an amino group, or a substituted amino group which each is a monovalent organic group having one or more carbon atoms.

The aforementioned dithiocarbamate ester compound or dithiocarboxylate ester compound may be used solely but is preferably used in combination with the aforementioned disulfide compound. Namely, in the case of using the dithiocarbamate ester compound and the disulfide compound in combination, side reactions such as radical coupling occurring during the above iniferter polymerization can be inhibited. Moreover, in the case of using the dithiocarboxylate ester compound and the disulfide compound in combination, the molecular weight distribution can be made sharper.

The dithiocarbamate ester compound represented by the formula (2) is described in detail in European Polymer Journal, vol. 31, No. 1, pp. 67-68 (1995) (Ohtu), Kogyo Kagaku Zasshi, vol. 63, No. 2, pp. 156-160 (1960) (Ohtu), and so on. Moreover, the dithiocarboxylate ester compounds represented by the formulae (3) and (4) and a process for synthesizing the same and the disulfide compound represented by the formula (5) and processes for synthesizing the same are described in detail in WO98/01478, WO99/31144, WO99/05099 (Rizzardo et al.), Tetrahedron, vol. 28, 3203-3216 (1972) (S. Oae et al.), Synthesis, 605-622 (1983) (S. R. Ramadas et al.), Tetrahedron Letters, vol. 23, 4087-4090 (1982), and so on. These compounds can be also used in the invention.

Moreover, as a compound having the same function as that of the above dithiocarbamate ester compound, there is xanthogenate ester compounds, which are disclosed, for example, in JP-T-2002-512653, JP-A-03-291265, and so on. The xanthogenate ester compound may be further used in combination.

The amount of the dithiocarbamate ester compound, the dithiocarboxylate ester compound, or the disulfide compound to be used in the invention is not particularly limited. Since the molecular weight of the polymer (A) and the polymer (B) constituting the chloroprene-based block copolymer of the invention is proportional to the amount of the polymerized monomer and is inversely proportional to the mol number of the polymer (A) containing the dithiocarbamate ester compound, the dithiocarboxylate ester compound, or a dithiocarbamate ester group, a dithiocarboxylate ester group, the amount of the polymer (A) containing the dithiocarbamate ester compound, the dithiocarboxylate ester compound, or the dithiocarbamate ester group, the dithiocarboxylate ester group may be suitably controlled depending on the molecular weight of the target polymer. The amount of the dithiocarbamate ester compound or the dithiocarboxylate ester compound is preferably 10 mol or less relative to 100 mol of the monomer from the viewpoint of obtaining a moldable polymer.

A radical polymerization is a method of generating radicals in a polymerization system by means of a radical initiator, heat, or a radiation such as ultraviolet rays or γ ray and polymerizing a monomer in a radical mechanism. In general, the monomer and a molecular weight controller such as a chain transferring agent are dissolved, dispersed, or emulsified in a medium such as an organic solvent or water and while a radical initiator such as a peroxide or an azo compound is added thereto or the whole is irradiated with a radiation such as ultraviolet rays, polymerization is carried out at a temperature of from room temperature or lower to about 100° C. for several hours to several dozen hours depending on the polymerizability of the monomer. For example, there may be mentioned an iniferter polymerization process wherein a monomer is radically polymerized with repeating fragmentation and recombination of a carbon-sulfur bond under irradiation with ultraviolet rays using a so-called iniferter acting as an initiator and also a chain transferring agent and also a terminator, such as a dithiocarbamate ester compound or a xanthogenate ester compound (the iniferter polymerization process is described in detain in Polymer Preprints, Japan (Kobunshi Gakkai Yokoshu) Vol. 31, No. 6 (1982), pp. 1289-1292, Polymer Preprints, Japan (Kobunshi Gakkai Yokoshu) Vol. 32, No. 6 (1983), pp. 1047-1052), a so-called RAFT (reversible addition-fragmentation chain transfer) polymerization process wherein, using a dithiocarboxylate ester compound, a dithiocarbamate ester compound, or a xanthogenate ester compound, a monomer and a propagating radical of a polymer are radically polymerized with repeating reversible addition, fragmentation, transfer reaction thereof to these compounds (the RAFT polymerization is described in detail in WO98/01478 (Eizo Rizzardo et al.), WO98/58974, WO99/35178 (Charmot Dominique et al.)), and the like processes.

As the radical initiator, there can be, for example, used a peroxide compound such as benzoyl peroxide, lauroyl peroxide, t-butyl hydroperoxide, paramenthane hydroperoxide, dicumyl peroxide, potassium persulfate, or ammonium persulfate; or an azo compound such as 2,2′-azobis(4-methoxy-2,4-dimethylvaleronitrile), 2,2′-azobis(2,4-dimethylvaleronitrile), 2,2′-azobis(2-methylpropionitrile), 2,2′-azobis(2-methylbutyronitrile), 1,1′-azobis(cyclohexane-1-carbonitrile), 1-[(1-cyano-1-methylethyl)azo]formaldehyde, dimethyl 2,2′-azobis(2-methylpropionate), 4,4′-azobis(4-cyanovaleric acid), 2,2′-azobis(2,4,4-trimethylpentane), 2,2′-azobis{2-methyl-N-[1,1′-bis(hydroxymethyl)-2-hydroxyethyl]propionamide}, 2,2′-azobis{2-(2-imidazolin-2-yl)propane}dihydrochloride, 2,2′-azobis{2-(2-imidazolin-2-yl)propane}disulfate dihydrate, 2,2′-azobis{2-[1-(2-hydroxyethyl)-2-imidazolin-2-yl]propane}}dihydrochloride, 2,2′-azobis(1-imino-1-pyrrolidino-2-methylpropane) dihydrochloride, 2,2′-azobis(2-methylpropionamidine) dihydrochloride, or 2,2′-azobis[N-(2-carboxyethyl)-2-methylpropionamidine]tetrahydrate. The lesser amount of the radical initiator is more preferred as compared with the mol number of the dithiocarboxylate ester compound and the dithiocarboxylate ester-containing polymer for the reason of obtaining a polymer and high-molecular-weight compound having a narrower molecular weight distribution.

The temperature at the radical polymerization is not particularly limited but is preferably 100° C. or lower. However, it is necessary that the temperature at the radical polymerization of chloroprene or chloroprene and a monomer copolymerizable therewith is 70° C. or lower. When the polymerization temperature exceeds 70° C., the total amount of the 1,2-bond and the isomerized 1,2-bond in the chloroprene-based polymer exceeds 2.0% by mol and stability of the chloroprene-based polymer is impaired. In order to further secure the stability of the chloroprene-based polymer, the temperature is preferably 60° C. or lower.

In the invention, the molecular weight of the polymer is proportional to the amount of the polymer produced and is inversely proportional to the amount of the dithiocarbamate ester compound, the dithiocarboxylate ester compound, and the disulfide compound. Therefore, the polymerization may be terminated by adding a radical polymerization terminator such as phenothiazine, 2,6-di-t-butyl-4-methylphenol, 2,2′-methylenebis(4-ethyl-6-t-butylphenol), tris(nonylphenyl) phosphite, 4,4′-thiobis(3-methyl-6-t-butylphenol), N-phenyl-1-naphthylamine, 2,2′-methylenebis(4-methyl-6-t-butylphenol), 2-mercaptobenzimidazole, or hydroquinone at the time when a target monomer conversion rate, i.e., molecular weight is achieved.

The polymerization of the monomer may be carried out without any solvent but, in view of temperature control and polymer recovery, solution polymerization using an aromatic solvent or halogenated hydrocarbon such as benzene, toluene, chlorobenzene, or methylene chloride or polymerization in a water medium is preferred. As the process for polymerization in a water medium, preferred is an emulsion polymerization process wherein a monomer and a molecular weight controller are emulsified in water with an emulsifier and polymerization is carried out in an emulsifier micelle by adding a radical initiator or mini-emulsion polymerization, suspension polymerization wherein a monomer, a molecular weight controller, and a radical initiator are dispersed in water with a small amount of an emulsifier or a dispersant and polymerization is effected in liquid drops of the monomer. Moreover, in the invention, after a monomer constituting the polymer (A) is polymerized, the polymer (A) may be once taken out of the polymerization system and then again dissolved in the above solvent and monomer and then a monomer constituting the polymer (B) may be polymerized but the polymerization into the polymer (B) may be carried out successively without taking out the polymer (A). Particularly, in the case where polymerization is carried out using a monomer having much higher radical reactivity than the monomer constituting the polymer (A), such as chloroprene, 2,3-dichloro-1,3-butadiene, or 2-cyano-1,3-butadiene, as a main component as a monomer constituting the polymer (B), they may be added in the course of the polymerization into the polymer (A).

As another process for producing the chloroprene-based block copolymer of the invention, there may be mentioned a process of synthesizing the chloroprene-based polymer (B) by radical polymerization of chloroprene or chloroprene and a monomer copolymerizable therewith in the presence of a dithiocarbamate ester compound, a disulfide compound, or a dithiocarbamate ester compound and a disulfide compound and radically polymerizing or copolymerizing a styrene-based monomer, 2,3-dichloro-1,3-butadiene, a methacrylic monomer, or a styrene-based monomer and maleic anhydride, citraconic anhydride, maleic acid, itaconic acid, an N-substituted maleimide, a fumalate ester, a maleate ester, or a vinylnitrile-based monomer copolymerizable with the styrene-based monomer in the presence of the resulting chloroprene-based polymer (B). Additionally, there may be mentioned a process of synthesizing the chloroprene-based polymer (B) by radical polymerization of chloroprene or chloroprene and a monomer copolymerizable therewith in the presence of a dithiocarbamate ester compound, a disulfide compound, or a dithiocarbamate ester compound and a disulfide compound and radically polymerizing or copolymerizing a styrene-based monomer, 2,3-dichloro-1,3-butadiene, or a styrene-based monomer and maleic anhydride, citraconic anhydride, maleic acid, itaconic acid, an N-substituted maleimide, a fumalate ester, a maleate ester, or a vinylnitrile-based monomer copolymerizable with the styrene-based monomer copolymerizable with the styrene-based monomer copolymerizable with the styrene-based monomer in the presence of the resulting chloroprene-based polymer (B).

In the production process, the chloroprene-based polymer (B) is first synthesized by radical polymerization of chloroprene or chloroprene and a monomer copolymerizable therewith in the presence of a dithiocarbamate ester compound, a dithiocarboxylate ester compound, or a disulfide compound. The process is advantageous since a resin-based polymer such as a styrene-based polymer can be easily block-copolymerized to both terminals of a chloroprene-based polymer. Such a triblock copolymer can be utilized as a novel thermoplastic elastomer, a hot-melt adhesive, a compatibilizer for blending CR with the other kind of polymer.

The dithiocarbamate ester compound, the dithiocarboxylate ester compound, the disulfide compound, chloroprene and the monomer copolymerizable therewith, radical polymerization, and the like are as previously described.

Then, by radically polymerizing or copolymerizing a styrene-based monomer, 2,3-dichloro-1,3-butadiene, or a styrene-based monomer and maleic anhydride, citraconic anhydride, maleic acid, itaconic acid, an N-substituted maleimide, a fumalate ester, a maleate ester, or a vinylnitrile-based monomer copolymerizable with the styrene-based monomer in the presence of the chloroprene-based polymer (B) obtained by the synthesis, the polymer (A) can be linked to one terminal or both terminals of the chloroprene-based polymer (B) to produce the chloroprene-based block copolymer of the invention. The styrene-based monomer to be used at that occasion includes styrene, p-vinylbenzenesulfonic acid, a p-vinylbenzenesulfonic acid salt, p-cyanostyrene, p-acetoxystyrene, p-styrenesulfonyl chloride, ethyl p-styrenesulfonyl, p-butoxystyrene, 4-vinylbenzoic acid, α-methylstyrene, and the like; the vinylnitrile includes acrylonitrile, methacrylonitrile, and the like; the N-substituted maleimide includes N-methylmaleimide, N-phenylmaleimide, and the like; and the fumalate ester includes dibutyl fumalate, cyclohexyl fumalate, butyl fumalate, ethyl fumalate, and the like.

The following will explain the soapless CR-based latex of the invention in detail.

The soapless CR-based latex of the invention remarkably reduces the amount of an emulsifier by utilizing the aforementioned CR-based block copolymer and contains 2 wt % or less of an emulsifying agent based on CR. When the amount of the emulsifier exceeds 2 wt %, the adhesiveness and water resistance of the CR-based latex remarkably decrease. The emulsifier is not particularly limited so far as it is an emulsifier commonly used and there may be mentioned an anionic emulsifier, a nonionic emulsifier, or a cationic emulsifier. For example, the anionic emulsifier includes potassium rhodinate, fatty acid salts, alkenylsuccinate salts, sodium alkyl sulfate, sodium sulfate higher alcohol esters, alkylbenzenesulfonate salts, alkyldiphenyl-ether-disulfonate salts, sulfonate salts of higher fatty acid amides, sulfate ester salts of higher fatty acid alkylolamides, alkylsulfo betains, and the like; the nonionic emulsifier includes polyoxyethylene alkyl ethers, polyoxyethylene sorbitan fatty acid esters, polyvinyl alcohol, and the like; and the cationic emulsifier includes alkylamine salts, quaternary ammonium salts, and the like.

The soapless CR-based latex of the invention contains an amphipathic chloroprene-based copolymer having a hydrophobic chloroprene-based polymer and a hydrophilic oligomer or polymer having an acidic functional group linked to the hydrophobic chloroprene-based polymer (an amphipathic chloroprene-based copolymer of CR diblock copolymer type is included in the chloroprene-based block copolymer previously described). By incorporating the amphipathic chloroprene-based copolymer, the amount of the conventional emulsifier to be used can be remarkably reduced. The content of the amphipathic chloroprene-based copolymer in the soapless CR-based latex is not particularly limited but, in order not to impair water resistance of the latex, the content of the hydrophilic monomer polymerization residue contained in the amphipathic chloroprene-based copolymer is preferably 10 wt % or less, more preferably 5 wt %, based on the polymers contained in the final latex.

The hydrophobic chloroprene-based polymer in the amphipathic chloroprene-based copolymer means a polymer comprising chloroprene as a main polymerization unit and, for example, chloroprene homopolymer, chloroprene copolymers, and the like may be mentioned. The monomer copolymerizable with chloroprene constituting the chloroprene copolymer includes 1,3-butadiens such as 2,3-dichloro-1,3-butadiene, 2-cyano-1,3-butadiene, and 1-chloro-1,3-butadiene; styrenes such as styrene, α-methylstyrene, p-chloromethylstyrene, p-cyanostyrene, p-acetoxystyrene, p-styrenesulfonyl chloride, ethyl p-styrenesulfonyl, p-butoxystyrene, 4-vinylbenzoic acid, and 3-isopropenyl-α,α′-dimethylbenzylisocyanate; methacrylate esters such as methyl methacrylate, glycidyl methacrylate, 2-hydroxyethyl methacrylate, 2-hydroxypropyl methacrylate, 4-hydroxybutyl methacrylate, 2-(dimethylamino)ethyl methacrylate, 2-(diethylamino)ethyl methacrylate, 3-(dimethylamino)propyl methacrylate, 2-(isocyanato)ethyl methacrylate, 2,4,6-tribromophenyl methacrylate, 2,2,3,3-tetrafluoropropyl methacrylate, 2,2,2-trifluoroethyl methacrylate, 2,2,3,3,3-pentafluoropropyl methacrylate, and 2,2,3,4,4,4-hexafluorobutyl methacrylate; acrylate esters such as butyl acrylate, ethyl acrylate, 2-ethylhexyl acrylate, 2-ethoxyethyl acrylate, 2-butoxyethyl acrylate, cyclohexyl acrylate, 3-(trimetoxysilyl)propyl acrylate, 2,2,3,3-tetrafluoropropyl acrylate, 2,2,2-trifluoroethyl acrylate, 2,2,3,3,3-pentafluoropropyl acrylate, and 2,2,3,4,4,4-hexafluorobutyl acrylate; as well as acrylonitrile, methacrylonitrile, α-cyanoethyl acrylate, maleic anhydride, methacrylic acid, acrylic acid, and the like. Of these, in view of relatively high radical copolymerizability with chloroprene, 2,3-dichloro-1,3-butadiene, 2-cyano-1,3-butadiene, 1-chloro-1,3-butadiene, styrene, methyl methacrylate, methacrylic acid, glycidyl methacrylate, 2-hydroxyethyl methacrylate, 2-hydroxypropyl methacrylate, 4-hydroxybutyl methacrylate, and α-cyanoethyl acrylate are preferred. 2,3-Dichloro-1,3-butadiene having the highest copolymerizability with chloroprene is further preferred.

Moreover, the hydrophilic oligomer or polymer having an acidic functional group in the amphipathic chloroprene-based copolymer means an oligomer or polymer soluble in water or an alkaline aqueous solution. For example, there may be mentioned polystyrenesulfonic acid, polyvinylsulfonic acid, phosphoric acid group-containing polyacrylate esters, polymethacrylic acid, polyacrylic acid, vinyl benzoic acid/styrene copolymers, maleic anhydride/styrene copolymers, maleic anhydride/p-methoxystyrene copolymers, maleic anhydride/isobutylene copolymers, maleic anhydride/chloroprene copolymers, maleic anhydride/2,3-dichlorobutadiene/chloroprene copolymers, maleic acid/chloroprene copolymers, and the like.

The hydrophilic oligomer or polymer is an essential component for stably dispersing CR latex particles in water and is obtained by radical polymerization of a monomer containing a hydrophilic group such as a sulfonic acid group, a phosphoric acid group, a carboxyl group and a salt thereof, a hydroxyl group, a polyalkylene oxide, an amino group, or a quaternary ammonium salt but may be a copolymer of a hydrophilic group-containing monomer with a copolymerizable monomer so far as hydrophilicity is not impaired. Alternatively, the oligomer or polymer can be also obtained by radical polymerization of a hydrophobic monomer having a functional group such as an ester group and subsequent conversion of the functional group into a hydrophilic group by hydrolysis with an acid or an alkali. The sulfonic acid group-containing monomer includes styrenesulfonic acid, 4-(methacryloyloxy)butylsulfonic acid, methallylsulfonic acid, vinylsulfonic acid, and salts thereof, and the like; a monomer having a functional group convertible into sulfonic acid includes alkyl p-styrenesulfonates, p-chlorosulfonylstyrene, and the like; the phosphoric acid group-containing monomer includes 2-(methacryloyloxy)ethyl phosphate and salts thereof, and the like. The carboxyl group-containing monomer includes methacrylic acid, acrylic acid, vinylbenzoic acid, maleic anhydride, maleic acid, crotonic acid, itaconic acid, fumalic acid, citraconic acid, mono-2-(methacryloyloxy)ethyl phthalate, mono-2-(methacryloyloxy)ethyl succinate, mono-2-(acryloyloxy)ethyl succinate, and salts thereof, and the like; and a monomer having a functional group convertible into carboxyl group includes t-butyl methacrylate, t-butyl acrylate, benzyl methacrylate, benzyl acrylate, and the like. The hydroxyl group-containing monomer includes 2-hydroxyethyl methacrylate, 2-hydroxyethyl acrylate, 2-hydroxypropyl methacrylate, 2-hydroxypropyl acrylate, 4-hydroxybutyl methacrylate, 4-hydroxybutyl acrylate, and the like; and a monomer having a functional group convertible into hydroxyl group includes glycidyl methacrylate, glycidyl acrylate, and the like. The polyalkylene oxide-containing monomer includes polyethylene glycol methacrylate, polyethylene glycol acrylate, and the like. The amino group-containing monomer includes dimethylaminoethyl methacrylate, dimethylaminoethyl acrylate, diethylaminoethyl methacrylate, diethylaminoethyl acrylate, and the like. The quaternary ammonium salt-containing monomer includes [(2-methacryloyloxy)ethyl]trimethylammonium chloride, [(2-acryloyloxy)ethyl]trimethylammonium chloride, and the like.

The amphipathic chloroprene-based copolymer having a hydrophobic chloroprene polymer and a hydrophilic oligomer or polymer having an acidic functional group linked to the hydrophobic chloroprene polymer means a polymer comprising a lipophilic polymer block and a hydrophilic polymer block and having an ability of emulsifying a monomer such as chloroprene in water, i.e., surface activity. For example, there may be mentioned those wherein a water-soluble monomer such as polystyrenesulfonic acid or polyalkylene oxide is linked to a hydrophobic chloroprene-based polymer, a chloroprene-based block copolymer represented by the following formula (6) in which a hydrophilic oligomer or polymer is linked to a hydrophobic chloroprene-based polymer:

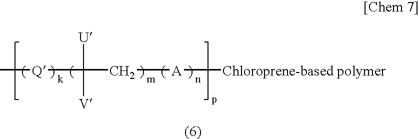

wherein U′ represents hydrogen, a methyl group, or a cyano group; V′ represents a methyl group, a carboxyl group, a carboxyl group-containing alkyl group, or a carboxyl group-containing aryl group; A represents a polymerization residue of chloroprene, 2,3-dichloro-1,3-butadiene, styrene, p-methoxystyrene, or isobutylene; Q′ represents a polymerization residue of maleic anhydride, citraconic acid, maleic acid, or fumalic acid; k, m, and n each represents an integer of 0 or more; and p represents an integer of 1 or more.

Of these, in order to sufficiently emulsify a monomer such as chloroprene in water and to obtain a stable CR latex, preferred is a chloroprene-based block copolymer represented by the above formula (6) wherein a hydrophilic oligomer block or polymer block is linked to a hydrophobic chloroprene-based polymer. The chloroprene-based block copolymer represented by the above formula (6) includes, for example, polymethacrylic acid-CR diblock copolymers, polyacrylic acid-CR diblock copolymers, vinyl benzoate/styrene copolymer-CR diblock copolymers, maleic anhydride/styrene copolymer-CR diblock copolymers, maleic anhydride/p-methoxystyrene copolymer-CR diblock copolymers, maleic anhydride/isobutylene copolymer-CR diblock copolymers, maleic anhydride/chloroprene copolymer-CR diblock copolymers, maleic anhydride/styrene copolymer-CR diblock copolymers, maleic acid/chloroprene copolymer-CR diblock copolymers, maleic anhydride/2,3-dichlorobutadiene/chloroprene copolymer-CR diblock copolymers, and the like.

In the case where the soapless polychloroprene-based latex of the invention is used in the applications of an adhesive, a primer, and a sealing material in which water resistance against water from the outside, among the above monomers, preferred is the use of the sulfonic acid group-containing monomer, the phosphoric acid group-containing monomer, the carboxyl group-containing monomer, or the monomer having a functional group convertible into sulfonic acid, phosphoric acid, or carboxylic acid which are capable of exhibiting latex stability with lesser content of the hydrophilic oligomer or polymer. Furthermore, in consideration of solubility of the above monomers in a polymerization solvent, the use of the carboxyl group-containing monomer is preferred and, in consideration of the price and polymerization rate of the monomer, combinations of methacrylic acid, acrylic acid, or maleic anhydride with styrene, isobutylene, chloroprene, or the like (alternating copolymerization) are particularly preferred. Namely, in the case where the hydrophilic oligomer or polymer is synthesized using a monomer easily homo-polymerizable, such as methacrylic acid or acrylic acid, the monomers corresponding to Q′ and A in the formula (6) may not be present. On the other hand, in the case where the hydrophilic oligomer or polymer is synthesized using maleic anhydride, citraconic acid, maleic acid, fumaric acid (also referred to as 1,2-disubstituted monomer, which corresponds to Q′ in the formula (6)) which is not homo-polymerizable, an electron-donating monomer such as styrene, chloroprene, or isobutylene (corresponding to A in the formula (6)) which accelerates polymerization of the 1,2-substituted monomer, i.e., has alternating copolymerizability with the monomer may be used in combination with the 1,2-substituted monomer. In general, it is known that monomers having a high alternating copolymerizability are monomers having a cyclic structure, such as maleic anhydride and citraconic acid and the alternating copolymerizability of monomers having no cyclic structure, such as maleic acid and fumaric acid is low. However, it has been now found that the alternating copolymerizability of the 1,2-substituted monomer having no cyclic structure is increased in a living radical mechanism and thus even maleic acid can be sufficiently utilized in the synthesis of the amphipathic chloroprene-based copolymer.

Moreover, the soapless CR-based latex of the invention can be used in applications such as binders for secondary batteries and capacitor electrodes. In the case where the latex is used in these sealed systems which are shielded from the outside, i.e., in the case where the latex is used without any contact with water from the outside, a monomer containing a hydroxyl group, alkylene oxide, or an amino group or a monomer having a functional group convertible into a hydroxyl group or an amino group may be used.

The content of the hydrophilic oligomer or polymer in the above amphipathic chloroprene-based copolymer is not particularly limited but is preferably from 1 to 50 wt %, more preferably from 1 to 40 wt % in order to obtain a sufficient monomer emulsifying power and also to maintain water resistance.

As processes for producing the above amphipathic chloroprene-based copolymer, there may be mentioned a process of polymerization of the hydrophilic monomer by the above living radical polymerization wherein radical polymerization is carried out with suppressing deactivation of propagating radicals through recombination of the propagating radicals each other and disproportionation by converting polymer radicals (active species) in the course of propagation into covalent bond species (resting species) capable of reversible radical fragmentation by the action of light, heat, catalyst, or the like and subsequent block polymerization of chloroprene; a process of radical polymerization of chloroprene and the like using an azo compound having a hydrophilic oligomer block or a hydrophilic polymer block (so-called water-soluble macro-azo initiator) or a carboxyl group-containing azo compound as a radical initiator; a process of radical polymerization of chloroprene and the like using a mercaptan having a hydroxyl group, a carboxyl group, or the like as a chain transferring agent; a process of introducing a hydrophilic group into a terminal of the chloroprene polymer by radical polymerization of chloroprene in the presence of a radical initiator such as potassium persulfate or ammonium persulfate; a process of graft polymerization of a hydrophilic monomer to CR using an organic peroxide such as benzoyl peroxide in an organic solvent; a process of radical copolymerization of chloroprene with a reactive emulsifier; a process of radical polymerization of the hydrophilic monomer in the presence of a diphenylethylene and subsequent radical polymerization of chloroprene; and the like. In view of efficient introduction of the hydrophilic oligomer or polymer block into CR, it is suitable to utilize a living radical polymerization process. As the living radical polymerization process, for example, there may be mentioned the aforementioned iniferter polymerization process or RAFT polymerization process utilizing the dithiocarbamate ester compound, the xanthogenate ester compound, or the dithiocarboxylate ester compound, and a TEMPO process using a stable nitroxyl radical. The synthesis of the amphipathic chloroprene-based copolymer utilizing the processes is in the same manner as in the process for the chloroprene-based block copolymer as previously described. Moreover, as the other living radical polymerization, there is a process of atom transfer polymerization (ATRP) of the hydrophilic monomer using allyl chlorine which is contained in CR in a small amount as an initiator. The ATRP process is a process of living polymerization of a radically polymerizable monomer using an organic halide as an initiator, a metal complex such as copper(I) chloride, copper(I) bromide, an iron complex, or a ruthenium complex as a catalyst, and a nitrogen compound such as bipyridine or polyamine as a ligand for activating the catalyst. When the hydrophilic monomer is subjected to the ATRP polymerization utilizing allyl chlorine derived from the 1,2-bond usually contained in CR as an initiator, an amphipathic CR-based graft polymer can be obtained. The ATRP process is described in detail in Chemical Reviews, vol. 101, pp. 2921-2990 (2001) (K. Matyjaszewski et al.) and Chemical Reviews, vol. 101, pp. 3689-3745 (2001) (M. Sawamoto et al.) and these catalyst systems can be also used in the invention.

Of the above production processes, the iniferter polymerization process and the RAFT polymerization process are most preferred since polymerization of the hydrophilic monomer and chloroprene is possible at a lower temperature.

The soapless polychloroprene-based latex of the invention is characterized in that an amphipathic chloroprene-based copolymer having a hydrophobic chloroprene-based polymer and a hydrophilic oligomer or polymer having an acidic functional group linked to the hydrophobic chloroprene-based polymer is used at the production of the CR-based latex by emulsion polymerization of chloroprene or chloroprene and a monomer polymerizable with chloroprene. Particularly, in order to stably emulsify a monomer such as chloroprene and to obtain a stable latex, it is preferred to use an amphipathic chloroprene-based copolymer represented by the following formula (6) wherein a hydrophilic oligomer block or polymer block is linked to a hydrophobic chloroprene-based polymer.

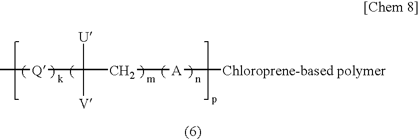

wherein U′ represents hydrogen, a methyl group, or a cyano group; V′ represents a methyl group, a carboxyl group, a carboxyl group-containing alkyl group, or a carboxyl group-containing aryl group; A represents a polymerization residue of chloroprene, 2,3-dichloro-1,3-butadiene, styrene, p-methoxystyrene, or isobutylene; Q′ represents a polymerization residue of maleic anhydride, citraconic acid, maleic acid, or fumalic acid; k, m, and n each represents an integer of 0 or more; and p represents an integer of 1 or more.

The above hydrophobic chloroprene-based polymer, hydrophilic oligomer or polymer having an acidic functional group, amphipathic chloroprene-based copolymer, and hydrophilic oligomer block or polymer block are the same as previously described.

The amount of the above amphipathic chloroprene-based copolymer to be used in the emulsion polymerization is not particularly limited so far as it can sufficiently emulsify the monomer and a sufficient stability of the formed latex can be maintained but, in consideration of increase in viscosity of the latex, is preferably 30 wt % or less of the total charged monomer, and is more preferably 20 wt % or less in consideration of adhesiveness and water resistance of the finally obtained latex.

The process for emulsion polymerization of chloroprene or chloroprene and a monomer polymerizable therewith in the production of the soapless polychloroprene-based latex of the invention is the same as the conventional emulsion polymerization except that the amphipathic chloroprene copolymer having a hydrophobic chloroprene-based polymer and a hydrophilic oligomer or polymer having an acidic functional group linked to the hydrophobic chloroprene-based polymer is used.

The following will explain examples of the production of the amphipathic chloroprene-based copolymer and the production of the soapless CR-based latex using the amphipathic chloroprene-based copolymer.

First, by radical polymerization of a hydrophilic monomer using a dithiocarbamate ester compound, a xanthogenate ester compound, or a dithiocarboxylate ester compound, or the like as a polymerization controller by the above iniferter polymerization process or RAFT polymerization process in a solvent such as tetrahydrofuran or dioxane, a hydrophilic oligomer or polymer having a dithiocarbamate ester compound, xanthogenate ester compound, or dithiocarboxylate ester compound terminal. Subsequently, by adding chloroprene to carry out radical block-copolymerization, an amphipathic CR having a structure where CR is linked to the hydrophilic oligomer or polymer block can be synthesized. By pouring the polymer solution into an aqueous solution of a basic compound such as triethylamine, diethylamine, triethanolamine, diethanolamine, ethanolamine, propanolamine, N,N-dimethylethanolamine, morpholine, N-methylmorpholine, 2-amino-2-methyl-1-propanol, ammonia, sodium hydroxide, or potassium hydroxide, an aqueous amphipathic CR solution is prepared. As the basic compound, a low-molecular-weight amine such as triethylamine or ethanolamine or ammonia is preferred in consideration of adhesiveness and water resistance of the soapless CR latex. A monomer such as chloroprene and, if necessary, a molecular weight controller such as mercaptan are charged into the above aqueous solution to emulsify the monomer and then a radical initiator and, if necessary, a reducing agent are added to carry out polymerization. In order to prevent increase in 1,2-bond and isomerized 1,2-bond in CR to maintain stability of CR, the polymerization temperature is preferably 70° C. or lower. In order to further secure the stability of CR, the temperature is preferably 60° C. or lower. When a target monomer conversion rate is attained, a polymerization inhibitor (polymerization terminator) is added to terminate the polymerization. Thereafter, the unreacted monomer is removed by distillation under reduced pressure to obtain the soapless CR-based latex. Moreover, during or after the polymerization, a common emulsifier or dispersant may be added for the purpose of improving the stability of the latex, reducing the viscosity thereof, or reducing the surface tension thereof. However, the amount of these emulsifier and the like to be added is 2 wt % or less based on the CR-based polymer. When the amount exceeds 2 wt %, decrease in adhesiveness and water resistance of the CR latex by the emulsifier becomes remarkable. In order to suppress the adhesion inhibition by the emulsifier, the amount of the emulsifier to be contained in the latex is more preferably 1 wt % or less.

As the above molecular weight controller, there may be used a mercaptan such as n-dodecyl mercaptan, octyl mercaptan, t-butyl mercaptan, thighlycollic acid, or thiomalic acid; a sulfide such as diisopropylxanthogen disulfide, diethylxanthogen disulfide, or diethylthiuram disulfide; a dithicarboxylate ester such as benzyl dithiobenzoate, 2-cyanopropyl dithiobenzoate, 3-chloro-2-butenyl dithiobenzoate, S-(thiobenzoyl) thioglycollic acid, or cumyl dithibenzoate; a hologenated hydrocarbon such as iodoform; diphenylethylene, p-chlorodiphenylethylene, p-cyanodiphenylethylene, α-methylstyrene dimer, sulfur, or the like. The above radical initiator is the same as that in the production of the chloroprene-based block copolymer described above and as the reducing agent for accelerating the decomposition of the peroxide, a hydrosulfide, Rongalit, sodium sulfite, sodium thiosulfate, iron(II) sulfate, ascorbic acid, aniline, or the like can be used. As the above polymerization inhibitor (polymerization terminator), in addition to those usable in the production of the chloroprene-based block copolymer described above, there can be used N,N-diethylhydroxylamine or the like which is a water soluble polymerization inhibitor (polymerization terminator).

The soapless CR-based latex of the invention can be used as a water-based adhesive, a water-based primer, or a sealing agent after mixing with a tackifying resin such as a rhodinate ester resin, a terpene phenol resin, a petroleum resin, or a chroman-indene resin; an alkyl phenol resin; an inorganic filler such as silica, clay, aluminum paste, titanium oxide, or calcium carbonate; a thickener such as hydrophobic cellulose, a polycarboxylate salt, associative nonionic surfactant, polyalkylene oxide, or clay; a hardening agent such as a polyisocyanate compound, an epoxy resin, an oxazoline compound, or a carbodiimide compound; zinc oxide; a plasticizer; a wetting agent; an antifreezing agent; a film-making auxiliary; and the like.

Examples will be illustrated in the following for more specifically explaining the invention but the invention is not limited to these Examples.

First, Reference Example, Synthetic Examples 1 to 15, Examples 1 to 26, and Comparative Examples 1 to 5 are shown with regard to the chloroprene-based block copolymer of the invention. Incidentally, the values therein are measured by the following methods.

### <Monomer Conversion Rate>

The monomer conversion rate during polymerization was calculated using benzene as an internal standard by means of a gas chromatograph GC-17A manufactured by Shimadzu Corporation (a capillary column NEUTRABOND-5 manufactured by GL Science, a flame ionization detector).

### <Molecular Weight>

The number-average molecular weight Mn, weight-average molecular weight Mw, and molecular weight distribution Mw/Mn of a polymer were measured by means of GPC 8220 manufactured by Tosoh Corporation under the following conditions (eluent=tetrahydrofuran, flow rate=1.0 ml/min, column temperature=40° C., peak detection=differential refractometer, packed column=TSK-gel (registered trademark, the same shall apply hereinafter) G7000Hxl/GMHxl/GMHxl/G3000Hxl, molecular weight calculation=polystyrene conversion).

### <Elemental Analysis of Polymer>

The amounts of chlorine and sulfur in a polymer were measured by an oxygen flask combustion-ion chromatography method under the following conditions. After 20 mg of a polymer sample was precisely weighed, it was combusted by a flask combustion method and was absorbed in an absorbing solution consisting of 10 ml of N/100 aqueous sodium hydroxide solution to which 100 μl of 30% aqueous hydrogen peroxide solution had been added. The volume of the absorbing solution was made up to 50 ml with pure water and the chloride ion in the absorbing solution was quantitatively determined by ion chromatography. The measuring conditions of the ion chromatography were as follows: an ion chromatograph manufactured by Tosoh Corporation, column=TSKgel IC-Anion-PWXL PEEK, eluent=1.3 mM potassium gluconate, 1.3 mM borax, 30 mM boric acid, 10% by volume acetonitrile, 0.5% by volume of aqueous glycerin solution, column temperature=40° C., flow rate=1.2 ml/min, detector=an electric conductivity detector.

### <Electron Microscopic Observation of Copolymer>

The observation of microphase-separated structure of a copolymer was carried out by means of a transmission electron microscopy JEM-2000FX manufactured by JEOL Ltd. The procedure was as follows: after a copolymer sample embedded in a thermosetting epoxy resin was dyed with RuO4 vapor or OsO4 vapor, an ultrathin slice was prepared by an ultramicrotome and then observed at an accelerating voltage of 60 kV.

### <NMR Analysis of Chloroprene-Based Polymer>

With regard to the bonding modes in the chloroprene-based polymer (B), a spectrum was measured at a sample concentration of 15% by weight, a measuring temperature of room temperature, and an integration number of 60,000 times in chloroform by means of a carbon-13 nuclear magnetic resonance spectrometer GSX-400 manufactured by JEOL Ltd. and the total amounts of the 1,2-bond and the isomerized 1,2-bond were calculated based on area ratios of individual peaks.

### <Measurement of Infrared Spectrum of Polymer>

It was measured by a total reflection method by means of Spectrum 2000 manufactured by Perkin-Elmer.

### <Performance Evaluation as Solvent-Type Primer>

The performance evaluation of the chloroprene-based block copolymer as a solvent-type primer was carried out by the following method. A chloroprene-based block copolymer was dissolved in an appropriate solvent to form a primer solution. The primer solution was applied on a resin plate (120 mm×25 mm) with a brush and dried at room temperature for 15 minutes. Then, an adhesive having a composition shown in Table 1 (Y3OS represents a chloroprene rubber manufactured by Tosoh Corporation and MEK represents methyl ethyl ketone) was applied on the primer-applied surface. After drying at room temperature for 25 minutes, the same adhesive shown in Table 1 was applied twice and the resulting one was adhered to a dried No. 9 cotton sail cloth (120 mm×25 mm), followed by adhesion with pressure by means of a hand roller. After aging at room temperature for 7 days, 180° T-type peeling test was conducted under a condition of a tensile rate of 50 mm/min by means of a tensilon-type tensile tester.

TABLE 1

| | (parts by weight) |
|---|---|
| Y30S | 100 |
| MgO | 8 |
| ZnO | 2 |
| CKM1634* | 40 |
| Toluene | 270 |
| n-Hexane | 220 |
| MEK | 51 |

*An alkylphenol resin (manufactured by Showa Higholymer Co., Ltd.)

As the above resin plate, a soft polyvinyl chloride resin (manufactured by Japan Wavelock Co., Ltd., Content of di-2-ethylhexyl phthalate: 34% by weight), an acrylonitrile-butadiene-styrene (ABS) resin, and a polypropylene resin (PP) (manufactured by Sanplatec Co., Ltd.) were employed.

### <Color Fastness Test of Copolymer>

The color fastness of the chloroprene-based block copolymer was evaluated by the following method. A dry film was prepared from a 10% by weight of tetrahydrofuran solution of the copolymer by a casting method. After heating at 70° C. for 4 days in a gear oven or irradiation of the cast film with an ultraviolet ray of 254 nm at 20° C. for 6 hours, color tone of the film was visually evaluated. The color fastness was judged as follows: ◯: light yellow, Δ: yellow brown, and X: dark yellow brown.

### <Mechanical Properties Evaluation of Block Copolymer>

The mechanical properties of the chloroprene-based triblock copolymer were evaluated by the following method. A cast film was prepared at room temperature from a 10 wt % toluene solution of the triblock copolymer containing 1 wt % antioxidant (manufactured by Kawaguchi Chemical Industry Co., Ltd.: W-500) at room temperature. It was finely cut and subjected to electrothermal press molding (180° C., gauge pressure: 70 kg/cm²) to prepare a sheet having a thickness of 2 mm. The sheet was punched out into a dumbbell No. 6 shape (JIS K6251) and tensile properties were measured at a tensile rate of 200 mm/minute on a tensilon-type tensile tester.

### REFERENCE EXAMPLE

An adhesion test was conducted on the conventional chloroprene-based adhesive. Namely, a chloroprene homopolymer (Y-30 manufactured by Tosoh Corporation) was dissolved in a mixed solvent of acetone/methyl ethyl ketone/toluene=40/20/40% by weight to form a 5% solution. An adhesion test of the PP resin, the ABS resin, and the soft polyvinyl chloride was carried out under the same conditions as mentioned above except that the solution was used as a primer. As a result, the adhesion strength measured by peeling from the PP resin, ABS resin, and soft polyvinyl chloride interface were 15 N/25 mm, 20 N/25 mm, and 15 N/25 mm, respectively.

### Synthetic Example 1

Into a 200 ml Pyrex (registered trademark) glass flask fitted with a nitrogen gas-inlet tube were charged 0.30 g of a carbamate ester represented by the following formula (7), 30.0 g of styrene, 4.0 g of acrylonitrile, and 20.0 g of methyl ethyl ketone, followed by thorough degassing by repeating operations of freeze-pump-thaw cycle three times. Thereafter, polymerization was carried out under stirring under a nitrogen atmosphere for 20 hours under irradiation with ultraviolet rays (UM452 (450W) manufactured by Ushio Inc.) at a distance of 80 mm in a constant-temperature bath of 30° C. The conversion rates of the polymerization of styrene and acrylonitrile at this moment were 30% and 57%, respectively. The content was poured into a large amount of methanol to precipitate a polystyrene/acrylonitrile copolymer, thereby a polymer (A) being obtained. The number-average molecular weight Mn was 14,600, the weight-average molecular weight Mw was 29,100, and the molecular weight distribution Mw/Mn was 1.99, which were measured by GPC. The sulfur content in the polymer was 0.66 wt %.

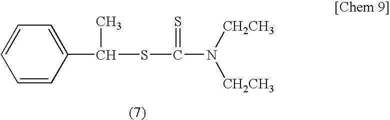

### Synthetic Example 2

Into a 200 ml Pyrex (registered trademark) glass flask fitted with a nitrogen gas-inlet tube were charged 0.30 g of a carbamate ester represented by the following formula (7), 0.14 g of a carbamate disulfide, 30.0 g of styrene, 5.0 g of acrylonitrile, and 20.0 g of methyl ethyl ketone, followed by thorough degassing by repeating operations of freeze-pump-thaw cycle three times. Thereafter, polymerization was carried out under stirring under a nitrogen atmosphere for 20 hours under irradiation with ultraviolet rays (UM452 (450W) manufactured by Ushio Inc.) at a distance of 80 mm in a constant-temperature bath of 30° C. The conversion rates of the polymerization of styrene and acrylonitrile at this moment were 29% and 56%, respectively. The content was poured into a large amount of methanol to precipitate a polystyrene/acrylonitrile copolymer, thereby a polymer (A) being obtained. The number-average molecular weight Mn was 13,100, the weight-average molecular weight Mw was 25,900, and the molecular weight distribution Mw/Mn was 1.98, which were measured by GPC. The sulfur content in the polymer was 0.67 wt %.

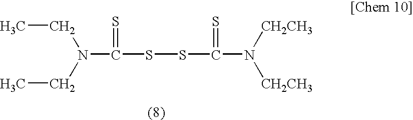

### Synthetic Example 3

Polymerization was initiated under the same conditions as in Synthetic Example 2 except that 50.0 g of methyl methacrylate is used instead of acrylonitrile and no solvent was used in Synthetic Example 2. After irradiation with ultraviolet rays for 10 hours, the conversion rate of polymerization of methyl methacrylate was 24%. The content was poured into a large amount of methanol to precipitate polymethyl methacrylate, thereby a polymer (A) being obtained. The number-average molecular weight Mn was 13,500, the weight-average molecular weight Mw was 24,900, and the molecular weight distribution Mw/Mn was 1.84, which were measured by GPC. The sulfur content in the polymer was 0.63 wt %.

### Synthetic Example 4

Polymerization was initiated under the same conditions as in Synthetic Example 3 except that 30.0 g of n-butyl acrylate is used instead of styrene and acrylonitrile in Synthetic Example 3. After irradiation with ultraviolet rays for 10 hours, the conversion rate of polymerization of n-butyl methacrylate was 29%. The unreacted monomer was removed by distillation under vacuum to precipitate poly-n-butyl acrylate, thereby a polymer (A) being obtained. The number-average molecular weight Mn was 13,500, the weight-average molecular weight Mw was 25,700, and the molecular weight distribution Mw/Mn was 1.90, which were measured by GPC. The sulfur content in the polymer was 0.63 wt %.

### Synthetic Example 5

Into a 200 ml brown flask fitted with a nitrogen gas-inlet tube and a reflux condenser were charged 0.69 g of a 4.00% by weight benzene solution of a dithiocarboxylate ester represented by the following formula (9), 0.30 g of a 1.60% by weight benzene solution of 2,2′-azobis(2-methylpropionitrile), 56.51 g of benzene, and 15.01 g of methyl methacrylate, followed by thorough degassing by repeating operations of freeze-pump-thaw cycle three times. Thereafter, the whole was heated on an oil bath of 60° C. under stirring with a magnetic stirrer under a nitrogen atmosphere. After 119 hours, the content was poured into a large amount of methanol to precipitate polymethyl methacrylate, thereby a polymer (A) being obtained. The conversion rate of the polymerization calculated from the dry weight of the resulting polymer (A) was 82.3%. The number-average molecular weight Mn was 53,700, the weight-average molecular weight Mw was 65,000, and the molecular weight distribution Mw/Mn was 1.21, which were measured by GPC.

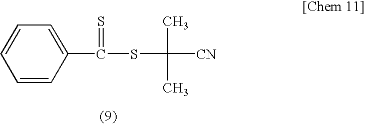

### Synthetic Example 6

Into a 200 ml brown flask fitted with a nitrogen gas-inlet tube and a reflux condenser were charged 1.78 g of a 4.00% by weight benzene solution of a dithiocarboxylate ester represented by the formula (9), 0.89 g of a 1.60% by weight benzene solution of 2,2′-azobis(2-methylpropionitrile), 66.18 g of benzene, and 18.05 g of styrene, followed by thorough degassing by repeating operations of freeze-pump-thaw cycle three times. Thereafter, the whole was heated on an oil bath of 60° C. under stirring with a magnetic stirrer under a nitrogen atmosphere. After 330 hours, the content was poured into a large amount of methanol to precipitate polystyrene, thereby a polymer (A) being obtained. The conversion rate of the polymerization calculated from the dry weight of the resulting polymer (A) was 40.0%. The number-average molecular weight Mn was 16,900, the weight-average molecular weight Mw was 19,400, and the molecular weight distribution Mw/Mn was 1.15, which were measured by GPC.

### Synthetic Example 7

Into a 300 ml brown flask fitted with a nitrogen gas-inlet tube and a reflux condenser were charged 2.91 g of a 5.00% by weight benzene solution of a dithiocarboxylate ester represented by the following formula (10), 0.41 g of a 1.60% by weight benzene solution of 2,2′-azobis(2-methylpropionitrile), 55.00 g of benzene, and 40.05 g of butyl acrylate, followed by thorough degassing by repeating operations of freeze-pump-thaw cycle three times. Thereafter, the whole was heated on an oil bath of 60° C. under stirring with a magnetic stirrer under a nitrogen atmosphere. After 44 hours, the content was poured into a large amount of a mixed solution of methanol/distilled water to precipitate polybutyl acrylate, thereby a polymer (A) being obtained. The conversion rate of the polymerization calculated from the dry weight of the resulting polymer (A) was 74.0%. The number-average molecular weight Mn was 45,500, the weight-average molecular weight Mw was 60,100, and the molecular weight distribution Mw/Mn was 1.32, which were measured by GPC.

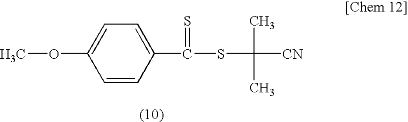

### Synthetic Example 8

Into a 300 ml brown flask fitted with a nitrogen gas-inlet tube and a reflux condenser were charged 2.33 g of a 4.00% by weight benzene solution of a dithiocarboxylate ester represented by the formula (10), 2.80 g of a 1.11% by weight benzene solution of 2,2′-azobis(2,4-dimethylvaleronitrile), 70.71 g of benzene, and 19.42 g of chloroprene subjected to simple distillation, followed by thorough degassing by repeating operations of freeze-pump-thaw cycle three times. Thereafter, the whole was heated on an oil bath of 40° C. under stirring with a magnetic stirrer under a nitrogen atmosphere. After 220 hours, the content was poured into a large amount of methanol to precipitate polychloroprene, thereby a chloroprene-based polymer (B) being obtained. The conversion rate of the polymerization calculated from the dry weight of the chloroprene-based polymer (B) was 49.2%. The number-average molecular weight Mn was 27,100, the weight-average molecular weight Mw was 34,400, and the molecular weight distribution Mw/Mn was 1.27, which were measured by GPC. The total amount of the 1,2-bond and the isomerized 1,2-bond in the polymer calculated based on the measurement by means of carbon-13 nuclear magnetic resonance spectrometer (FIGS. 1 and 2) was 0.7% by mol.

### Synthetic Example 9

Polymerization was carried out in the same manner as in Synthetic Example 5 except that 0.60 g of a 4.00% by weight benzene solution of a dithiocarboxylate ester represented by the formula (89), 0.25 g of a 1.60% by weight benzene solution of 2,2′-azobis(2-methylpropionitrile), 57.00 g of benzene, 15.00 g of methyl methacrylate, and 5.0 g of glycidyl methacrylate were charged into a 200 ml brown flask. After 120 hours, the content was poured into a large amount of methanol to precipitate a methyl methacrylate/glycidyl methacrylate copolymer, thereby a polymer (A) being obtained. The conversion rate of the polymerization calculated from the dry weight of the resulting polymer (A) was 86.2%. The number-average molecular weight Mn was 71,600, the weight-average molecular weight Mw was 88,800, and the molecular weight distribution Mw/Mn was 1.24, which were measured by GPC.

### Synthetic Example 10

Polymerization was carried out in the same manner as in Synthetic Example 5 except that 0.50 g of a 4.00% by weight benzene solution of a dithiocarboxylate ester represented by the formula (9), 0.40 g of a 1.60% by weight benzene solution of 2,2′-azobis(2-methylpropionitrile), 50.00 g of benzene, 25.00 g of styrene, 3.00 g of methacrylic acid, and 7.00 g of acrylonitrile were charged into a 300 ml brown flask. After 144 hours, the content was poured into a large amount of methanol to precipitate a styrene/methacrylic acid/acrylonitrile copolymer, thereby a polymer (A) being obtained. The conversion rate of the polymerization calculated from the dry weight of the resulting polymer (A) was 21.0%. The number-average molecular weight Mn was 44,600, the weight-average molecular weight Mw was 62,900, and the molecular weight distribution Mw/Mn was 1.41, which were measured by GPC.

### Synthetic Example 11

Polymerization was carried out in the same manner as in Synthetic Example 8 except that 2.25 g of a 4.00% by weight benzene solution of a dithiocarboxylate ester represented by the formula (9), 2.54 g of a 1.11% by weight benzene solution of 2,2′-azobis(2,4-dimethylvaleronitrile), 67.00 g of benzene, 10.00 g of 2,3-dichloro-1,3-butadiene, 2.00 g of methacrylic acid, and 9.00 g of 2-chloro-1,3-butadiene were charged into a 300 ml brown flask. After 168 hours, the content was poured into a large amount of methanol to precipitate a 2,3-dichloro-1,3-butadiene/methacrylic acid/2-chloro-1,3-butadiene copolymer, thereby a polymer (A) being obtained. The conversion rate of the polymerization calculated from the dry weight of the resulting polymer (A) was 57.2%. The number-average molecular weight Mn was 50,500, the weight-average molecular weight Mw was 91,900, and the molecular weight distribution Mw/Mn was 1.82, which were measured by GPC.

### Synthetic Example 12

Into a 300 ml brown flask fitted with a nitrogen gas-inlet tube and a reflux condenser were charged 4.00 g of a 3.95% by weight benzene solution of a dithiocarboxylate ester represented by the formula (9), 7.82 g of a 0.538% by weight benzene solution of 1,1′-azobis(cyclohexane-1-carbonitrile), 40.00 g of benzene, and 30.25 g of chloroprene subjected to simple distillation, followed by thorough degassing by repeating operations of freeze-pump-thaw cycle three times. Thereafter, the whole was heated on an oil bath of 80° C. under stirring with a magnetic stirrer under a nitrogen atmosphere. After 62 hours, the content was poured into a large amount of methanol to precipitate polychloroprene, thereby a chloroprene-based polymer (B) being obtained. The conversion rate of the polymerization calculated from the dry weight of the chloroprene-based polymer (B) was 62.9%. The number-average molecular weight Mn was 24,600, the weight-average molecular weight Mw was 38,900, and the molecular weight distribution Mw/Mn was 1.58, which were measured by GPC. The total amount of the 1,2-bond and the isomerized 1,2-bond in the polymer calculated based on the measurement by means of carbon-13 nuclear magnetic resonance spectrometer as in Synthetic Example 8 was 2.1% by mol.

### Synthetic Example 13

A polymer (A) was synthesized using no dithiocarboxylate ester. Namely, into a 200 ml brown flask fitted with a nitrogen gas-inlet tube and a reflux condenser were charged 1.32 g of a 5.94% by weight benzene solution of n-dodecyl mercaptan, 0.51 g of a 1.60% by weight benzene solution of 2,2′-azobis(2-methylpropionitrile), 58.19 g of benzene, and 20.33 g of methyl methacrylate, followed by thorough degassing by repeating operations of freeze-pump-thaw cycle three times. Thereafter, the whole was heated on an oil bath of 60° C. under stirring with a magnetic stirrer under a nitrogen atmosphere. After 62 hours, the content was poured into a large amount of methanol to precipitate polymethyl methacrylate, thereby a polymer (A) being obtained. The conversion rate of the polymerization calculated from the dry weight of the resulting polymer was 74.8%. The number-average molecular weight Mn was 44,000, the weight-average molecular weight Mw was 77,000, and the molecular weight distribution Mw/Mn was 1.73, which were measured by GPC.

### Synthetic Example 14

A chloroprene-based polymer (B) was synthesized using no dithiocarboxylate ester. Namely, into a 300 ml brown flask fitted with a nitrogen gas-inlet tube and a reflux condenser were charged 2.55 g of a 5.94% by weight benzene solution of n-dodecyl mercaptan, 2.01 g of a 1.493% by weight benzene solution of 2,2′-azobis(2,4-dimethylvaleronitrile), 45.74 g of benzene, and 23.33 g of chloroprene subjected to simple distillation, followed by thorough degassing by repeating operations of freeze-pump-thaw cycle three times. Thereafter, the whole was heated on an oil bath of 40° C. under stirring with a magnetic stirrer under a nitrogen atmosphere. After 140 hours, the content was poured into a large amount of methanol to precipitate polychloroprene, thereby a chloroprene-based polymer (B) being obtained. The conversion rate of the polymerization calculated from the dry weight of the chloroprene-based polymer (B) was 45.9%. The number-average molecular weight Mn was 36,600, the weight-average molecular weight Mw was 65,200, and the molecular weight distribution Mw/Mn was 1.78, which were measured by GPC. The total amount of the 1,2-bond and the isomerized 1,2-bond in the polymer calculated based on the measurement by means of carbon-13 nuclear magnetic resonance spectrometer as in Synthetic Example 8 was 0.6% by mol.

### Synthetic Example 15

Into a 200 ml Pyrex (registered trademark) glass flask fitted with a nitrogen gas-inlet tube and a reflux condenser were charged 0.15 g of a carbamate ester represented by the formula (7), carbamate disulfide, 90.0 g of benzene, and 40.0 g of chloroprene subjected to simple distillation, followed by thorough degassing by repeating operations of freeze-pump-thaw cycle three times. Thereafter, polymerization was carried out under stirring under a nitrogen atmosphere for 3 hours under irradiation with ultraviolet rays (UM452 (450W) manufactured by Ushio Inc.) at a distance of 80 mm in a constant-temperature bath of 80° C. The conversion rate of the polymerization of chloroprene at this moment was 35%. The content was poured into a large amount of methanol to precipitate polychloroprene, thereby a polymer (B) being obtained. The number-average molecular weight Mn was 53,300, the weight-average molecular weight Mw was 121,000, and the molecular weight distribution Mw/Mn was 2.27, which were measured by GPC. The total amount of the 1,2-bond and the isomerized 1,2-bond in the polymer calculated based on the measurement by means of carbon-13 nuclear magnetic resonance spectrometer as in Synthetic Example 8 was 2.1% by mol.

### Example 1

Into a 200 ml brown flask fitted with a nitrogen gas-inlet tube and a reflux condenser were charged 5.00 g of the polystyrene/acrylonitrile copolymer obtained in Synthetic Example 1 as a polymer (A) and 80.00 g of chloroprene subjected to simple distillation and then dissolution of the polymer was confirmed, followed by thorough degassing by repeating operations of freeze-pump-thaw cycle three times. Thereafter, polymerization was carried out under stirring under a nitrogen atmosphere for 10 hours under irradiation with ultraviolet rays (UM452 (450W) manufactured by Ushio Inc.) at a distance of 80 mm in a constant-temperature bath of 30° C. The conversion rate of the polymerization of chloroprene at this moment was 30%. The content was poured into a large amount of methanol to precipitate a polymer. The number-average molecular weight Mn was 93,200, the weight-average molecular weight Mw was 195,700, and the molecular weight distribution Mw/Mn was 2.10, which were measured by GPC. The peak of the original polystyrene/acrylonitrile copolymer completely disappeared and it was converted into higher-molecular-weight one, so that it was judged that a polystyrene/acrylonitrile copolymer-CR block copolymer was formed. The total amount of the 1,2-bond and the isomerized 1,2-bond in the polymer calculated based on the measurement by means of carbon-13 nuclear magnetic resonance spectrometer as in Synthetic Example 8 was 1.5% by mol.

The block copolymer was dissolved in toluene to prepare a 5% by weight primer solution. As a result of the adhesion test of the ABS resin using the solution as a primer, a peeling strength of 29 N/25 mm was exhibited.

As a result of evaluation of color fastness of the block copolymer, the film showed light yellow in any cases after heating in a gear oven or irradiation with ultraviolet ray, and thus the color fastness was judged as ◯.

### Example 2

Into a 200 ml brown flask fitted with a nitrogen gas-inlet tube and a reflux condenser were charged 5.00 g of the polystyrene/acrylonitrile copolymer obtained in Synthetic Example 2 as a polymer (A) and 80.00 g of chloroprene subjected to simple distillation and then dissolution of the polymer was confirmed, followed by thorough degassing by repeating operations of freeze-pump-thaw cycle three times. Thereafter, polymerization was carried out under stirring under a nitrogen atmosphere for 10 hours under irradiation with ultraviolet rays (UM452 (450W) manufactured by Ushio Inc.) at a distance of 80 mm in a constant-temperature bath of 30° C. The conversion rate of the polymerization of chloroprene at this moment was 29%. The content was poured into a large amount of methanol to precipitate a polymer. The number-average molecular weight Mn was 81,200, the weight-average molecular weight Mw was 166,500, and the molecular weight distribution Mw/Mn was 2.05, which were measured by GPC. The peak of the original polystyrene/acrylonitrile copolymer completely disappeared and it was converted into higher-molecular-weight one, so that it was judged that a polystyrene/acrylonitrile copolymer-CR block copolymer was formed. The total amount of the 1,2-bond and the isomerized 1,2-bond in the polymer calculated based on the measurement by means of carbon-13 nuclear magnetic resonance spectrometer as in Synthetic Example 8 was 1.5% by mol.

The block copolymer was dissolved in toluene to prepare a 5% by weight primer solution. As a result of the adhesion test of the ABS resin using the solution as a primer, a peeling strength of 29 N/25 mm was exhibited.

As a result of evaluation of color fastness of the block copolymer, the film showed light yellow in any cases after heating in a gear oven or irradiation with ultraviolet ray, and thus the color fastness was judged as ◯.

### Example 3

Polymerization of chloroprene was initiated in the same manner as in Example 2 except that 5.00 g of polymethyl methacrylate obtained in Synthetic Example 3 was used as a polymer (A) instead of the polystyrene/acrylonitrile copolymer in the Example 2. After irradiation with ultraviolet rays for 10 hours, the conversion rate of the polymerization of chloroprene was 31%. The content was poured into a large amount of methanol to precipitate a polymer. The number-average molecular weight Mn was 83,100, the weight-average molecular weight Mw was 165,400, and the molecular weight distribution Mw/Mn was 1.99, which were measured by GPC. The peak of the original polymethyl methacrylate completely disappeared and it was converted into higher-molecular-weight one, so that it was judged that a polymethyl methacrylate-CR diblock copolymer was formed. The total amount of the 1,2-bond and the isomerized 1,2-bond in the polymer calculated based on the measurement by means of carbon-13 nuclear magnetic resonance spectrometer as in Synthetic Example 8 was 1.6% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 25 N/25 mm was exhibited.

As a result of evaluation of color fastness of the block copolymer, the film showed light yellow in any cases after heating in a gear oven or irradiation with ultraviolet ray, and thus the color fastness was judged as ◯.

### Example 4

Polymerization of chloroprene was initiated in the same manner as in Example 2 except that 5.00 g of poly-n-butyl acrylate obtained in Synthetic Example 4 was used as a polymer (A) instead of the polystyrene/acrylonitrile copolymer in the Example 2. After irradiation with ultraviolet rays for 10 hours, the conversion rate of the polymerization of chloroprene was 31%. The content was poured into a large amount of methanol to precipitate a polymer. The number-average molecular weight Mn was 83,100, the weight-average molecular weight Mw was 174,500, and the molecular weight distribution Mw/Mn was 2.10, which were measured by GPC. The peak of the original poly-n-butyl acrylate completely disappeared and it was converted into higher-molecular-weight one, so that it was judged that a poly-n-butyl acrylate-CR diblock copolymer was formed. The total amount of the 1,2-bond and the isomerized 1,2-bond in the polymer calculated based on the measurement by means of carbon-13 nuclear magnetic resonance spectrometer as in Synthetic Example 8 was 1.4% by mol.

The block copolymer was dissolved in toluene to prepare a 5% by weight primer solution. As a result of the adhesion test of the PP resin using the solution as a primer, a peeling strength of 22 N/25 mm was exhibited.

As a result of evaluation of color fastness of the block copolymer, the film showed light yellow in any cases after heating in a gear oven or irradiation with ultraviolet ray, and thus the color fastness was judged as ◯.

### Example 5

Into a 100 ml brown flask fitted with a nitrogen gas-inlet tube and a reflux condenser were charged 7.16 g of polymethyl methacrylate obtained in Synthetic Example 5 as a polymer (A) and 25.11 g of benzene and then dissolution of the polymethyl methacrylate was confirmed. Thereafter, 7.71 g of chloroprene subjected to simple distillation and 2.12 g of a 0.18% by weight benzene solution of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. After 15 hours, 60 hours, and 200 hours, the reaction liquid was sucked in an amount of 0.5 to 1 ml by a syringe and then discharged into a glass sample bottle to which a minute amount of a polymerization terminator (manufactured by Kawaguchi Chemical Co., Ltd.: W-500) to terminate the polymerization, thereby a polymer being obtained. Then, by air-drying the unreacted chloroprene and benzene, the conversion rate of the polymerization of chloroprene was calculated from the dry weight. Also, the dry sample was used for GPC analysis. A relation of molecular weight distribution measured by GPC is shown in FIG. 3. It is obvious that the GPC curve of polymethyl methacrylate as the polymer (A) shifts to a high-molecular-weight side as polymerization of chloroprene proceeds.

The conversion rate of the polymerization of chloroprene after 200 hours was 43.8%, the number-average molecular weight Mn was 95,300, the weight-average molecular weight Mw was 135,000, and the molecular weight distribution Mw/Mn was 1.40. The chlorine content in the polymer was 12.4% by weight, which was almost coincident with the polychloroprene content of 32% by weight in the formed polymer calculated from the conversion rate of chloroprene. Furthermore, the polymer is soluble in acetone which is a non-solvent for polychloroprene and is a solvent for polymethyl methacrylate and shows a microphase separated structure where polychloroprene domains having a diameter of about 0.02 to 0.03μ are dispersed in a matrix of polymethyl methacrylate as shown in FIG. 4.

When all the above results are considered together, it is presumed that a chloroprene block copolymer having an average composition represented by the following formula (11) wherein chloroprene polymer is linked to the terminal(s) of polymethyl methacrylate is formed as a result of radical polymerization wherein chloroprene is reversibly chain-transferred to the dithiocarboxylate ester at the terminal(s) of the polymer (A), i.e., polymethyl methacrylate. The total amount of the 1,2-bond and the isomerized 1,2-bond in the polymer calculated based on the measurement by means of carbon-13 nuclear magnetic resonance spectrometer as in Synthetic Example 8 was 0.8% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 25 N/25 mm was exhibited.

As a result of evaluation of color fastness of the block copolymer, the film showed light yellow in any cases after heating in a gear oven or irradiation with the ultraviolet ray, and thus the color fastness was judged as ◯.

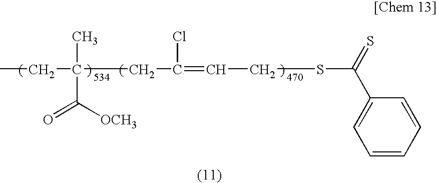

### Example 6

Into a 200 ml brown flask fitted with a nitrogen gas-inlet tube and a reflux condenser were charged 5.40 g of polystyrene obtained in Synthetic Example 6 as a polymer (A) and 40.05 g of benzene and then dissolution of the polystyrene was confirmed. Thereafter, 9.56 g of chloroprene subjected to simple distillation and 5.60 g of a 0.18% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. Then, in the same manner as in Example 5, after 40 hours, 110 hours, and 250 hours, the reaction liquid was sucked and a polymer was obtained, followed by measurement of the conversion rate of chloroprene and GPC of the formed polymer. A relation between the conversion rate of the polymerization of chloroprene and the molecular weight distribution measured by GPC is shown in FIG. 5. It is obvious that the GPC curve of polystyrene as the polymer (A) shifts to a high-molecular-weight side as the polymerization of chloroprene proceeds. The conversion rate of the polymerization of chloroprene after 250 hours was 37.9%, and the number-average molecular weight Mn was 34,600, the weight-average molecular weight Mw was 44,600, and the molecular weight distribution Mw/Mn was 1.29, which were measured by GPC. Moreover, the polymer is soluble in acetone which is a non-solvent for polychloroprene.

From the above results, it is presumed that the formed polymer is a chloroprene block copolymer having an average composition represented by the following formula (12) wherein chloroprene polymer is linked to the terminal(s) of polymethyl methacrylate. That is, it is a result of radical polymerization while chloroprene is reversibly chain-transferred to the dithiocarboxylate ester group at the terminal of the polymer (A). The total amount of the 1,2-bond and the isomerized 1,2-bond in the polymer calculated based on the measurement by means of carbon-13 nuclear magnetic resonance spectrometer as in Synthetic Example 8 was 0.9% by mol.

The block copolymer was dissolved in toluene to prepare a 5% by weight primer solution. As a result of the adhesion test of the ABS resin using the solution as a primer, a peeling strength of 30 N/25 mm was exhibited.

As a result of evaluation of color fastness of the block copolymer, the film showed light yellow in any cases after heating in a gear oven or irradiation with the ultraviolet ray, and thus the color fastness was judged as ◯.

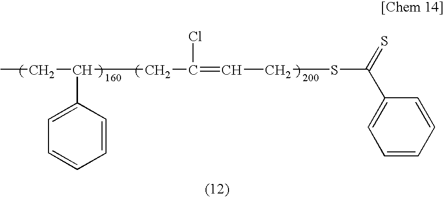

### Example 7

Into a 200 ml brown flask fitted with a nitrogen gas-inlet tube and a reflux condenser were charged 7.49 g of polybutyl acrylate obtained in Synthetic Example 7 as a polymer (A) and 55.46 g of benzene and then dissolution of the polybutyl acrylate was confirmed. Thereafter, 17.15 g of chloroprene subjected to simple distillation and 2.02 g of a 1.11% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. Then, in the same manner as in Example 5, after 20 hours, 64 hours, and 230 hours, the reaction liquid was sucked and a polymer was obtained, followed by measurement of the conversion rate of chloroprene and GPC of the formed polymer. A relation between the conversion rate of the polymerization of chloroprene and the molecular weight distribution measured by GPC is shown in FIG. 6. It is obvious that the GPC curve of polystyrene as the polymer (A) shifts to a high-molecular-weight side as the polymerization of chloroprene proceeds. The conversion rate of the polymerization of chloroprene after 230 hours was 48.6%, and the number-average molecular weight Mn was 100,000, the weight-average molecular weight Mw was 163,500, and the molecular weight distribution Mw/Mn was 1.63, which were measured by GPC. Moreover, the polymer is soluble in acetone which is a non-solvent for polychloroprene and is a solvent for polybutyl acrylate.

From the above results, it is presumed that the formed polymer is a chloroprene block copolymer having an average composition represented by the following formula (13) wherein chloroprene polymer is linked to terminal(s) of polymethyl methacrylate. That is, it is a result of radical polymerization while chloroprene is reversibly chain-transferred to the dithiocarboxylate ester group at the terminal of the polymer (A). The total amount of the 1,2-bond and the isomerized 1,2-bond in the polymer calculated based on the measurement by means of carbon-13 nuclear magnetic resonance spectrometer as in Synthetic Example 8 was 0.7% by mol.

The block copolymer was dissolved in toluene to prepare a 5% by weight primer solution. As a result of the adhesion test of the PP resin using the solution as a primer, a peeling strength of 22 N/25 mm was exhibited.

As a result of evaluation of color fastness of the block copolymer, the film showed light yellow in any cases after heating in a gear oven or irradiation with the ultraviolet ray, and thus the color fastness was judged as ◯.

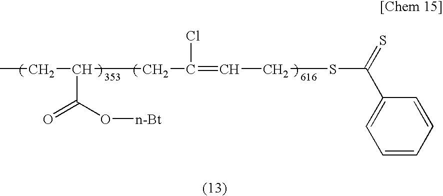

### Example 8

Into a 200 ml brown flask fitted with a nitrogen gas-inlet tube and a reflux condenser were charged 6.02 g of the polymethyl methacrylate/glycidyl methacrylate copolymer obtained in Synthetic Example 9 as a polymer (A) and 55.02 g of benzene and then dissolution of the polymethyl methacrylate/glycidyl methacrylate copolymer was confirmed. Thereafter, 18.15 g of chloroprene subjected to simple distillation and 1.72 g of a 1.11% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. Then, in the same manner as in Example 5, a polymer was obtained and the conversion rate of chloroprene and GPC of the formed polymer were measured. The conversion rate of the polymerization of chloroprene after 230 hours was 45.6%, the number-average molecular weight Mn was 162,000, the weight-average molecular weight Mw was 288,000, and the molecular weight distribution Mw/Mn was 1.73. The GPC peak of the polymer (A) shifted to a high-molecular-weight side as the polymerization of chloroprene proceeded. Accordingly, it is considered that a block copolymer of the polymethyl methacrylate/glycidyl methacrylate copolymer and polychloroprene is formed. The total amount of the 1,2-bond and the isomerized 1,2-bond in the polymer calculated based on the measurement by means of carbon-13 nuclear magnetic resonance spectrometer as in Synthetic Example 8 was 0.7% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 25 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 9

Into a 500 ml brown flask fitted with a nitrogen gas-inlet tube and a reflux condenser were charged 2.00 g of the styrene/methacrylic acid/acrylonitrile copolymer obtained in Synthetic Example 10 as a polymer (A) and 20.00 g of benzene and then dissolution of the styrene/methacrylic acid/acrylonitrile copolymer was confirmed. Thereafter, 70.00 g of chloroprene subjected to simple distillation and 1.32 g of a 1.11% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 30° C. under a nitrogen atmosphere. Then, in the same manner as in Example 5, a polymer was obtained and the conversion rate of chloroprene and GPC of the formed polymer were measured. The conversion rate of the polymerization of chloroprene after 144 hours was 7.7%, and the number-average molecular weight Mn was 198,000, the weight-average molecular weight Mw was 376,200, and the molecular weight distribution Mw/Mn was 1.90, which were measured by GPC. The GPC peak of the polymer (A) shifted to a high-molecular-weight side as the polymerization of chloroprene proceeded. Accordingly, it is considered that a block copolymer of the styrene/methacrylic acid/acrylonitrile copolymer and polychloroprene is formed. The total amount of the 1,2-bond and the isomerized 1,2-bond in the polymer calculated based on the measurement by means of carbon-13 nuclear magnetic resonance spectrometer as in Synthetic Example 8 was 0.5% by mol.

The block copolymer was dissolved in toluene to prepare a 5% by weight primer solution. As a result of the adhesion test of the ABS resin using the solution as a primer, a peeling strength of 35 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 10

Into a 200 ml brown flask fitted with a nitrogen gas-inlet tube and a reflux condenser were charged 5.00 g of the 2,3-dichloro-1,3-butadiene/methacrylic acid/2-chloro-1,3-butadiene copolymer obtained in Synthetic Example 11 as a polymer (A) and 55.00 g of benzene and then dissolution of the copolymer was confirmed. Thereafter, 20.04 g of chloroprene subjected to simple distillation and 1.60 g of a 1.11% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. Then, in the same manner as in Example 5, a polymer was obtained and the conversion rate of chloroprene and GPC of the formed polymer were measured. The conversion rate of the polymerization of chloroprene after 230 hours was 52.3%, and the number-average molecular weight Mn was 126,300, the weight-average molecular weight Mw was 246,300, and the molecular weight distribution Mw/Mn was 1.95, which were measured by GPC. The GPC peak of the polymer (A) shifted to a high-molecular-weight side by the polymerization of chloroprene. Accordingly, it is considered that a block copolymer of the 2,3-dichloro-1,3-butadiene/methacrylic acid/2-chloro-1,3-butadiene copolymer and polychloroprene is formed. The total amount of the 1,2-bond and the isomerized 1,2-bond in the polymer calculated based on the measurement by means of carbon-13 nuclear magnetic resonance spectrometer as in Synthetic Example 8 was 1.7% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 30 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 11

Into a 500 ml brown flask fitted with a nitrogen gas-inlet tube and a reflux condenser were charged 1.02 g of polymethyl methacrylate obtained in Synthetic Example 5 as a polymer (A) and 15.34 g of benzene and then dissolution of the polymethyl methacrylate was confirmed. Thereafter, 65.17 g of chloroprene subjected to simple distillation and 0.20 g of a 1.49% by weight of 2,2′-azobis(2,4-dimethylvaleronitrile) were charged thereinto, followed by thorough degassing by repeating operations of freeze-pump-thaw cycle three times. Thereafter, polymerization was carried out in the same manner as in Example 5 on an oil bath of 30° C. under a nitrogen atmosphere, thereby a polymer being obtained. The conversion rate of the polymerization of chloroprene after 139 hours was 7.4%, the number-average molecular weight Mn was 298,000, the weight-average molecular weight Mw was 506,600, and the molecular weight distribution Mw/Mn was 1.70. In GPC measurement, the GPC peak of the polymer (A) shifted to a high-molecular-weight side as the polymerization of chloroprene proceeds and hence, as in Example 2, it is considered that a block copolymer of polymethyl methacrylate and polychloroprene is formed. The total amount of the 1,2-bond and the isomerized 1,2-bond in the polymer calculated based on the measurement by means of carbon-13 nuclear magnetic resonance spectrometer as in Synthetic Example 8 was 0.6% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 34 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 12

Into a 500 ml brown flask fitted with a nitrogen gas-inlet tube and a reflux condenser were charged 1.60 g of polymethyl methacrylate obtained in Synthetic Example 5 as a polymer (A) and 15.34 g of benzene and then dissolution of the polymethyl methacrylate was confirmed. Thereafter, 70.00 g of chloroprene subjected to simple distillation, 5.99 g of methacrylic acid, and 0.20 g of a 1.49% by weight of 2,2′-azobis(2,4-dimethylvaleronitrile) were charged thereinto, followed by thorough degassing by repeating operations of freeze-pump-thaw cycle three times. Thereafter, polymerization was carried out in the same manner as in Example 11 on an oil bath of 30° C. under a nitrogen atmosphere, thereby a polymer being obtained. The conversion rate of the polymerization of chloroprene after 139 hours was 8.6%, the number-average molecular weight Mn was 278,000, the weight-average molecular weight Mw was 480,900, and the molecular weight distribution Mw/Mn was 1.73. In GPC measurement, the GPC peak of the polymer (A) shifted to a high-molecular-weight side as the polymerization of chloroprene proceeds and hence, as in Example 5, it is considered that a block copolymer of polymethyl methacrylate and a polychloroprene-methacrylic acid copolymer is formed. The total amount of the 1,2-bond and the isomerized 1,2-bond in the polymer calculated based on the measurement by means of carbon-13 nuclear magnetic resonance spectrometer as in Synthetic Example 8 was 0.5% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 32 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 13

Into a 100 ml brown flask fitted with a nitrogen gas-inlet tube and a reflux condenser were charged 5.00 g of polymethyl methacrylate obtained in Synthetic Example 5 as a polymer (A) and 20.00 g of benzene and then dissolution of the polymethyl methacrylate was confirmed. Thereafter, 7.00 g of chloroprene subjected to simple distillation, 3.00 g of 2,3-dichlorobutadiene, and 0.20 g of a 0.18% by weight of 2,2′-azobis(2,4-dimethylvaleronitrile) were charged thereinto. Subsequently, polymerization was carried out in the same manner as in Example 5, thereby a polymer being obtained. The conversion rate of the polymerization after 200 hours was 48.3%, the number-average molecular weight Mn was 75,200, the weight-average molecular weight Mw was 120,400, and the molecular weight distribution Mw/Mn was 1.60. Since the peak of the polymer (A) shifted to a high-molecular-weight side in GPC measurement by the polymerization of chloroprene, it is considered that a block copolymer is formed. The total amount of the 1,2-bond and the isomerized 1,2-bond in the polymer calculated based on the measurement by means of carbon-13 nuclear magnetic resonance spectrometer as in Synthetic Example 8 was 0.6% by mol.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 29 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 14

Into a 100 ml brown flask fitted with a nitrogen gas-inlet tube and a reflux condenser were charged 2.94 g of polychloroprene obtained in Synthetic Example 8 as a polymer (B) and 18.74 g of benzene and then dissolution of the polychloroprene was confirmed. Thereafter, 20.00 g of styrene and 2.02 g of a 0.16% by weight of 2,2′-azobis(2-methylpropionitrile) were charged thereinto, followed by thorough degassing by repeating operations of freeze-pump-thaw cycle three times. Thereafter, the whole was heated on an oil bath of 60° C. under a nitrogen atmosphere. Then, in the same manner as in Example 5, after 24 hours, 90 hours, and 188 hours, the reaction liquid was sucked and a polymer was obtained, followed by measurement of the conversion rate of styrene and GPC of the formed polymer. A relation between the conversion rate of the polymerization of styrene and the molecular weight distribution measured by GPC is shown in FIG. 7. It is obvious that the GPC curve of polychloroprene as the polymer (B) shifts to a high-molecular-weight side as the polymerization of styrene proceeds. The conversion rate of the polymerization of styrene after 188 hours was 19.1%, the number-average molecular weight Mn was 41,200, the weight-average molecular weight Mw was 55,200, and the molecular weight distribution Mw/Mn was 1.34. From the above results, it is presumed that the polymer is a block copolymer wherein the chloroprene-based polymer (B) consisting of polychloroprene is linked to terminal(s) of polystyrene as a polymer (A).

The block copolymer was dissolved in toluene to prepare a 5% by weight primer solution. As a result of the adhesion test of the ABS resin using the solution as a primer, a peeling strength of 29 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 15

Into a 200 ml brown flask fitted with a nitrogen gas-inlet tube and a reflux condenser were charged 4.59 g of the polychloroprene obtained in Synthetic Example 8 as a polymer (B) and 40 g of benzene and then dissolution of the polychloroprene was confirmed. Thereafter, 8.46 g of 2,3-dichloro-1,3-butadiene and 3.00 g of a 0.15% by weight of 2,2′-azobis(2-methylpropionitrile) were charged thereinto, followed by thorough degassing by repeating operations of freeze-pump-thaw cycle three times. After 52 hours, the content was poured into a large amount of methanol (containing di-t-butylhydroxytolune as a stabilizer) to precipitate a polymer. The conversion rate of 2,3-dichloro-1,3-butadiene determined from the weight of dry polymer was 37%. When the polymer was dissolved in tetrahydrofuran at room temperature, 57% thereof was soluble but 43% thereof was insoluble. As a result of GPC measurement of the soluble part, the number-average molecular weight Mn was 46,600, the weight-average molecular weight Mw was 55,900, the molecular weight distribution Mw/Mn was 1.20, and the peak of the original polychloroprene completely disappeared. From the above results, it is presumed that the polymer is a block copolymer wherein the chloroprene-based polymer (B) consisting of polychloroprene is linked to terminal(s) of poly2,3-dichloro-1,3-butadiene as a polymer (A).

The block copolymer was dissolved in toluene at 60° C. to prepare a 5% by weight primer solution. As a result of the adhesion test of the ABS resin using the solution as a primer, a peeling strength of 27 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Example 16

### Polymerization at First Stage

Into a 300 ml Pyrex (registered trademark) glass flask fitted with a nitrogen gas-inlet tube were charged 0.15 g of a carbamate ester represented by the following formula (14), 0.06 g of the carbamate disulfide represented by the following general formula (8), and 100.0 g of chloroprene subjected to simple distillation, followed by thorough degassing by repeating operations of freeze-pump-thaw cycle three times. Thereafter, polymerization was carried out under stirring under a nitrogen atmosphere for 5 hours under irradiation with ultraviolet rays (UM452 (450W) manufactured by Ushio Inc.) at a distance of 80 mm in a constant-temperature bath of 30° C. The conversion rate of the polymerization of chloroprene at this moment was 10%. The unreacted chloroprene was removed by distillation under vacuum without opening the flask to obtain a chloroprene polymer (B). The number-average molecular weight Mn was 51,200, the weight-average molecular weight Mw was 98,900, and the molecular weight distribution Mw/Mn was 1.93, which were measured by GPC. The total amount of the 1,2-bond and the isomerized 1,2-bond in the polymer calculated based on the measurement by means of carbon-13 nuclear magnetic resonance spectrometer as in Synthetic Example 8 was 1.0% by mol.

### (Polymerization at Second Stage)

Subsequently, 100.0 g of styrene was added to the above flask and the polychloroprene (B) was completely dissolved with stirring under a nitrogen atmosphere and then, in the same manner as in the first stage, after thorough degassing, the whole was irradiated with ultraviolet rays under stirring at 30° C. for 6 hours. The conversion rate of styrene at this moment was 2%. The content was poured into a large amount of methanol to obtain a block copolymer. The number-average molecular weight Mn was 72,100, the weight-average molecular weight Mw was 154,100, and the molecular weight distribution Mw/Mn was 2.10, which were measured by GPC. Furthermore, it shows an island-sea microphase-separated structure as shown in FIG. 8, so that it is presumed that the polymer is a triblock copolymer wherein the styrene polymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer is a chloroprene polymer having resin blocks at the both terminals, it exhibits tensile properties of a stress at break of 5 MPa and an elongation at break of 750% which are not exhibited by unvulcanized chloroprene-based rubbers having a similar degree of molecular weight and crystallinity, so that it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

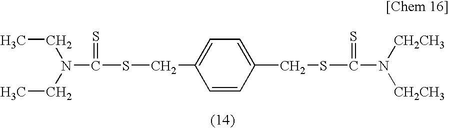

### Example 17

Polymerization at the second stage was initiated in the same manner as in Example 16 except that 95.0 g of styrene and 2.0 g of maleic anhydride were used instead of 100.0 g of styrene in the polymerization at the second stage of Example 16. The conversion rates of the polymerization of styrene and maleic anhydride after the irradiation with ultraviolet rays at 30° C. for 6 hours were 2.2% and 98%, respectively. The content was poured into a large amount of methanol to precipitate a polymer, thereby a block copolymer being obtained. The number-average molecular weight Mn was 84,500, the weight-average molecular weight Mw was 164,000, and the molecular weight distribution Mw/Mn was 1.94, which were measured by GPC. Furthermore, since the peak of the original chloroprene polymer disappeared and was converted into high-molecular-weight one, it is presumed that the polymer is a triblock copolymer wherein a styrene/maleic anhydride copolymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer is a chloroprene polymer having resin blocks at the both terminals, it exhibits tensile properties of a stress at break of 4 MPa and an elongation at break of 800% which are not exhibited by unvulcanized chloroprene-based rubbers having a similar degree of molecular weight and crystallinity, so that it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 18

Polymerization at the second stage was initiated in the same manner as in Example 16 except that 95.0 g of styrene and 2.0 g of N-phenylmaleimide were used instead of 100.0 g of styrene in the polymerization at the second stage of Example 16. The conversion rates of the polymerization of styrene and N-phenylmaleimide after the irradiation with ultraviolet rays at 30° C. for 6 hours were 2.2% and 97%, respectively. The content was poured into a large amount of methanol to precipitate a polymer, thereby a block copolymer being obtained. The number-average molecular weight Mn was 86,300, the weight-average molecular weight Mw was 171,000, and the molecular weight distribution Mw/Mn was 1.98, which were measured by GPC. Furthermore, since the peak of the original chloroprene polymer disappeared and was converted into high-molecular-weight one, it is presumed that the polymer is a triblock copolymer wherein a styrene/maleic anhydride copolymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer is a chloroprene polymer having resin blocks at the both terminals, it exhibits tensile properties of a stress at break of 5 MPa and an elongation at break of 700% which are not exhibited by unvulcanized chloroprene-based rubbers having a similar degree of molecular weight and crystallinity, so that it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 19

Polymerization at the second stage was initiated in the same manner as in Example 16 except that 45.0 g of styrene, 5.0 g of maleic acid, and 50.0 g of methyl ethyl ketone were used instead of 100.0 g of styrene in the polymerization at the second stage of Example 16. The conversion rates of the polymerization of styrene and maleic acid after the irradiation with ultraviolet rays at 30° C. for 12 hours were 4.5% and 81%, respectively. The content was poured into a large amount of methanol to precipitate a polymer, thereby a block copolymer being obtained. The number-average molecular weight Mn was 89,200, the weight-average molecular weight Mw was 183,700, and the molecular weight distribution Mw/Mn was 2.10, which were measured by GPC. Furthermore, since the peak of the original chloroprene polymer disappeared and was converted into high-molecular-weight one, it is presumed that the polymer is a triblock copolymer wherein a styrene/maleic acid copolymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer is a chloroprene polymer having resin blocks at the both terminals, it exhibits tensile properties of a stress at break of 5 MPa and an elongation at break of 750% which are not exhibited by unvulcanized chloroprene-based rubbers having a similar degree of molecular weight and crystallinity, so that it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 20

Into a 300 ml brown flask fitted with a nitrogen gas-inlet tube and a reflux condenser were charged 2.00 g of a 5.12% by weight benzene solution of a dithiocarboxylate ester represented by the following formula (15), 2.0 g of a 0.15% by weight benzene solution of 2,2′-azobis(2-methylpropionitrile), and 75.25 g of chloroprene subjected to simple distillation, followed by thorough degassing by repeating operations of freeze-pump-thaw cycle three times. Thereafter, the whole was heated on an oil bath of 60° C. under stirring with a magnetic stirrer under a nitrogen atmosphere. After 32 hours, the unreacted chloroprene was removed by distillation under vacuum without opening the flask to obtain a chloroprene polymer (B). The conversion rate of the polymerization of chloroprene calculated from the solid content in the polymerization solution was 23.2%. The number-average molecular weight Mn was 81,500, the weight-average molecular weight Mw was 154,900, and the molecular weight distribution Mw/Mn was 1.90, which were measured by GPC (shoulders were present at both side of the GPC main peak). The total amount of the 1,2-bond and the isomerized 1,2-bond in the polymer calculated based on the measurement by means of carbon-13 nuclear magnetic resonance spectrometer as in Synthetic Example 8 was 1.4% by mol. Subsequently, 134 g of styrene was added to the above flask and the polychloroprene (B) was completely dissolved with stirring under a nitrogen atmosphere. Then, 2.20 g of a 0.15 wt % benzene solution of 2,2′-azobis(2,4-dimethylvaleronitrile) was added thereto and, in the same manner as above, after thorough degassing, the whole was heated under stirring on an oil bath of 50° C. After 80 hours, the content was poured into a large amount of methanol to precipitate a polymer, thereby a block copolymer being obtained. The conversion rate of styrene calculated from the dry weight of the polymer was 4.1%. The number-average molecular weight Mn was 93,600, the weight-average molecular weight Mw was 191,900, and the molecular weight distribution Mw/Mn was 2.05, which were measured by GPC (shoulders were present at both side of the GPC main peak). Furthermore, it shows an island-sea microphase-separated structure as shown in FIG. 9, so that it is presumed that the polymer is a triblock copolymer wherein the styrene polymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer is a chloroprene polymer having resin blocks at the both terminals, it exhibits tensile properties of a stress at break of 6 MPa and an elongation at break of 700% which are not exhibited by unvulcanized chloroprene-based rubbers having a similar degree of molecular weight and crystallinity, so that it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

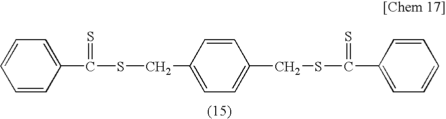

### Example 21

Into a 300 ml brown flask fitted with a nitrogen gas-inlet tube and a reflux condenser were charged 5.30 g of the styrene-based polymer (A) obtained in Synthetic Example 6, 86.50 g of chloroprene subjected to simple distillation, 0.79 g of a 0.35 wt % benzene solution of azobis(2,4-dimethylvaleronitrile), and 22.25 g of benzene, followed by thorough degassing by repeating operations of freeze-pump-thaw cycle three times. Thereafter, the whole was heated on an oil bath of 60° C. under stirring with a magnetic stirrer under a nitrogen atmosphere. After 32 hours, the unreacted chloroprene was removed by distillation under vacuum without opening the flask to obtain a diblock copolymer consisting of the polymer (A)/chloroprene polymer (B). The total amount of the 1,2-bond and the isomerized 1,2-bond in the polymer calculated based on the measurement by means of carbon-13 nuclear magnetic resonance spectrometer as in Synthetic Example 8 was 1.4% by mol. The conversion rate of the polymerization of chloroprene calculated from the solid content in the polymerization solution was 16.0%. After 100.52 g of styrene was added thereto and the copolymer was completely dissolved, 0.65 g of a 0.35 wt % benzene solution of azobis(2,4-dimethylvaleronitrile) was added thereto and, after thorough degassing, the whole was heated on an oil bath of 50° C. After 24 hours, the content was poured into a large amount of methanol to precipitate a polymer, which was collected. The conversion rate of the polymerization of styrene calculated from the weight of the polymer after drying was about 2.9%. The number-average molecular weight was 89,200, the weight-average molecular weight was 124,500, and Mw/Mn was 1.40, which were measured by GPC. It shows a layered microphase-separated structure as shown in FIG. 10, so that it is presumed that the copolymer is a triblock copolymer wherein the styrene polymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 29 N/25 mm was exhibited. Moreover, since the copolymer exhibits tensile properties of a stress at break of 21 MPa and an elongation at break of 600% which are not exhibited by unvulcanized chloroprene-based rubbers having a similar degree of molecular weight and crystallinity, so that it is considered to be useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 22

Into a 300 ml brown flask fitted with a nitrogen gas-inlet tube and a reflux condenser were charged 2.00 g of a 6.00% by weight benzene solution of a dithiocarboxylate ester represented by the following formula (16), 2.0 g of a 0.15% by weight benzene solution of 2,2′-azobis(2-methylpropionitrile), and 76.02 g of chloroprene subjected to simple distillation, followed by thorough degassing by repeating operations of freeze-pump-thaw cycle three times. Thereafter, the whole was heated on an oil bath of 60° C. under stirring with a magnetic stirrer under a nitrogen atmosphere. After 34 hours, the unreacted chloroprene was removed by distillation under vacuum without opening the flask to obtain a chloroprene polymer (B). The conversion rate of the polymerization of chloroprene calculated from the solid content in the polymerization solution was 24.5%. The number-average molecular weight Mn was 65,000, the weight-average molecular weight Mw was 122,000, and the molecular weight distribution Mw/Mn was 1.88, which were measured by GPC (shoulders were present at both side of the GPC main peak). The total amount of the 1,2-bond and the isomerized 1,2-bond in the polymer calculated based on the measurement by means of carbon-13 nuclear magnetic resonance spectrometer as in Synthetic Example 8 was 1.5% by mol. Subsequently, after 120.01 g of styrene and 20.00 g of maleic anhydride were added to the above flask and the polychloroprene (B) was completely dissolved with stirring under a nitrogen atmosphere, 3.00 g of a 0.15 wt % benzene solution of 2,2′-azobis(2,4-dimethylvaleronitrile) was added thereto and, in the same manner as above, after thorough degassing, the whole was heated on an oil bath of 50° C. under stirring. After 80 hours, the content was poured into a large amount of methanol to precipitate a polymer, thereby a block copolymer being obtained. The conversion rate of the total of styrene and maleic anhydride calculated from the dry weight of the polymer was 5.1% and an infrared absorption peak characteristic to carbonyl was shown at around 1700 to 1870 cm⁻¹. The number-average molecular weight Mn was 87,300, the weight-average molecular weight Mw was 173,700, and the molecular weight distribution Mw/Mn was 1.99, which were measured by GPC (shoulders were present at both side of the GPC main peak). The block copolymer was dissolved in toluene to prepare a 5% by weight primer solution. As a result of the adhesion test of the ABS resin using the solution as a primer, a peeling strength of 30 N/25 mm was exhibited. Moreover, since the copolymer exhibits tensile properties of a stress at break of 7 MPa and an elongation at break of 750% which are not exhibited by unvulcanized chloroprene-based rubbers having a similar degree of molecular weight and crystallinity, so that it is considered to be useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

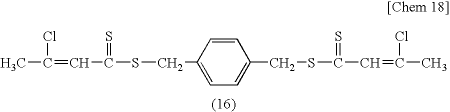

### Example 23

Polymerization was carried out in the same manner as in Example 22 except that 60.0 g of styrene, 10.0 g of maleic acid, and 60.0 g of dioxane were used instead of 120.01 g of styrene and 20.00 g of maleic anhydride. After 150 hours, the content was poured into a large amount of methanol to precipitate a polymer, thereby a block copolymer being obtained. The conversion rates of the polymerization of styrene and maleic acid were 11% and 54%, respectively and an infrared absorption peak characteristic to carbonyl was shown at around 1700 to 1870 cm⁻¹. The number-average molecular weight Mn was 93,100, the weight-average molecular weight Mw was 186,200, and the molecular weight distribution Mw/Mn was 2.00, which were measured by GPC (shoulders were present at both side of the GPC main peak). The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer exhibits tensile properties of a stress at break of 6.5 MPa and an elongation at break of 730% which are not exhibited by unvulcanized chloroprene-based rubbers having a similar degree of molecular weight and crystallinity, so that it is considered to be useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 24

Into a 300 ml brown flask fitted with a nitrogen gas-inlet tube and a reflux condenser were charged 3.00 g of a 6.00% by weight benzene solution of a disulfide compound represented by the following formula (17), 3.50 g of a 1.11% by weight benzene solution of 2,2′-azobis(2,4-dimethylvaleronitrile), and 100.01 g of chloroprene subjected to simple distillation, followed by thorough degassing by repeating operations of freeze-pump-thaw cycle three times. Thereafter, the whole was heated on an oil bath of 60° C. under stirring with a magnetic stirrer under a nitrogen atmosphere. After 24 hours, the unreacted chloroprene was removed by distillation under vacuum. The conversion rate of the polymerization solution calculated from the solid content in the polymerization solution was 10.2%. The number-average molecular weight Mn was 24,000, the weight-average molecular weight Mw was 45,600, and the molecular weight distribution Mw/Mn was 1.90, which were measured by GPC. The total amount of the 1,2-bond and the isomerized 1,2-bond in the polymer calculated based on the measurement by means of carbon-13 nuclear magnetic resonance spectrometer as in Synthetic Example 8 was 1.4% by mol. After 120.00 g of styrene was added thereto and the copolymer was completely dissolved, 0.65 g of a 0.35 wt % benzene solution of azobis(2,4-dimethylvaleronitrile) was added thereto and, after thorough degassing, the whole was heated on an oil bath of 50° C. After 24 hours, the content was poured into a large amount of methanol to precipitate a polymer, which was collect. The conversion rate of the polymerization of styrene calculated from the weight of the polymer after drying was about 1.9%. The number-average molecular weight was 32,000, the weight-average molecular weight was 65,600, and Mw/Mn was 2.05, which were measured by GPC.

The block copolymer was dissolved in toluene to prepare a 5% by weight primer solution. As a result of the adhesion test of the ABS resin using the solution as a primer, a peeling strength of 29 N/25 mm was exhibited.

As a result of evaluation of color fastness of the block copolymer, the film showed light yellow in any cases after heating in a gear oven or irradiation with the ultraviolet ray, and thus the color fastness was judged as ◯.

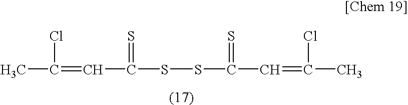

### Example 25

Into a 300 ml brown flask fitted with a nitrogen gas-inlet tube and a reflux condenser were charged 2.10 g of a 5.12% by weight benzene solution of a dithiocarboxylate ester represented by the formula (15), 2.1 g of a 0.15% by weight benzene solution of 2,2′-azobis(2-methylpropionitrile), and 76.15 g of chloroprene subjected to simple distillation, followed by thorough degassing by repeating operations of freeze-pump-thaw cycle three times. Thereafter, the whole was heated on an oil bath of 60° C. under stirring with a magnetic stirrer under a nitrogen atmosphere. After 32 hours, the unreacted chloroprene was removed by distillation under vacuum without opening the flask to obtain a chloroprene polymer (B). The conversion rate of the polymerization of chloroprene calculated from the solid content in the polymerization solution was 23.8%. The number-average molecular weight Mn was 82,200, the weight-average molecular weight Mw was 157,000, and the molecular weight distribution Mw/Mn was 1.91, which were measured by GPC (shoulders were present at both side of the GPC main peak). The total amount of the 1,2-bond and the isomerized 1,2-bond in the polymer calculated based on the measurement by means of carbon-13 nuclear magnetic resonance spectrometer as in Synthetic Example 8 was 1.4% by mol.

Subsequently, 150 g of styrene was added to the above flask and the polychloroprene (B) was completely dissolved with stirring under a nitrogen atmosphere. Then, 20 g of N-phenylmaleimide and 2.00 g of a 0.15 wt % benzene solution of 2,2′-azobis(2,4-dimethylvaleronitrile) were added thereto and, in the same manner as above, after thorough degassing, the whole was heated under stirring on an oil bath of 50° C. After 80 hours, the content was poured into a large amount of methanol to precipitate a polymer, thereby a block copolymer being obtained. The conversion rate of the total of styrene and N-phenylmaleimide calculated from the dry weight of the polymer was 3.9%. The polymer showed infrared absorption characteristic to imide at 1700 to 1850 cm⁻¹. The number-average molecular weight Mn was 95,300, the weight-average molecular weight Mw was 192,500, and the molecular weight distribution Mw/Mn was 2.02, which were measured by GPC (shoulders were present at both side of the GPC main peak). Furthermore, it shows an island-sea microphase-separated structure as shown in Example 16, so that it is presumed that the polymer is a triblock copolymer wherein the styrene/N-phenylmaleimide copolymer (A) is linked to the both terminals of the chloroprene-based polymer (B).

The block copolymer was dissolved in toluene to prepare a 5% by weight primer solution. As a result of the adhesion test of the ABS resin using the solution as a primer, a peeling strength of 31 N/25 mm was exhibited. Moreover, since the copolymer exhibits tensile properties of a stress at break of 7 MPa and an elongation at break of 650% which are not exhibited by unvulcanized chloroprene-based rubbers having a similar degree of molecular weight and crystallinity, it is useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Example 26

Into a 300 ml brown flask fitted with a nitrogen gas-inlet tube and a reflux condenser were charged 2.00 g of a 6.00% by weight benzene solution of a dithiocarboxylate ester represented by the formula (16), 3.00 g of a 6.00% by weight benzene solution of a disulfide represented by the formula (17), 2.0 g of a 0.15% by weight benzene solution of 2,2′-azobis(2-methylpropionitrile), and 80.00 g of chloroprene subjected to simple distillation, followed by thorough degassing by repeating operations of freeze-pump-thaw cycle three times. Thereafter, the whole was heated on an oil bath of 60° C. under stirring with a magnetic stirrer under a nitrogen atmosphere. After 34 hours, the unreacted chloroprene was removed by distillation under vacuum without opening the flask to obtain a chloroprene polymer (B). The conversion rate of the polymerization of chloroprene calculated from the solid content in the polymerization solution was 21.5%. The number-average molecular weight Mn was 53,000, the weight-average molecular weight Mw was 84,300, and the molecular weight distribution Mw/Mn was 1.59, which were measured by GPC (shoulders were present at both side of the GPC main peak). The total amount of the 1,2-bond and the isomerized 1,2-bond in the polymer calculated based on the measurement by means of carbon-13 nuclear magnetic resonance spectrometer as in Synthetic Example 8 was 1.5% by mol. Subsequently, 140.0 g of styrene was added to the above flask and the polychloroprene (B) was completely dissolved with stirring under a nitrogen atmosphere. Then, 3.00 g of a 0.15 wt % benzene solution of 2,2′-azobis(2,4-dimethylvaleronitrile) was added thereto and, in the same manner as above, after thorough degassing, the whole was heated under stirring on an oil bath of 50° C. After 80 hours, the content was poured into a large amount of methanol to precipitate a polymer, thereby a block copolymer being obtained. The conversion rate of the polymerization of styrene calculated from the dry weight of the polymer was 4.3%. The number-average molecular weight Mn was 73,000, the weight-average molecular weight Mw was 129,900, and the molecular weight distribution Mw/Mn was 1.78, which were measured by GPC (shoulders were present at both side of the GPC main peak). The block copolymer was dissolved in toluene to prepare a 5% by weight primer solution. As a result of the adhesion test of the ABS resin using the solution as a primer, a peeling strength of 29 N/25 mm was exhibited. Moreover, since the copolymer exhibits tensile properties of a stress at break of 6.0 MPa and an elongation at break of 750% which are not exhibited by unvulcanized chloroprene-based rubbers having a similar degree of molecular weight and crystallinity, so that it is considered to be useful as a thermoplastic elastomer and a hot-melt adhesive.

As a result of evaluation of color fastness of the block copolymer, the film showed light yellow in any cases after heating in a gear oven or irradiation with the ultraviolet ray, and thus the color fastness was judged as ◯.

### Comparative Example 1

Into a 100 ml brown flask fitted with a nitrogen gas-inlet tube and a reflux condenser were charged 4.93 g of the polymethyl methacrylate obtained in Synthetic Example 13 as a polymer (A) and 25.81 g of benzene and then dissolution of the polymer was confirmed. Thereafter, 9.21 g of chloroprene subjected to simple distillation and 1.67 g of a 0.177% by weight of 2,2′-azobis(2,4-dimethylvaleronitrile) were charged thereinto, followed by thorough degassing by repeating operations of freeze-pump-thaw cycle three times. Thereafter, the whole was heated on an oil bath of 40° C. under a nitrogen atmosphere. After 192 hours, the content was poured into a large amount of methanol to precipitate a polymer. The conversion rate of the polymerization of chloroprene calculated from the dry weight of the polymer was 31.7%. The number-average molecular weight Mn was 73,400, the weight-average molecular weight Mw was 415,800, and the molecular weight distribution Mw/Mn was 5.77, which were measured by GPC. Even when chloroprene was polymerized using the polymer (A) synthesized without using the dithiocarboxylate ester, block copolymerization did not proceed, so that it is considered that a homopolymer of chloroprene was formed.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 14 N/25 mm was exhibited.

### Comparative Example 2

Into a 200 ml brown flask fitted with a nitrogen gas-inlet tube and a reflux condenser were charged 3.20 g of polychloroprene obtained in Synthetic Example 14 as a chloroprene-based polymer (B) and 10.00 g of benzene and then dissolution of the polychloroprene was confirmed. Thereafter, 41.33 g of styrene and 1.60 g of a 0.16% by weight benzene solution of 2,2′-azobis(4-methylpropionitrile) were charged thereinto, followed by thorough degassing by repeating operations of freeze-pump-thaw cycle three times. Thereafter, the whole was heated on an oil bath of 60° C. under a nitrogen atmosphere. Then, in the same manner as in Example 5, after 20 hours, 48 hours, and 90 hours, the reaction liquid was sucked and a polymer was obtained, followed by measurement of the conversion rate of styrene and GPC of the formed polymer. A relation between the conversion rate of the polymerization of styrene and the molecular weight distribution measured by GPC is shown in FIG. 11. It is obvious that the GPC curve of polystyrene as the polymer (B) hardly shifts although the polymerization of chloroprene proceeds and a large amount of high-molecular-weight components are formed. The conversion rate of the polymerization of styrene after 90 hours was 10.3%, and the number-average molecular weight Mn was 47,700, the weight-average molecular weight Mw was 144,800, and the molecular weight distribution Mw/Mn was 3.04, which were measured by GPC.

From the above results, it is presumed that styrene almost singly radically polymerized without occurring chain transfer to a polychloroprene terminal.

The block copolymer was dissolved in toluene to prepare a 5% by weight primer solution. As a result of the adhesion test of the ABS resin using the solution as a primer, a peeling strength of 15 N/25 mm was exhibited.

As a result of evaluation of color fastness of the block copolymer, the film showed light yellow in any cases after heating in a gear oven or irradiation with the ultraviolet ray, and thus the color fastness was judged as ◯.

### Comparative Example 3

Polymerization of styrene was carried out in the same manner as in Example 14 except that polychloroprene obtained in Synthetic Example 12 was used as a polymer (A). The conversion rate of the polymerization of styrene after 188 hours was 18.5%. The number-average molecular weight Mn was 54,400, the weight-average molecular weight Mw was 96,800, and the molecular weight distribution Mw/Mn was 1.78, which were measured by GPC. The peak of the original chloroprene polymer almost disappeared by the polymerization of styrene.

From the above results, it is presumed that the polymer is a block copolymer wherein the styrene polymer (B) is linked to the terminal of the polymer (A) consisting of polychloroprene.

The block copolymer was dissolved in a mixed solvent of acetone/methyl ethyl ketone/toluene=20/50/30% by weight to prepare a 5% by weight primer solution. As a result of the adhesion test of the soft polyvinyl chloride resin using the solution as a primer, a peeling strength of 30 N/25 mm was exhibited.

However, as in Example 14, as a result of evaluation of color fastness of the block copolymer, the film showed yellow brown in any cases after heating in a gear oven or irradiation with ultraviolet ray, and thus the color fastness was judged as Δ. Namely, since the polymerization temperature of the chloroprene-based polymer (B) is high and the amount of 1,2- and 1,2-bond is large, it is considered that deterioration such as dehydrochlorination tends to occur and thus the color fastness is poor.

### Comparative Example 4

Into a 300 ml Pyrex (registered trademark) glass flask fitted with a nitrogen inlet tube were charged 5.0 g of polychloroprene obtained in Synthetic Example 15 as a chloroprene-based polymer (B) and 50.0 g of styrene, followed by thorough degassing by repeating operations of freeze-pump-thaw cycle three times. Thereafter, polymerization was carried out under stirring under a nitrogen atmosphere for 10 hours under irradiation with ultraviolet rays (UM452 (450W) manufactured by Ushio Inc.) at a distance of 80 mm in a constant-temperature bath of 30° C. The conversion rate of the polymerization of styrene at this moment was 7%. The content was poured into a large amount of methanol to precipitate a polymer, thereby a block copolymer being obtained. The number-average molecular weight Mn was 126,000, the weight-average molecular weight Mw was 315,000, which were measured by GPC. Since the molecular weight of polychloroprene shifts to a high-molecular-weight side, it is presumed that the polymer is a diblock copolymer wherein the styrene polymer (A) is linked to the chloroprene-based polymer (B).

The block copolymer was dissolved in toluene to prepare a 5% by weight primer solution. As a result of the adhesion test of the ABS resin using the solution as a primer, a peeling strength of 29 N/25 mm was exhibited.

However, as a result of evaluation of color fastness of the block copolymer, the film showed yellow brown in any cases after heating in a gear oven or irradiation with ultraviolet ray, and thus the color fastness was judged as X. Namely, since the polymerization temperature of the chloroprene-based polymer (B) is high and the amount of 1,2- and 1,2-bond is large, it is considered that deterioration such as dehydrochlorination tends to occur and thus the color fastness is poor.

### Comparative Example 5

Into a 200 ml brown flask fitted with a nitrogen gas-inlet tube and a reflux condenser were charged 3.12 g of polychloroprene obtained in Synthetic Example 8 as a chloroprene-based polymer (B) and 23.27 g of benzene and then dissolution of the polychloroprene was confirmed. Thereafter, 8.14 g of methyl methacrylate and 1.60 g of a 0.16% by weight benzene solution of 2,2′-azobis(2-methylpropionitrile) were charged thereinto, followed by thorough degassing by repeating operations of freeze-pump-thaw cycle three times. Thereafter, the whole was heated on an oil bath of 60° C. under a nitrogen atmosphere. After 90 hours, the content was poured into a large amount of methanol (containing di-t-butylhydroxytoluene as a stabilizer) to precipitate a polymer. The conversion rate of the polymerization of methyl methacrylate determined from the weight of the dry polymer was 52.3%. The number-average molecular weight Mn was 47,700, the weight-average molecular weight Mw was 144,800, and Mw/Mn was 3.03, which were measured by GPC. The peak of the original polychloroprene remained unmoved. From the above results, it is presumed that methyl methacrylate singly polymerized without occurring chain transfer to the terminal of the polychloroprene which is the chloroprene-based polymer (B).

The following show Synthetic Examples 16 to 27, Examples 27 to 40, and Comparative Examples 6 to 9 with regard to soapless CR-based latexes produced using the chloroprene-based block copolymers of the invention. Incidentally, the values therein are those measured by the following methods.

### <Molecular Weight>

The number-average molecular weight Mn, Weight-average molecular weight Mw, and molecular weight distribution Mw/Mn of a polymer were measured by means of GPC 8220 manufactured by Tosoh Corporation under the following conditions (eluent=tetrahydrofuran, flow rate=1.5 ml/min, column temperature=40° C., peak detection=differential refractometer, packed column=TSK-gel (registered trademark, the same shall apply hereinafter) G7000Hxl/GMHxl/GMHxl/G3000Hxl/guard column H-L, molecular weight calculation=polystyrene conversion). The amounts of chlorine and sulfur in a polymer were measured by an oxygen flask combustion-ion chromatography, and the infrared absorption spectrum of the polymer was measured by means of Spectrum 2000 manufactured by Perkin-Elmer. The monomer conversion rate during polymerization was calculated using benzene as an internal standard by means of a gas chromatograph GC-17A manufactured by Shimadzu Corporation (a capillary column NEUTRABOND-5 manufactured by GL Science, a flame ionization detector).

### <Adhesion Property Evaluation of Latex>

The performance evaluation of a soapless CR latex as an adhesive was carried out by the following method. A CR latex adhesive composition was applied on two sheets of No. 9 cotton sail cloth with a brush and dried in an oven at 80° C. for 5 minutes (the above operations of application-drying were repeated three times). Then, after open time at room temperature (standing for a certain time), the sheets were adhered with pressure by means of a hand roller. After aging at room temperature for 1 day, it was cut into a width of 25 mm and a 180° T-type peeling test was conducted under a condition of a tensile rate of 50 mm/min by means of a tensilon-type tensile tester. The adhesiveness was evaluated from the change of the peeling strength and the peeling state depending on the open time. Namely, when the adhesiveness is sufficient, the decrease in peeling strength is small even when the open time is long but when the adhesiveness is insufficient, peeling at an adhesive interface (so-called paste separation) becomes remarkable and the decrease in peeling strength becomes large. The water resistance was evaluated by aging a test piece at room temperature for 1 day after adhesion with pressure at an open time of 3 hours, immersing it in pure water at room temperature for 3, and subsequently conducting the 180° T-type peeling test thereof.

### Synthetic Example 16

Into a 100 ml Pyrex (registered trademark) glass flask fitted with a nitrogen inlet tube and a reflux condenser were charged 1.50 g (7.0 mmol) of a xanthogenate ester represented by the following formula (18), 0.85 g (3.5 mmol) of a xanthogenate disulfide represented by the following formula (19), 5.00 g (58.14 mmol) of methacrylic acid, and 10.00 g of methyl ethyl ketone, followed by thorough degassing by repeating operations of freeze-pump-thaw cycle three times. Thereafter, polymerization was carried out under stirring under a nitrogen atmosphere for 10 hours under irradiation with ultraviolet rays (UM452 (450W) manufactured by Ushio Inc.) at a distance of 80 mm in a constant-temperature bath of 30° C. The conversion rate of the polymerization of methacrylic acid at this moment was 80%. Subsequently, 25.00 g (282 mmol) of chloroprene subjected to simple distillation and 60 ml of methyl ethyl ketone were added and the whole was irradiated with ultraviolet rays at 30° C. for 12 hours under a nitrogen atmosphere with sufficient stirring, followed by addition of 2,6-t-butylhydroxytoluene as a stabilizer. The conversion rate of chloroprene was 51% and the total conversion rate of methacrylic acid was 86%. The number-average molecular weight Mn was 2,600, the weight-average molecular weight Mw was 5,200, and the molecular weight distribution Mw/Mn was 2.0, which were measured by GPC. The chlorine content in the dry polymer was 27.3 wt % and the sulfur content was 2.5 wt %. In the infrared absorption spectrum shown in FIG. 12, peaks derived from the carboxylic acid in methacrylic acid and the unsaturated bond in CR were observed. Moreover, the formed polymer did not dissolve in toluene and chloroform which were good solvents of CR and dissolved in acetone which is a non-solvent thereof. Furthermore, an acetone solution of the formed polymer dissolved in an aqueous triethylamine solution. From the above results, it could be judged that a polymethacrylic acid-CR diblock copolymer (amphipathic CR block copolymer-A) was formed.

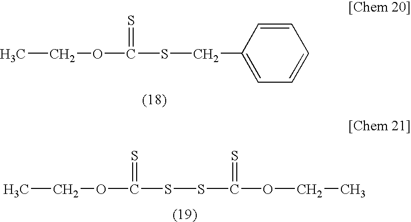

### Synthetic Example 17

Into a 100 ml Pyrex (registered trademark) glass flask were charged 1.50 g (7.6 mmol) of a xanthogenate ester represented by the following formula (20), 0.80 g (3.3 mmol) of a xanthogenate disulfide represented by the formula (19), 5.00 g (69.4 mmol) of acrylic acid, and 11.00 g of methyl ethyl ketone. In the same manner as in Synthetic Example 16, polymerization was carried out at 30° C. for 5 hours under irradiation with ultraviolet rays. The conversion rate of the polymerization of acrylic acid at this moment was 80%. Subsequently, 25.00 g (282 mmol) of chloroprene subjected to simple distillation and 60 ml of methyl ethyl ketone were added and the whole was irradiated with ultraviolet rays at 30° C. for 12 hours under a nitrogen atmosphere with sufficient stirring, followed by addition of 2,6-t-butylhydroxytoluene as a stabilizer. The conversion rate of chloroprene was 52% and the total conversion rate of acrylic acid was 88%. The number-average molecular weight Mn was 2,500, the weight-average molecular weight Mw was 5,500, and the molecular weight distribution Mw/Mn was 2.20, which were measured by GPC. The chlorine content in the dry polymer was 27.3 wt % and the sulfur content was 2.2 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it could be judged that a polyacrylic acid-CR diblock copolymer having a composition of an acrylic acid content of about 26 wt % (amphipathic CR block copolymer-B) was formed.

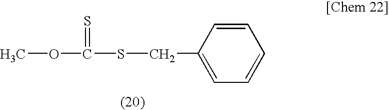

### Synthetic Example 18

Into a 100 ml Pyrex (registered trademark) glass flask were charged 1.50 g (6.3 mmol) of a carbamate ester represented by the following formula (21), 0.80 g (2.7 mmol) of a carbamate disulfide represented by the formula (8), 5.00 g (58.1 mmol) of methacrylic acid, and 11.00 g of methyl ethyl ketone. In the same manner as in Synthetic Example 16, polymerization was carried out at 30° C. for 10 hours under irradiation with ultraviolet rays. The conversion rate of the polymerization of methacrylic acid at this moment was 83%. Subsequently, 25.00 g (282 mmol) of chloroprene subjected to simple distillation and 60 ml of methyl ethyl ketone were added and polymerization was carried out in the same manner as in Synthetic Example 16. The conversion rate of chloroprene was 50% and the total conversion rate of methacrylic acid was 86%. The number-average molecular weight Mn was 2,800, the weight-average molecular weight Mw was 5,800, and the molecular weight distribution Mw/Mn was 2.10, which were measured by GPC. The chlorine content in the dry polymer was 27.3 wt % and the sulfur content was 2.2 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it could be judged that a polymethacrylic acid-CR diblock copolymer having a composition of a methacrylic acid content of about 26 wt % (amphipathic CR block copolymer-C) was formed.

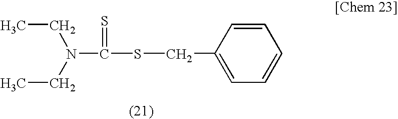

### Synthetic Example 19

Polymerization was carried out under irradiation with ultraviolet rays at 30° C. for 12 hours with the same charged composition as in Synthetic Example 17 except that 5.00 g (56.5 mmol) of chloroprene, 5.50 g (56.1 mmol) of maleic anhydride, and 20.00 g of benzene were charged instead of acrylic acid and methyl ethyl ketone in Synthetic Example 17. The conversion rate of the polymerization of chloroprene and maleic anhydride at this moment was 70%. Subsequently, 20.00 g (226 mmol) of chloroprene subjected to simple distillation and 20 ml of benzene were added thereto and polymerization was carried out under irradiation with ultraviolet rays at 30° C. for 12 hours. The conversion rate of chloroprene was 50% and the total conversion rate of methacrylic acid was 85%. The number-average molecular weight Mn was 2,200, the weight-average molecular weight Mw was 5,000, and the molecular weight distribution Mw/Mn was 2.27, which were measured by GPC. The chlorine content in the dry polymer was 29.9 wt % and the sulfur content was 2.9 wt %. Since an acetone solution of the polymer was dissolved in an aqueous triethylamine solution, it could be judged that a poly(chloroprene/maleic anhydride copolymer)-CR diblock copolymer having a composition of a maleic anhydride content of about 21 wt % (amphipathic CR block copolymer-D) was formed.

### Synthetic Example 20

Polymerization was carried out under irradiation with ultraviolet rays at 30° C. for 12 hours with the same charged composition as in Synthetic Example 17 except that 5.00 g (56.5 mmol) of chloroprene and 6.50 g (56.1 mmol) of maleic acid were charged instead of 5.00 g of acrylic acid in Synthetic Example 17. The conversion rates of the polymerization of chloroprene and maleic acid at this moment were 50% and 40%, respectively. Subsequently, 25.00 g (282 mmol) of chloroprene subjected to simple distillation and 40 ml of methyl ethyl ketone were added thereto and polymerization was carried out under irradiation with ultraviolet rays at 30° C. for 12 hours. The total conversion rate of chloroprene was 55% and the total conversion rate of maleic acid was 65%. The number-average molecular weight Mn was 2,800, the weight-average molecular weight Mw was 5,900, and the molecular weight distribution Mw/Mn was 2.11, which were measured by GPC. The chlorine content in the dry polymer was 28.2 wt % and the sulfur content was 2.5 wt %. Since an acetone solution of the polymer was dissolved in an aqueous triethylamine solution, it could be judged that a poly(chloroprene/maleic acid copolymer)-CR diblock copolymer having a composition of a maleic acid content of about 21 wt % (amphipathic CR block copolymer-E) was formed.

### Synthetic Example 21

Into a 200 ml brown flask fitted with a nitrogen gas-inlet tube and a reflux condenser were charged 1.14 g (58.19 mmol) of a dithiocarboxylate ester represented by the general formula (9), 5.01 g (58.19 mmol) of methacrylic acid, 0.026 g (0.16 mmol) of 2,2′-azobis(2-methylpropionitrile), and 11.35 g of dioxane into a 100 ml egg plant-shape flask, followed by thorough degassing by repeating operations of freeze-pump-thaw cycle three times. Thereafter, the whole was heated on an oil bath of 80° C. under stirring with a magnetic stirrer under a nitrogen atmosphere. After heating for 4 hours, the whole was cooled to room temperature. The conversion rate of the polymerization of methacrylic acid at this moment was 78%. Subsequently, 24.52 g (277 mmol) of chloroprene subjected to simple distillation, 60 ml of tetrahydrofuran, 0.17 g (0.71 mmol) of 2,2′-azobis(2-methylpropionitrile), and 0.14 g (15.46 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The conversion rate of chloroprene was 61% and the total conversion rate of methacrylic acid was 91%. The polymerization solution was poured into a large amount of pure water to precipitate a polymer. The number-average molecular weight Mn was 4,600, the weight-average molecular weight Mw was 6,200, and the molecular weight distribution Mw/Mn was 1.4, which were measured by GPC. The chlorine content in the dry polymer was 28.7 wt % and the sulfur content was 1.5 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it could be judged that a polymethacrylic acid-CR diblock copolymer having a composition of a methacrylic acid content of about 23.04 wt % (amphipathic CR block copolymer-F) was formed.

### Synthetic Example 22

Into a 200 ml brown flask fitted with a nitrogen gas-inlet tube and a reflux condenser were charged 2.50 g (11.78 mmol) of a dithiocarboxylate ester represented by the following formula (22), 5.00 g (69.39 mmol) of acrylic acid, 0.025 g (0.13 mmol) of 2,2′-azobis(2-methylpropionitrile), 5.3 g of dioxane, and 5.0 g of tetrahydrofuran, followed by thorough degassing by repeating operations of freeze-pump-thaw cycle three times. Thereafter, the whole was heated on an oil bath of 80° C. under stirring with a magnetic stirrer under a nitrogen atmosphere for 4 hours, followed by cooling to room temperature. The conversion rate of the polymerization of acrylic acid at this moment was 91%. Subsequently, 60.00 g (677.97 mmol) of chloroprene subjected to simple distillation, 90 ml of tetrahydrofuran, 0.2 g (0.81 mmol) of 2,2′-azobis(2,4-dimethylvaleronitrile) were added thereto, followed by thorough degassing by repeating operations of freeze-pump-thaw cycle three times. Thereafter, the whole was heated at 50° C. under stirring with a magnetic stirrer under a nitrogen atmosphere. After heating for 42 hours, 2,6-di-t-butylhydroxytoluene was added thereto to terminate the polymerization. The conversion rate of chloroprene was 68% and the total conversion rate of acrylic acid was 96%. The polymerization solution was poured into a large amount of pure water to precipitate a polymer. The number-average molecular weight Mn was 5,100, the weight-average molecular weight Mw was 7,900, and the molecular weight distribution Mw/Mn was 1.55, which were measured by GPC. The chlorine content in the dry polymer was 33.7 wt % and the sulfur content was 1.6 wt %. Since an acetone solution of the formed polymer dissolved in an aqueous triethylamine solution, it was judged that a polyacrylic acid-CR diblock copolymer (amphipathic CR block copolymer-G) was formed.

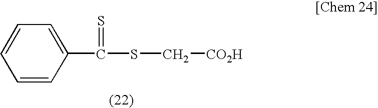

### Synthetic Example 23

Into a 200 ml brown flask fitted with a nitrogen gas-inlet tube and a reflux condenser were charged 1.00 g (4.56 mmol) of a dithiocarboxylate ester represented by the following formula (23), 4.80 g (55.76 mmol) of methacrylic acid, 0.020 g (0.12 mmol) of 2,2′-azobis(2-methylpropionitrile), and 11.00 g of dioxane into a 100 ml egg plant-shape flask, followed by thorough degassing by repeating operations of freeze-pump-thaw cycle three times. Thereafter, the whole was heated on an oil bath of 80° C. under stirring with a magnetic stirrer under a nitrogen atmosphere for 4 hours, followed by cooling to room temperature. The conversion rate of the polymerization of methacrylic acid at this moment was 74%. Subsequently, 20.00 g (226.0 mmol) of chloroprene subjected to simple distillation, 5.00 g (40.7 mmol) of 2,3-dichloro-1,3-butadiene, 60 ml of tetrahydrofuran, and 0.20 g (0.81 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The conversion rate of chloroprene was 65%, the conversion rate of 2,3-dichloro-1,3-butadiene was 87%, and the total conversion rate of acrylic acid was 92%. The polymerization solution was poured into a large amount of pure water to precipitate a polymer. The number-average molecular weight Mn was 5,300, the weight-average molecular weight Mw was 8,500, and the molecular weight distribution Mw/Mn was 1.6, which were measured by GPC. The chlorine content in the dry polymer was 35.3 wt % and the sulfur content was 1.3 wt %. Since a tetrahydrofuran solution of the formed polymer dissolved in an aqueous triethylamine solution, it could be judged that a polymethacrylic acid-CR diblock copolymer having a composition of a methacrylic acid content of about 20.4 wt % (amphipathic CR block copolymer-H) was formed.

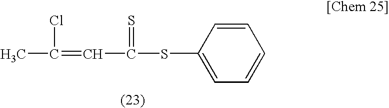

### Synthetic Example 24

Into a 200 ml brown flask fitted with a nitrogen gas-inlet tube and a reflux condenser were charged 1.50 g (5.00 mmol) of a dithiocarboxylate ester represented by the formula (23), 2.00 g (20.40 mmol) of maleic anhydride, 2.55 g (24.48 mmol) of styrene, 65.0 mg (0.23 mmol) of 4,4′-azobis(4-cyanopentanoic acid), and 10.00 g of dioxane into a 100 ml egg plant-shape flask, followed by thorough degassing by repeating operations of freeze-pump-thaw cycle three times. Thereafter, the whole was heated on an oil bath of 80° C. under stirring with a magnetic stirrer under a nitrogen atmosphere. After heating for 10 hours, the whole was cooled to room temperature. The conversion rate of the polymerization of maleic anhydride at this moment was 72%. Subsequently, 26.00 g (294 mmol) of chloroprene subjected to simple distillation, 60 ml of tetrahydrofuran, and 0.10 g (10.33 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The conversion rate of chloroprene was 58%. The polymerization solution was poured into a large amount of pure water to precipitate a polymer. The number-average molecular weight Mn was 4,600, the weight-average molecular weight Mw was 6,200, and the molecular weight distribution Mw/Mn was 1.4, which were measured by GPC. The chlorine content in the dry polymer was 32.8 wt % and the sulfur content was 1.7 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it could be judged that a polymaleic anhydride/styrene alternating copolymer-CR diblock copolymer (amphipathic CR block copolymer-I) was formed.

### Synthetic Example 25

Into a 200 ml brown flask fitted with a nitrogen gas-inlet tube and a reflux condenser were charged 3.19 g (13.40 mmol) of a dithiocarboxylate ester represented by the formula (23), 5.00 g (48.00 mmol) of chloroprene, 4.65 g (47.40 mmol) of maleic anhydride, 0.14 g (0.50 mmol) of 4,4′-azobis(4-cyanopentanoic acid), and 22.00 g of dioxane into a 100 ml egg plant-shape flask, followed by thorough degassing by repeating operations of freeze-pump-thaw cycle three times. Thereafter, the whole was heated on an oil bath of 60° C. under stirring with a magnetic stirrer under a nitrogen atmosphere. After heating for 10 hours, the whole was cooled to room temperature. The conversion rates of the polymerization of chloroprene and maleic anhydride at this moment were 74% and 79%, respectively. Subsequently, 25.00 g (282.5 mmol) of chloroprene subjected to simple distillation, 60 ml of tetrahydrofuran, 0.2 g (0.81 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The conversion rate of chloroprene was 65% and the total conversion rate of maleic anhydride was 100%. The polymerization solution was poured into a large amount of pure water to precipitate a polymer. The number-average molecular weight Mn was 2,300, the weight-average molecular weight Mw was 3,300, and the molecular weight distribution Mw/Mn was 1.4, which were measured by GPC. The chlorine content in the dry polymer was 33.6 wt % and the sulfur content was 2.5 wt %. Since a tetrahydrofuran solution of the formed polymer dissolved in an aqueous triethylamine solution, it could be judged that a chloroprene/maleic anhydride copolymer-CR diblock copolymer (amphipathic CR block copolymer-J) was formed.

### Synthetic Example 26

Into a 200 ml brown flask fitted with a nitrogen gas-inlet tube and a reflux condenser were charged 1.50 g (5.00 mmol) of a dithiocarboxylate ester represented by the formula (23), 1.00 g (10.20 mmol) of maleic anhydride, 1.28 g (12.24 mmol) of styrene, 1.05 g (12.24 mmol) of methacrylic acid, 65.0 mg (0.23 mmol) of 4,4′-azobis(4-cyanopentanoic acid), and 10.00 g of dioxane into a 100 ml egg plant-shape flask, followed by thorough degassing by repeating operations of freeze-pump-thaw cycle three times. Thereafter, the whole was heated on an oil bath of 80° C. under stirring with a magnetic stirrer under a nitrogen atmosphere. After heating for 10 hours, the whole was cooled to room temperature. The conversion rate of the polymerization of styrene and maleic anhydride at this moment was 76% and the conversion rate of the polymerization of methacrylic acid was 71%. Subsequently, 26.00 g (294 mmol) of chloroprene subjected to simple distillation, 60 ml of tetrahydrofuran, 0.10 g (10.33 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The conversion rate of chloroprene was 59%. The polymerization solution was poured into a large amount of pure water to precipitate a polymer. The number-average molecular weight Mn was 4,800, the weight-average molecular weight Mw was 8,200, and the molecular weight distribution Mw/Mn was 1.7, which were measured by GPC. The chlorine content in the dry polymer was 34.0 wt % and the sulfur content was 1.7 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it was judged that a maleic anhydride/styrene/methacrylic acid copolymer-CR diblock copolymer (amphipathic CR block copolymer-K) was formed.

### Synthetic Example 27

Into a 200 ml brown flask fitted with a nitrogen gas-inlet tube and a reflux condenser were charged 1.68 g (7.60 mmol) of a dithiocarboxylate ester represented by the general formula (9), 5.00 g (56.5 mmol) of chloroprene, 6.50 g (56.1 mmol) of maleic acid, 195.0 mg (0.69 mmol) of 4,4′-azobis(4-cyanopentanoic acid), and 30.00 g of dioxane, followed by thorough degassing by repeating operations of freeze-pump-thaw cycle three times. Thereafter, the whole was heated on an oil bath of 50° C. under stirring with a magnetic stirrer under a nitrogen atmosphere. After heating for 48 hours, the whole was cooled to room temperature. The conversion rate of the polymerization of chloroprene at this moment was 71% and the conversion rate of the polymerization of maleic acid was 45%. Subsequently, 26.00 g (294 mmol) of chloroprene subjected to simple distillation, 60 ml of tetrahydrofuran, and 0.10 g (10.33 mmol) of 2,2′-azobis(2,4-dimethylvaleronitrile) were added thereto, followed by thorough degassing by repeating operations of freeze-pump-thaw cycle three times. Thereafter, the whole was heated on an oil bath of 50° C. under stirring with a magnetic stirrer under a nitrogen atmosphere. After heating for 32 hours, 2,6-di-t-butylhydroxytoluene was added thereto to terminate the polymerization. The total conversion rate of chloroprene was 65% and the total conversion rate of maleic acid was 70%. The polymerization solution was poured into a large amount of pure water to precipitate a polymer. The number-average molecular weight Mn was 3,900, the weight-average molecular weight Mw was 5,300, and the molecular weight distribution Mw/Mn was 1.35, which were measured by GPC. The chlorine content in the dry polymer was 33.0 wt % and the sulfur content was 1.9 wt %. The formed polymer did not dissolve in toluene and chloroform which were good solvents of CR but dissolved in acetone which was a non-solvent thereof. Furthermore, an acetone solution of the formed polymer dissolved in an aqueous triethylamine solution. From the above results, it could be judged that a chloroprene/maleic acid copolymer-CR diblock copolymer having a maleic acid content of about 18 wt % (amphipathic CR block copolymer-L) was formed.

### Example 27

Into a 200 ml flask fitted with a nitrogen gas-inlet tube, a reflux condenser, and a stirrer were charged 3.60 g (content of methacrylic acid: up to 9.3 mmol, 12 wt % of the total charged monomers) of the amphipathic CR block copolymer-A obtained in Synthetic Example 16 and 7.00 g of acetone. After the polymer was dissolved, 1.19 g (11.80 mmol) of triethylamine and 42.00 g of pure water were added thereto. After acetone was removed by distillation with aspirator under reduced pressure, 30.00 g (339 mmol) of chloroprene subjected to simple distillation, 1.01 g (5 mmol) of n-dodecyl mercaptan, and 30 mg (0.18 mmol, added as a benzene solution) of 2,2′-azobis(2-methylpropionitrile) were added thereto. After inside of the system was thoroughly degassed with flowing a small amount of nitrogen under stirring, polymerization was carried out at 50° C. under stirring in a nitrogen atmosphere. As a result, emulsion polymerization proceeded without occurrence of scaling. After heating for 3 hours, 0.05 g of 2,6-di-t-butyl-4-methylphenol was added thereto to terminate the polymerization. The conversion rate of the polymerization of chloroprene was 80%. The unreacted monomer and water content were removed by distillation on a rotary evaporator to obtain a CR latex-A (a solid content 37 wt %, a methacrylic acid content relative to the total polymer was about 3.0 wt % and an emulsifier content was 0 wt % relative to the chloroprene-based polymer). No polymer was precipitated even when 5 equivalent amount of methanol was added to the resulting latex and thus the latex was extremely stable, so that it was judged that a soapless CR latex was obtained.

An adhesive composition was prepared in a blend composition shown in Table 2 using the resulting CR latex-A and the adhesion performance was evaluated. The results are shown in Table 2. As compared with the CR latexes of Comparative Examples, it is obvious that the decrease in peeling strength depending on open time and the decrease in peeling strength after water immersion are small and thus adhesiveness and water resistance are remarkably improved.

TABLE 2

| | Exam- | Exam- | Exam- | Exam- | Exam- |
|---|---|---|---|---|---|
| | ple | ple | ple | ple | ple |
| | 27 | 28 | 29 | 30 | 31 |
| Blend (parts by | | | | | |
| weight) | | | | | |
| CR latex-A | 100 | — | — | — | — |
| CR latex-B | — | 100 | — | — | — |
| CR latex-C | — | — | 100 | — | — |
| CR latex-D | — | — | — | 100 | — |
| CR latex-E | — | — | — | — | 100 |
| CR latex-F | — | — | — | — | — |
| CR latex-G | — | — | — | — | — |
| CR latex-H | — | — | — | — | — |
| CR latex-I | — | — | — | — | — |
| CR latex-J | — | — | — | — | — |
| CR latex-K | — | — | — | — | — |
| CR latex-L | — | — | — | — | — |
| CR latex-M | — | — | — | — | — |
| CR latex-N | — | — | — | — | — |
| CR latex-O | — | — | — | — | — |
| CR latex-P | — | — | — | — | — |
| CR latex-Q | — | — | — | — | — |
| CR latex-R | — | — | — | — | — |
| Pressure- | 15 | 15 | 15 | 15 | 15 |
| sensitive | | | | | |
| adhesive resin | | | | | |
| E-720¹⁾ | | | | | |
| Zinc oxide AZ- | 0.5 | 0.5 | 0.5 | 0.5 | 0.5 |
| SW | | | | | |
| Ordinary state | | | | | |
| peeling strength | | | | | |
| (N/25 mm)³⁾ | | | | | |
| Open time | | | | | |
| 0 hr | 86 C | 85 C | 87 C | 86 C | 86 C |
| 1 hr | 81 C | 82 C | 83 C | 79 C | 80 C |
| 3 hr | 79 C | 79 C | 80 C | 69 C | 70 C |
| Water resistant | 66 C | 65 C | 67 C | 66 C | 66 C |
| peeling strength | | | | | |
| (N/25 mm)³⁾ | | | | | |

¹⁾Rhodinate ester resin emulsion (solid content 50 wt %) manufactured by Arakawa Chemical Industries Ltd.
²⁾Zinc oxide emulsion manufactured by Osaki Industry Co., Ltd.
³⁾Peeled state: C = cohesion failure of adhesive layer, S = peeling at interface of pressure adhesion

### Example 28

Emulsion polymerization of chloroprene was carried out under the same conditions as in Example 27 except that 3.00 g (content of acrylic acid: up to 10.6 mmol, 10 wt % of total charged monomers) of the amphipathic CR block copolymer-B obtained in Synthetic Example 17 was used instead of the amphipathic CR block copolymer-A obtained in Synthetic Example 16 and 1.29 g (12.8 mmol) of triethylamine was added in Example 27. The unreacted monomer and water content were removed by distillation on a rotary evaporator to obtain a CR latex-B (a solid content 37 wt %, an acrylic acid content relative to the total polymer was about 3 wt % and an emulsifier content was 0 wt % relative to the chloroprene-based polymer). No polymer was precipitated even when 5 equivalent amount of methanol was added to the resulting latex and thus the latex was extremely stable, so that it was judged that a soapless CR latex was obtained.

An adhesive composition was prepared in a blend composition shown in Table 2 using the resulting CR latex-B and the adhesion performance was evaluated. The results are shown in Table 2. As compared with the CR latexes of Comparative Examples, it is obvious that the decrease in peeling strength depending on open time and the decrease in peeling strength after water immersion are small and thus adhesiveness and water resistance are remarkably improved.

### Example 29

Emulsion polymerization of chloroprene was carried out under the same conditions as in Example 27 except that 3.20 g (content of methacrylic acid: up to 9.5 mmol, 11 wt % of total charged monomers) of the amphipathic CR block copolymer-C obtained in Synthetic Example 18 was used instead of the amphipathic CR block copolymer-A obtained in Synthetic Example 16 and 1.15 g (11.4 mmol) of triethylamine was added in Example 27. The unreacted monomer and water content were removed by distillation on a rotary evaporator to obtain a CR latex-C (a solid content 37 wt %, a methacrylic acid content relative to the total polymer was about 3 wt % and an emulsifier content was 0 wt % relative to the chloroprene-based polymer). No polymer was precipitated even when 5 equivalent amount of methanol was added to the resulting latex and thus the latex was extremely stable, so that it was judged that a soapless CR latex was obtained.

An adhesive composition was prepared in a blend composition shown in Table 2 using the resulting CR latex-C and the adhesion performance was evaluated. The results are shown in Table 2. As compared with the CR latexes of Comparative Examples, it is obvious that the decrease in peeling strength depending on open time and the decrease in peeling strength after water immersion are small and thus adhesiveness and water resistance are remarkably improved.

### Example 30

Into a 200 ml flask fitted with a nitrogen gas-inlet tube, a reflux condenser, and a stirrer were charged 2.00 g (content of maleic anhydride: up to 5.6 mmol, 6.7 wt % of the total charged monomers) of the amphipathic CR block copolymer-D obtained in Synthetic Example 19 and 6.00 g of acetone. After the polymer was dissolved, 1.36 g (13.5 mmol) of triethylamine and 42.00 g of pure water were added thereto. After acetone was removed by distillation with aspirator under reduced pressure, 25.00 g (282 mmol) of chloroprene subjected to simple distillation, 5.00 g (40.7 mmol) of 2,3-dichloro-1,3-butadiene, 1.00 g (5 mmol) of n-dodecyl mercaptan, and 30 mg (0.18 mmol, added as a benzene solution) of 2,2′-azobis(2-methylpropionitrile) were added thereto. As a result of emulsion polymerization in the same manner as in Example 27, emulsion polymerization proceeded without occurrence of scaling. After heating for 3 hours, 0.05 g of 2,6-di-t-butyl-4-methylphenol was added thereto to terminate the polymerization. The conversion rates of the polymerization of chloroprene and 2,3-dichloro-1,3-butadiene were 74% and 86%, respectively. The unreacted monomer and water content were removed by distillation on a rotary evaporator to obtain a CR latex-D (a solid content 37 wt %, a maleic anhydride content relative to the total polymer was about 3 wt % and an emulsifier content was 0 wt % relative to the chloroprene-based polymer). Since the latex was extremely stable, it was judged that a soapless CR latex was obtained.

An adhesive composition was prepared in a blend composition shown in Table 2 using the resulting CR latex-D and the adhesion performance was evaluated. The results are shown in Table 2. As compared with the CR latexes of Comparative Examples, it is obvious that the decrease in peeling strength depending on open time and the decrease in peeling strength after water immersion are small and thus adhesiveness and water resistance are remarkably improved.

### Example 31

Emulsion polymerization of chloroprene and 2,3-dichloro-1,3-butadiene was carried out under the same manner as in Example 30 except that 2.5 g (content of maleic acid: up to 5.1 mmol, 8.3 wt % of the total charged monomers) of the amphipathic CR block copolymer-E obtained in Synthetic Example 20 was used instead of the amphipathic CR block copolymer-D obtained in Synthetic Example 19 and 1.13 g (12.15 mmol) of triethylamine was added in Example 30. As a result, emulsion polymerization proceeded without occurrence of scaling. After heating for 3 hours, 0.05 g of 2,6-di-t-butyl-4-methylphenol was added thereto to terminate the polymerization. The conversion rates of the polymerization of chloroprene and 2,3-dichloro-1,3-butadiene were 75% and 89%, respectively. The unreacted monomer and water content were removed by distillation on a rotary evaporator to obtain a CR latex-E (a solid content 37 wt %, a maleic acid content relative to the total polymer was about 2.3 wt % and an emulsifier content was 0 wt % relative to the chloroprene-based polymer). Since the latex was extremely stable, it was judged that a soapless CR latex was obtained.

An adhesive composition was prepared in a blend composition shown in Table 2 using the resulting CR latex-E and the adhesion performance was evaluated. The results are shown in Table 2. As compared with the CR latexes of Comparative Examples, it is obvious that the decrease in peeling strength depending on open time and the decrease in peeling strength after water immersion are small and thus adhesiveness and water resistance are remarkably improved.

### Example 32

Into a 200 ml flask fitted with a nitrogen gas-inlet tube, a reflux condenser, and a stirrer were charged 3.57 g (content of methacrylic acid: up to 8.7 mmol, 12 wt % of the total charged monomers) of the amphipathic CR block copolymer-F obtained in Synthetic Example 21 and 7.05 g of acetone. After the polymer was dissolved, 1.07 g (10.62 mmol) of triethylamine and 41.38 g of pure water were added thereto. After acetone was removed by distillation with aspirator under reduced pressure, 30.05 g (339.6 mmol) of chloroprene subjected to simple distillation, 1.01 g (5 mmol) of n-dodecyl mercaptan, and 32.84 mg (0.20 mmol, added as a benzene solution) of 2,2′-azobis(2-methylpropionitrile) were added thereto. After inside of the system was thoroughly degassed with flowing a small amount of nitrogen under stirring, polymerization was carried out at 50° C. under stirring in a nitrogen atmosphere. As a result of polymerization at 50° C., emulsion polymerization proceeded without occurrence of scaling. After heating for 3 hours, 0.05 g of 2,6-di-t-butyl-4-methylphenol was added thereto to terminate the polymerization. The conversion rate of the polymerization of chloroprene was 80%. The unreacted monomer and water content were removed by distillation on a rotary evaporator to obtain a CR latex-F (a solid content 37 wt %, a methacrylic acid content relative to the total polymer was about 3.0 wt % and an emulsifier content was 0 wt % relative to the chloroprene-based polymer). No polymer was precipitated even when 5 equivalent amount of methanol was added to the resulting latex and thus the latex was extremely stable, so that it was judged that a soapless CR latex was obtained.

An adhesive composition was prepared in a blend composition shown in Table 3 using the resulting CR latex-F and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

TABLE 3

| | Example | Example | Example | Example | Example | Example | Example | Example | Example |
|---|---|---|---|---|---|---|---|---|---|
| | 32 | 33 | 34 | 35 | 36 | 37 | 38 | 39 | 40 |
| Blend (parts by | | | | | | | | | |
| weight) | | | | | | | | | |
| CR latex-A | — | — | — | — | — | — | — | — | — |
| CR latex-B | — | — | — | — | — | — | — | — | — |
| CR latex-C | — | — | — | — | — | — | — | — | — |
| CR latex-D | — | — | — | — | — | — | — | — | — |
| CR latex-E | — | — | — | — | — | — | — | — | — |
| CR latex-F | 100 | — | — | — | — | — | — | — | — |
| CR latex-G | — | 100 | — | — | — | — | — | — | — |
| CR latex-H | — | — | 100 | — | — | — | — | — | — |
| CR latex-I | — | — | — | 100 | — | — | — | — | — |
| CR latex-J | — | — | — | — | 100 | — | — | — | — |
| CR latex-K | — | — | — | — | — | 100 | — | — | — |
| CR latex-L | — | — | — | — | — | — | 100 | — | — |
| CR latex-M | — | — | — | — | — | — | — | 100 | — |
| CR latex-N | — | — | — | — | — | — | — | — | 100 |
| CR latex-O | — | — | — | — | — | — | — | — | — |
| CR latex-P | — | — | — | — | — | — | — | — | — |
| CR latex-Q | — | — | — | — | — | — | — | — | — |
| CR latex-R | — | — | — | — | — | — | — | — | — |
| Pressure-sensitive | 15 | 15 | 15 | 15 | 15 | 15 | 15 | 15 | 15 |
| adhesive resin E- | | | | | | | | | |
| 720¹⁾ | | | | | | | | | |
| Zinc oxide AZ-SW | 0.5 | 0.5 | 0.5 | 0.5 | 0.5 | 0.5 | 0.5 | 0.5 | 0.5 |
| Ordinary state | | | | | | | | | |
| peeling strength | | | | | | | | | |
| (N/25 mm)³⁾ | | | | | | | | | |
| Open time | | | | | | | | | |
| 0 hr | 84 C | 85 C | 83 C | 86 C | 88 C | 84 C | 85 C | 85 C | 84 C |
| 1 hr | 81 C | 80 C | 80 C | 82 C | 84 C | 80 C | 82 C | 80 C | 81 C |
| 3 hr | 76 C | 79 C | 77 C | 76 C | 79 C | 75 C | 81 C | 74 C | 75 C |
| Water resistant | 63 C | 64 C | 61 C | 63 C | 62 C | 63 C | 66 C | 65 C | 65 C |
| peeling strength | | | | | | | | | |
| (N/25 mm)³⁾ | | | | | | | | | |

¹⁾Rhodinate ester resin emulsion (solid content 50 wt %) manufactured by Arakawa Chemical Industries Ltd.
²⁾Zinc oxide emulsion manufactured by Osaki Industry Co., Ltd.
³⁾Peeled state: C = cohesion failure of adhesive layer, S = peeling at interface of pressure adhesion

### Example 33

Polymerization was carried out in the same manner as in Example 32 except that 25.55 g (288.7 mmol) of chloroprene and 4.5 g (36.6 mmol) of 2,3-dichloro-1,3-butadiene were used instead of 30.05 g of chloroprene. As a result, emulsion polymerization proceeded without occurrence of scaling. After the polymerization for 3 hours, the conversion rates of the polymerization of chloroprene and 2,3-dichloro-1,3-butadiene were 81% and 98%, respectively. When the unreacted monomer and water content were removed by distillation on a rotary evaporator, as in Example 27, a stable soapless CR latex-G was obtained (a solid content 40 wt %, a methacrylic acid content relative to the total polymer was about 3 wt % and an emulsifier content was 0 wt % relative to the chloroprene-based polymer).

An adhesive composition was prepared in a blend composition shown in Table 3 using the resulting CR latex-G and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 34

Emulsion polymerization was carried out in the same manner as in Example 32 except that 27.0 g (305.1 mmol) of chloroprene and 2.05 g (20.81 mmol) of 2-hydroxypropyl methacrylate were used instead of 30.05 g of chloroprene. Emulsion polymerization proceeded without occurrence of scaling. After the polymerization for 3 hours, the conversion rates of the polymerization of chloroprene and 2-hydroxypropyl methacrylate were 83% and 25%, respectively. When the unreacted monomer and water content were removed by distillation on a rotary evaporator, as in Example 6, a stable soapless CR latex-H was obtained (a solid content 38 wt %, a methacrylic acid content relative to the total polymer was about 3 wt % and an emulsifier content was 0 wt % relative to the chloroprene-based polymer).

An adhesive composition was prepared in a blend composition shown in Table 3 using the resulting CR latex-H and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 35

Into a 200 ml flask fitted with a nitrogen gas-inlet tube, a reflux condenser, and a stirrer were charged 4.00 g (content of acrylic acid: up to 4.8 mmol, 13 wt % of the total charged monomers) of the amphipathic CR block copolymer-G obtained in Synthetic Example 22 and 7.00 g of tetrahydrofuran. After the polymer was dissolved, 0.60 g (4.94 mmol) of triethylamine and 40.00 g of pure water were added thereto. Then, 31.02 g (mmol) of chloroprene subjected to simple distillation, 1.00 g (mmol) of n-dodecyl mercaptan, and 60 mg of potassium persulfate were added thereto. After inside of the system was thoroughly degassed with flowing a small amount of nitrogen under stirring, polymerization was carried out at 40° C. under stirring in a nitrogen atmosphere. As a result of the polymerization at 40° C., emulsion polymerization proceeded without occurrence of scaling. After heating for 8 hours, 0.05 g of 2,6-di-t-butyl-4-methylphenol was added thereto to terminate the polymerization. The conversion rate of the polymerization of chloroprene was 72%. When the unreacted monomer and water content were removed by distillation on a rotary evaporator, a stable soapless CR latex-I was obtained (a solid content 39 wt %, an acrylic acid content relative to the total polymer was about 1.5 wt % and an emulsifier content was 0 wt % relative to the chloroprene-based polymer).

An adhesive composition was prepared in a blend composition shown in Table 3 using the resulting CR latex-I and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 36

Polymerization was carried out in the same manner as in Example 33 except that 4.03 g (13 wt % of the total charged monomers) of the amphipathic CR block copolymer-H obtained in Synthetic Example 23 was used instead of 3.57 g of the amphipathic CR block copolymer-F. As a result, emulsion polymerization proceeded without occurrence of scaling. After the polymerization for 3 hours, the conversion rates of the polymerization of chloroprene and 2,3-dichloro-1,3-butadiene were 80% and 97%, respectively. When the unreacted monomer and water content were removed by distillation on a rotary evaporator, as in Example 33, a stable soapless CR latex-J was obtained (a solid content 39 wt %, a methacrylic acid content relative to the total polymer was about 3 wt % and an emulsifier content was 0 wt % relative to the chloroprene-based polymer).

An adhesive composition was prepared in a blend composition shown in Table 3 using the resulting CR latex-J and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 37

Polymerization was carried out in the same manner as in Example 33 except that 6.00 g (20 wt % of the total charged monomers) of the amphipathic CR block copolymer-I obtained in Synthetic Example 24 was used instead of 3.57 g of the amphipathic CR block copolymer-F. As a result, emulsion polymerization proceeded without occurrence of scaling. After the polymerization for 3 hours, the conversion rates of the polymerization of chloroprene and 2,3-dichloro-1,3-butadiene were 79% and 97%, respectively. When the unreacted monomer and water content were removed by distillation on a rotary evaporator, as in Example 33, a stable soapless CR latex-K was obtained (a solid content 39 wt %, a maleic anhydride content relative to the total polymer was about 2.0 wt % and an emulsifier content was 0 wt % relative to the chloroprene-based polymer).

An adhesive composition was prepared in a blend composition shown in Table 3 using the resulting CR latex-K and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 38

Polymerization was carried out in the same manner as in Example 33 except that 5.00 g (17 wt % of the total charged monomers) of the amphipathic CR block copolymer-J obtained in Synthetic Example 25 and 0.15 g of sodium dodecylbenzenesulfonate were used instead of 3.57 g of the amphipathic CR block copolymer-F. As a result, emulsion polymerization proceeded without occurrence of scaling. After the polymerization for 3 hours, the conversion rates of the polymerization of chloroprene and 2,3-dichloro-1,3-butadiene were 79% and 97%, respectively. When the unreacted monomer and water content were removed by distillation on a rotary evaporator, as in Example 33, a stable soapless CR latex-L was obtained (a solid content 39 wt %, a maleic anhydride content relative to the total polymer was about 3.5 wt % and an emulsifier content was 0.5 wt % relative to the chloroprene-based polymer).

An adhesive composition was prepared in a blend composition shown in Table 3 using the resulting CR latex-L and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 39

Polymerization was carried out in the same manner as in Example 33 except that 6.00 g (20 wt % of the total charged monomers) of the amphipathic CR block copolymer-K obtained in Synthetic Example 26 was used instead of 3.57 g of the amphipathic CR block copolymer-F. As a result, emulsion polymerization proceeded without occurrence of scaling. After the polymerization for 3 hours, the conversion rates of the polymerization of chloroprene and 2,3-dichloro-1,3-butadiene were 78% and 96%, respectively. When the unreacted monomer and water content were removed by distillation on a rotary evaporator, as in Example 33, a stable soapless CR latex-M was obtained (a solid content 39 wt %, a maleic anhydride and methacrylic acid content relative to the total polymer was about 2.0 wt % and an emulsifier content was 0 wt % relative to the chloroprene-based polymer).

An adhesive composition was prepared in a blend composition shown in Table 3 using the resulting CR latex-M and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Example 40

Polymerization was carried out in the same manner as in Example 33 except that 6.00 g (20 wt % of the total charged monomers) of the amphipathic CR block copolymer-L obtained in Synthetic Example 27 was used instead of 3.57 g of the amphipathic CR block copolymer-F. As a result, emulsion polymerization proceeded without occurrence of scaling. After the polymerization for 3 hours, the conversion rates of the polymerization of chloroprene and 2,3-dichloro-1,3-butadiene were 77% and 95%, respectively. When the unreacted monomer and water content were removed by distillation on a rotary evaporator, as in Example 33, a stable soapless CR latex-N was obtained (a solid content 39 wt %, a maleic anhydride content relative to the total polymer was about wt % and an emulsifier content was 0 wt % relative to the chloroprene-based polymer).

An adhesive composition was prepared in a blend composition shown in Table 3 using the resulting CR latex-N and the adhesion performance was evaluated. The results are shown in Table 3. As compared with the CR latexes of Comparative Examples, it is obvious that the decrease in peeling strength depending on open time and the decrease in peeling strength after water immersion are small and thus adhesiveness and water resistance are remarkably improved.

### Comparative Example 6

Into a 500 ml flask fitted with a nitrogen gas-inlet tube, a reflux condenser, and a stirrer were charged 98.5 of chloroprene, 1.5 g of methacrylic acid, 0.3 g of n-dodecy mercaptan, 5 g (in terms of solid content) of sodium alkyldiphenyl-ether-disulfonate (manufactured by Kao Corporation, Pelex SSH), 0.5 g of sulfonic acid-formalin condensate sodium salt (manufactured by Kao Corporation, Demol N), 0.2 g of triethanolamine, and 100 g of pure water. Under stirring, inside of the system was thoroughly degassed with flowing a small amount of nitrogen under stirring. Then, 0.01 g of sodium hydrosulfite was added and emulsion polymerization of chloroprene was carried out at 40° C. with continuous dropwise addition of a 0.1 wt % aqueous potassium persulfate solution under a nitrogen atmosphere. At a conversion rate of 85%, 0.05 g of 2,6-di-t-butyl-4-methylphenol was added thereto to terminate the polymerization. The unreacted monomer and water content were removed by distillation on a rotary evaporator to obtain a stable conventional CR latex-O (a solid content 40 wt %, an emulsifier content was 5.5 wt % relative to the chloroprene-based polymer).

An adhesive composition was prepared in a blend composition shown in Table 4 using the resulting CR latex-O and the adhesion performance was evaluated. The results are shown in Table 4. As compared with Examples, it is obvious that the decrease in peeling strength depending on open time and the decrease in peeling strength after water immersion are large.

TABLE 4

| | Compar- | | Compar- | | Compar- | | Compar- | |
|---|---|---|---|---|---|---|---|---|
| | ative | | ative | | ative | | ative | |
| | Example 6 | | Example 7 | | Example 8 | | Example 9 | |
| Blend (parts by | | | | | | | | |
| weight) | | | | | | | | |
| CR latex-A | — | | — | | — | | — | |
| CR latex-B | — | | — | | — | | — | |
| CR latex-C | — | | — | | — | | — | |
| CR latex-D | — | | — | | — | | — | |
| CR latex-E | — | | — | | — | | — | |
| CR latex-F | — | | — | | — | | — | |
| CR latex-G | — | | — | | — | | — | |
| CR latex-H | — | | — | | — | | — | |
| CR latex-I | — | | — | | — | | — | |
| CR latex-J | — | | — | | — | | — | |
| CR latex-K | — | | — | | — | | — | |
| CR latex-L | — | | — | | — | | — | |
| CR latex-M | — | | — | | — | | — | |
| CR latex-N | — | | — | | — | | — | |
| CR latex-O | 100 | | — | | — | | — | |
| CR latex-P | — | | 100 | | — | | — | |
| CR latex-Q | — | | — | | 100 | | — | |
| CR latex-R | — | | — | | — | | 100 | |
| Pressure- | 15 | | 15 | | 15 | | 15 | |
| sensitive | | | | | | | | |
| adhesive resin | | | | | | | | |
| E-720¹⁾ | | | | | | | | |
| Zinc oxide AZ- | 0.5 | | 0.5 | | 0.5 | | 0.5 | |
| SW | | | | | | | | |
| Ordinary state | | | | | | | | |
| peeling | | | | | | | | |
| strength (N/25 | | | | | | | | |
| mm)³⁾ | | | | | | | | |
| Open time | | | | | | | | |
| 0 hr | 82 | C | 85 | C | 85 | C | 84 | c |
| 1 hr | 72 | C/S | 65 | C/S | 62 | C/S | 65 | C/S |
| 3 hr | 55 | S | 58 | C/S | 55 | S | 56 | C/S |
| Water resistant | 41 | C/S | 47 | C/S | 40 | C/S | 41 | C/S |
| peeling | | | | | | | | |
| strength (N/25 | | | | | | | | |
| mm)³⁾ | | | | | | | | |

¹⁾Rhodinate ester resin emulsion (solid content 50 wt %) manufactured by Arakawa Chemical Industries Ltd.
²⁾Zinc oxide emulsion manufactured by Osaki Industry Co., Ltd.
³⁾Peeled state: C = cohesion failure of adhesive layer, S = peeling at interface of pressure adhesion

### Comparative Example 7

Emulsion polymerization was carried out in the same manner as in Comparative Example 6 except that 3.0 g sodium dodecylbenzenesulfonate was used instead of sodium alkyldiphenyl-ether-disulfonate to obtain a stable conventional CR latex-P (a solid content 40 wt %, an emulsifier content was 3.4 wt % relative to the chloroprene-based polymer). An adhesive composition was prepared in a blend composition shown in Table 4 using the resulting CR latex-P and the adhesion performance was evaluated. The results are shown in Table 4. As compared with Examples, it is obvious that the decrease in peeling strength depending on open time and the decrease in peeling strength after water immersion are large.

### Comparative Example 8

Polymerization was carried out in the same manner as in Example 27 except that 0.7 g sodium dodecylbenzenesulfonate was added in addition to the amphipathic CR block copolymer-A at the emulsion polymerization of chloroprene in Example 27. After the polymerization for 3 hours, the conversion rate of the polymerization of chloroprene was 82%. The unreacted monomer and water content were removed by distillation on a rotary evaporator to obtain a stable conventional CR latex-Q (a solid content 39 wt %, an emulsifier content was about 2.4 wt % relative to the chloroprene-based polymer).

An adhesive composition was prepared in a blend composition shown in Table 4 using the resulting CR latex-Q and the adhesion performance was evaluated. The results are shown in Table 4. As compared with Examples, it is obvious that the decrease in peeling strength depending on open time and the decrease in peeling strength after water immersion are large.

### Comparative Example 9

Polymerization was carried out in the same manner as in Example 32 except that 0.7 g sodium dodecylbenzenesulfonate was added in addition to the amphipathic CR block copolymer-F at the emulsion polymerization of chloroprene in Example 32. After the polymerization for 3 hours, the conversion rate of the polymerization of chloroprene was 84%. The unreacted monomer and water content were removed by distillation on a rotary evaporator to obtain a stable conventional CR latex-R (a solid content 39 wt %, an emulsifier content was about 2.4 wt % relative to the chloroprene-based polymer).

An adhesive composition was prepared in a blend composition shown in Table 4 using the resulting CR latex-R and the adhesion performance was evaluated. The results are shown in Table 4. As compared with Examples, it is obvious that the decrease in peeling strength depending on open time and the decrease in peeling strength after water immersion are large.

While the invention has been described in detail and with reference to specific embodiments thereof, it will be apparent to one skilled in the art that various changes and modifications can be made therein without departing from the spirit and scope thereof.

The present application is based on Japanese Patent Application No. 2005-200304 filed on Jul. 8, 2005, Japanese Patent Application No. 2006-126067 filed on Apr. 28, 2006, and Japanese Patent Application No. 2006-139463 filed on May 18, 2006, and the contents are incorporated herein by reference.

### INDUSTRIAL APPLICABILITY

Since the chloroprene-based block copolymer obtained in the present invention has improved adhesiveness as compared with conventional chloroprene-based adhesives, the copolymer can be utilized as an adhesive or a primer for a wide variety of materials. Furthermore, it is also expectable that the block copolymer is utilized as a polymer modifier, a resin compatibilizer, a dispersant, an emulsifier, a hot-melt adhesive, and a thermoplastic elastomer. Moreover, the soapless CR latex obtained according to the invention can remarkably reduce an amount of an emulsifier which is conventionally contained in a large amount, the latex enables production of a CR latex adhesive, a primer, a sealant, and a binder for capacitor electrodes, which have remarkably improved adhesiveness and water resistance. Thus, the industrial value of the invention is remarkable.

1. A chloroprene-based block copolymer comprising a polymer (A) having a composition represented by the following formula (1) and a chloroprene-based polymer (B), wherein the polymer (A) is linked to one terminal or both terminals of a chloroprene-based polymer (B), and the total amount of the 1,2-bond and the isomerized 1,2-bond in the chloroprene-based polymer (B) as determined by carbon-13 nuclear magnetic resonance spectrometry is 2.0% by mol or less: 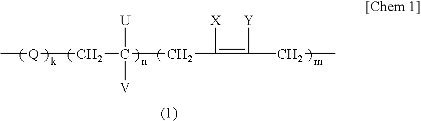
wherein U represents hydrogen, a methyl group, a cyano group, or a substituted alkyl group; V represents a phenyl group, a substituted phenyl group, a carboxyl group, an alkoxycarbonyl group, a substituted alkoxycarbonyl group, an allyloxycarbonyl group, a substituted allyloxycarbonyl group, an acyloxy group, a substituted acyloxy group, an amido group, or a substituted amido group; X represents hydrogen, a methyl group, chlorine, or a cyano group; Y represents hydrogen, chlorine, or a methyl group; Q represents a polymerization residue of maleic anhydride, citraconic acid, maleic acid, fumalic acid, a maleate ester, or a fumalate ester; and k, n, and m each represents an integer of 0 or more.

2. The chloroprene-based block copolymer according to claim 1, wherein molecular weight distribution (Mw/Mn) represented by the ratio of weight-average molecular weight (Mw) to number-average molecular weight (Mn) determined by gel permeation chromatography is 2.1 or less.

3. The chloroprene-based block copolymer according to claim 1, wherein the polymer (A) is a polymer obtained by radical polymerization using an acrylate ester-based monomer, a methacrylate ester-based monomer, acrylic acid, methacrylic acid, a styrene-based monomer, acrylonitrile, methacrylonitrile, a vinyl ester-based monomer, an acrylamide-based monomer, a methacrylamide-based monomer, a 1,3-butadiene-based monomer, or a styrene-based monomer and maleic anhydride, citraconic anhydride, maleic acid, itaconic acid, an N-substituted maleimide, a fumalate ester, a maleate ester, or a vinylnitrile-based monomer, copolymerizable with the styrene-based monomer, in the presence of a dithiocarbamate ester compound, a dithiocarboxylate ester compound, a dithiocarbamate ester compound and a disulfide compound, or a dithiocarboxylate ester compound and a disulfide compound.

4. A process for producing the chloroprene-based block copolymer according to claim 1, comprising steps of synthesizing the polymer (A) by radical polymerization of a radically polymerizable monomer in the presence of a dithiocarbamate ester compound, a dithiocarboxylate ester compound, a dithiocarbamate ester compound and a disulfide compound, or a dithiocarboxylate ester compound and a disulfide compound, and radically polymerizing chloroprene or chloroprene and a monomer copolymerizable therewith at a temperature of 70° C. or lower in the presence of the resulting polymer (A).

5. The process for producing the chloroprene-based block copolymer according to claim 4, wherein the radically polymerizable monomer is an acrylate ester-based monomer, a methacrylate ester-based monomer, acrylic acid, methacrylic acid, a styrene-based monomer, acrylonitrile, methacrylonitrile, a vinyl ester-based monomer, an acrylamide-based monomer, a methacrylamide-based monomer, a 1,3-butadiene-based monomer, or a styrene-based monomer and maleic anhydride, citraconic anhydride, maleic acid, itaconic acid, an N-substituted maleimide, a fumalate ester, a maleate ester, or a vinylnitrile-based monomer, copolymerizable with the styrene-based monomer.

6. A process for producing the chloroprene-based block copolymer according to claim 1, comprising steps of synthesizing the chloroprene-based polymer (B) by radical polymerization of chloroprene or chloroprene and a monomer copolymerizable therewith at a temperature of 70° C. or lower in the presence of a dithiocarbamate ester compound, a disulfide compound, or a dithiocarbamate ester compound and a disulfide compound, and radically polymerizing or copolymerizing a styrene-based monomer, 2,3-dichloro-1,3-butadiene, a methacrylate ester-based monomer, or a styrene-based monomer and maleic anhydride, citraconic anhydride, maleic acid, itaconic acid, an N-substituted maleimide, a fumalate ester, a maleate ester, or a vinylnitrile-based monomer, copolymerizable with the styrene-based monomer, in the presence of the resulting chloroprene-based polymer (B).

7. A process for producing the chloroprene-based block copolymer according to claim 1, comprising steps of synthesizing the chloroprene-based polymer (B) by radical polymerization of chloroprene or chloroprene and a monomer copolymerizable therewith at a temperature of 70° C. or lower in the presence of a dithiocarbamate ester compound, a disulfide compound, or a dithiocarbamate ester compound and a disulfide compound, and radically polymerizing or copolymerizing a styrene-based monomer, 2,3-dichloro-1,3-butadiene, or a styrene-based monomer and maleic anhydride, citraconic anhydride, maleic acid, itaconic acid, an N-substituted maleimide, a fumalate ester, a maleate ester, or a vinylnitrile-based monomer, copolymerizable with the styrene-based monomer, in the presence of the resulting chloroprene-based polymer (B).

8. The process for producing the chloroprene-based block copolymer according to claim 4, wherein the dithiocarbamate ester compound is a compound represented by the following formula (2): 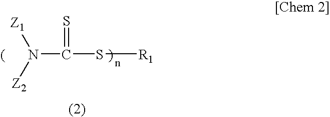
wherein R₁ represents an n-valent organic group having one or more carbon atoms, Z₁ and Z₂ each represents an alkyl group, a substituted alkyl group, an aryl group, or a substituted aryl group which each is an organic group having one or more carbon atoms, and n represents an integer of 1 or more.

9. The process for producing the chloroprene-based block copolymer according to claim 4, wherein the dithiocarbamate ester compound is a compound represented by the following formula (3) or (4): 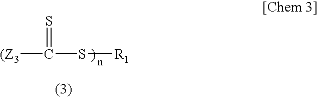
wherein R₁ represents an n-valent organic group having one or more carbon atoms, Z₃ represents an aryl group, a substituted aryl group, an allyl group, a substituted allyl group, an alkyl group substituted with an electron-withdrawing group, or an alkoxy group which each is a monovalent organic group having one or more carbon atoms; 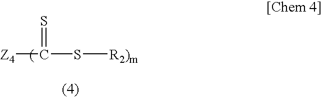
wherein R₂ represents a monovalent organic group having one or more carbon atoms, Z₄ represents an aryl group, a substituted aryl group, an allyl group, a substituted allyl group, an alkyl group substituted with an electron-withdrawing group, or an alkoxy group which each is an m-valent organic group having one or more carbon atoms.

10. The process for producing the chloroprene-based block copolymer according to claim 4, wherein the disulfide compound is a compound represented by the following formula (5): 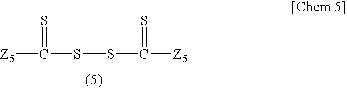
wherein Z₅ represents an aryl group, a substituted aryl group, an allyl group, a substituted allyl group, an alkyl group substituted with an electron-withdrawing group, an alkoxy group, an amino group, or a substituted amino group which each is a monovalent organic group having one or more carbon atoms.

11. An adhesive, a primer, a thermoplastic elastomer, or a rubber compatibilizer comprising the chloroprene-based block copolymer according to claim 1.

12. A soapless polychloroprene-based latex comprising an amphipathic chloroprene-based copolymer having a hydrophobic chloroprene-based polymer and a hydrophilic oligomer or polymer having an acidic functional group linked to the hydrophobic chloroprene-based polymer, and 2 wt % or less of an emulsifying agent.

13. The soapless polychloroprene-based latex according to claim 12, wherein the amphipathic chloroprene-based copolymer described in claim 12 is a chloroprene-based block copolymer represented by the following formula (6): 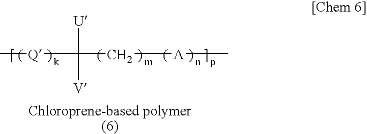
wherein U′ represents hydrogen, a methyl group, or a cyano group; V′ represents a methyl group, a carboxyl group, a carboxyl group-containing alkyl group, or a carboxyl group-containing aryl group; A represents a polymerization residue of chloroprene, 2,3-dichloro-1,3-butadiene, styrene, p-methoxystyrene, or isobutylene; Q′ represents a polymerization residue of maleic anhydride, citraconic acid, maleic acid, or fumalic acid; k, m, and n each represents an integer of 0 or more; and p represents an integer of 1 or more.

14. The soapless polychloroprene-based latex according to claim 12, wherein the hydrophilic oligomer or polymer having an acidic functional group contains a polymerization residue of a monomer selected from methacrylic acid, acrylic acid, maleic anhydride, maleic acid, and fumalic acid.

15. A process for producing the soapless polychloroprene-based latex according to claim 12, comprising emulsion polymerization of chloroprene or chloroprene and a monomer polymerizable with chloroprene, wherein an amphipathic chloroprene copolymer having a hydrophobic chloroprene-based polymer and a hydrophilic oligomer or polymer having an acidic functional group linked to the hydrophobic chloroprene-based polymer is used.

16. The process for producing the soapless polychloroprene-based latex according to claim 15, wherein the amphipathic chloroprene copolymer described in claim 15 is a chloroprene-based block copolymer represented by the following formula (6): 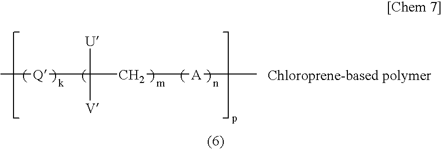
wherein U′ represents hydrogen, a methyl group, or a cyano group; V′ represents a methyl group, a carboxyl group, a carboxyl group-containing alkyl group, or a carboxyl group-containing aryl group; A represents a polymerization residue of chloroprene, 2,3-dichloro-1,3-butadiene, styrene, p-methoxystyrene, or isobutylene; Q′ represents a polymerization residue of maleic anhydride, citraconic acid, maleic acid, or fumalic acid; k, m, and n each represents an integer of 0 or more; and p represents an integer of 1 or more.

17. An adhesive comprising the soapless polychloroprene-based latex according to claim 12.
